(19) United States
(12) Patent Application Publication
(10) Pub. No.: US 2019/0302632 A1
(43) Pub. Date: Oct. 3, 2019

(54) ELECTROPHOTOGRAPHIC PHOTORECEPTOR, ELECTROPHOTOGRAPHIC PHOTORECEPTOR FOR POSITIVE CHARGING, PROCESS CARTRIDGE, AND IMAGE FORMING APPARATUS

(71) Applicant: FUJI XEROX CO., LTD., Tokyo (JP)

(72) Inventors: Nobuyuki TORIGOE, Ebina-shi (JP); Takeshi IWANAGA, Ebina-shi (JP); Masaki HIRAKATA, Ebina-shi (JP); Hideya KATSUHARA, Ebina-shi (JP); Yoichi KIGOSHI, Ebina-shi (JP); Yukimi KAWABATA, Ebina-shi (JP)

(73) Assignee: FUJI XEROX CO., LTD., Tokyo (JP)

(21) Appl. No.: 16/048,531

(22) Filed: Jul. 30, 2018

(30) Foreign Application Priority Data
Apr. 3, 2018 (JP) 2018-071954
Apr. 19, 2018 (JP) 2018-080710

(51) Int. Cl. G03G 5/147; G03G 15/00; G03G 21/18; G03G 5/06; G03G 5/05

(52) U.S. Cl. CPC G03G 5/14704; G03G 15/75; G03G 21/18; G03G 5/0507; G03G 5/0614; G03G 5/0672; G03G 5/0564; G03G 5/0696

(57) ABSTRACT

Provided is an electrophotographic photoreceptor including: a conductive substrate; a single-layer type photosensitive layer that is provided on the conductive substrate; an inorganic protective layer that is provided on the single-layer type photosensitive layer; wherein layers that are interposed between the conductive substrate and the inorganic protective layer have a total thickness of 10 μm to 25 μm.

### CROSS-REFERENCE TO RELATED APPLICATIONS

This application is based on and claims priorities under 35 U.S.C. § 119 from Japanese Patent Application No. 2018-071954 filed on Apr. 3, 2018 and from Japanese Patent Application No. 2018-080710 filed on Apr. 19, 2018.

### BACKGROUND

### Technical Field

The present invention relates to an electrophotographic photoreceptor, an electrophotographic photoreceptor for positive charging, a process cartridge, and an image forming apparatus.

### Related Art

Patent Literature 1 describes an electrophotographic photoreceptor that includes a conductive substrate, an organic photosensitive layer provided on the conductive substrate and including, in a region on a side in contact with an inorganic protective layer, at least a charge transport material and silica particles having a volume average particle diameter of 20 nm to 200 nm, and the inorganic protective layer provided to be in contact with a surface of the organic photosensitive layer.

Patent Literature 2 describes an electrophotographic photoreceptor that includes a substrate, an undercoat layer that is a vapor deposited film containing oxygen and gallium in order from the substrate side and having a gallium content of 28 atom % to 40 atom %, and a photosensitive layer.

### CITATION LIST

### Patent Literature

Patent Literature 1: Japanese Patent No. 5994708
Patent Literature 1: Japanese Patent No. 5509764

### SUMMARY

For example, in an electrophotographic photoreceptor including an inorganic protective layer, a hard material such as a carrier migrates on a surface of the electrophotographic photoreceptor and is interposed between the electrophotographic photoreceptor and a member that contacts the electrophotographic photoreceptor. Accordingly, a dent may occur to the inorganic protective layer.

Aspects of non-limiting embodiments of the present disclosure relate to provide an electrophotographic photoreceptor that includes a single-layer type photosensitive layer and an inorganic protective layer, in which occurrence of a dent of an inorganic protective layer is suppressed as compared with a case where a total film thickness of layers interposed between a conductive substrate and the inorganic protective layer exceeds 25 μm.

Here, the “dent” occurred in the inorganic protective layer is a circular or elliptical concave portion, and has a maximum diameter of 50 μm or less.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrophotographic photoreceptor including:
a conductive substrate;
a single-layer type photosensitive layer that is provided on the conductive substrate;
an inorganic protective layer that is provided on the single-layer type photosensitive layer;
in which
   layers that are interposed between the conductive substrate and the inorganic protective layer have a total thickness of 10 μm to 25 μm.

### BRIEF DESCRIPTION OF DRAWINGS

Exemplary embodiment(s) of the present invention will be described in detail based on the following figures, wherein:

FIG. 1 is a schematic sectional view illustrating an example of a layer structure of an electrophotographic photoreceptor of an embodiment;

FIG. 2 is another schematic sectional view illustrating an example of a layer structure of an electrophotographic photoreceptor of the present embodiment;

FIGS. 3A and 3B are schematic views each illustrating an example of a film forming apparatus used for forming an inorganic protective layer of the electrophotographic photoreceptor of the present embodiment;

FIG. 4 is a schematic view illustrating an example of a plasma generating apparatus used for forming an inorganic protective layer of the electrophotographic photoreceptor of the present embodiment;

FIG. 5 is another schematic sectional view illustrating an example of a layer structure of an electrophotographic photoreceptor for positive charging of the present embodiment;

FIG. 6 is another schematic sectional view illustrating an example of a layer structure of an electrophotographic photoreceptor for positive charging of the present embodiment;

FIG. 7 is another schematic sectional view illustrating an example of a layer structure of an electrophotographic photoreceptor for positive charging of the present embodiment;

FIG. 8 is another schematic sectional view illustrating an example of a layer structure of an electrophotographic photoreceptor for positive charging of the present embodiment;

FIG. 9 is a schematic configuration diagram showing an example of an image forming apparatus according to the present embodiment; and

FIG. 10 is another schematic configuration diagram showing an example of an image forming apparatus according to the present embodiment.

### DETAILED DESCRIPTION

Hereinafter, embodiments of the present invention are described.

In the present specification, an “electrophotographic photoreceptor” may be simply referred to as a “photoreceptor”.

[Electrophotographic Photoreceptor]

An electrophotographic photoreceptor according to a first embodiment includes a conductive substrate, a single-layer type photosensitive layer provided on the conductive substrate, and an inorganic protective layer provided on the single-layer type photosensitive layer, in which layers interposed between the conductive substrate and the inorganic protective layer have a total film thickness of 10 μm to 25 μm.

Here, the layers interposed between the conductive substrate and the inorganic protective layer includes, in addition to the single-layer type photosensitive layer, any layer of such as an undercoat layer or an intermediate layer when any one of the undercoat layer or the intermediate layer is provided between the conductive substrate and the inorganic protective layer.

The single-layer type photosensitive layer is a photosensitive layer formed of a single layer having a hole transport ability and an electron transport ability together with a charge generation ability.

Here, a technique of forming an inorganic protective layer on an organic photosensitive layer is conventionally known.

The organic photosensitive layer has flexibility and tends to be deformed easily, and the inorganic protective layer is hard but tends to be inferior in toughness. Therefore, a dent may occur in the inorganic protective layer.

For example, in a developing step, when a carrier is scattered from a developing unit and the scattered carrier adheres to the electrophotographic photoreceptor, the carrier reaches a transfer position while adhering to the electrophotographic photoreceptor. At the transfer position, the carrier receives a pressing force while the carrier is sandwiched between the electrophotographic photoreceptor and the transfer unit. Therefore, for example, the carrier is pressed against the inorganic protective layer between the electrophotographic photoreceptor and the transfer unit, and a dent occurs to the inorganic protective layer.

Therefore, the inventors of the present invention have studied to suppress the occurrence of a dent in the inorganic protective layer, and found an electrophotographic photoreceptor having the following configuration.

That is, the inventors have found an electrophotographic photoreceptor including a single-layer type photosensitive layer and an inorganic protective layer in this order on a conductive substrate, in which layer interposed between the conductive substrate and the inorganic protective layer have a total film thickness of 10 μm to 25 μm.

The conductive substrate and the inorganic protective layer are made of a material having relatively high hardness (for example, 30 GPa or more at a film elastic modulus), and the layers interposed between the conductive substrate and the inorganic protective layer includes the single-layer type photosensitive layer and has low hardness by including an organic compound.

In the electrophotographic photoreceptor according to the first embodiment, by reducing a film thickness of a layer having low hardness that is interposed between the conductive substrate and the inorganic protective layer having high hardness, it is considered that stress may be easily received due to the hardness of the conductive substrate even when the stress is locally applied to the inorganic protective layer via a carrier or the like, and the occurrence of a dent of the inorganic protective layer may be suppressed.

That is, among layers provided on the conductive substrate, the occurrence of a dent of the inorganic protective layer may be suppressed by reducing a proportion of a layer having low hardness, such as the single-layer type photosensitive layer, that has an influence on the occurrence of a dent of the inorganic protective layer.

As described above, in the electrophotographic photoreceptor according to the first embodiment, it is presumed that the occurrence of a dent is suppressed with the above configuration.

In the electrophotographic photoreceptor according to the first embodiment, the single-layer type photosensitive layer preferably includes a binder resin, a charge generation material, a hole transport material, an electron transport material, and silica particles.

The silica particles function as a reinforcing material in the single-layer type photosensitive layer, and may improve the film elastic modulus of the single-layer type photosensitive layer. Further, since the hardness of the single-layer type photosensitive layer as a lower layer is high, the occurrence of a dent in the inorganic protective layer may be effectively suppressed.

A content of the silica particles with respect to the single-layer type photosensitive layer is preferably 40% by mass to 70% by mass, more preferably 45% by mass to 70% by mass, and still more preferably 50% by mass to 65% by mass.

In the electrophotographic photoreceptor according to the first embodiment, it is preferable that, in view of suppressing the occurrence of a dent in the inorganic protective layer, a thickness A of the inorganic protective layer is large and a total film thickness B of layers interposed between the conductive substrate and the inorganic protective layer is small, a ratio (A/B) of the thickness A of the inorganic protective layer to the total film thickness B of layers interposed between the conductive substrate and the inorganic protective layer is preferably 0.12 or more, more preferably 0.16 or more, and even more preferably 0.2 or more.

In the electrophotographic photoreceptor according to the first embodiment, a proportion of a thickness of the single-layer type photosensitive layer in the total thickness B of the layers interposed between the conductive substrate and the inorganic protective layer is preferably 50% to 100%, and more preferably 90% to 100%.

Here, a method of measuring a film thickness of each layer provided on the conductive substrate is described.

In the method, a cross section of the electrophotographic photoreceptor is cut off and taken of an image with an optical microscope (model number: VHX 100 manufactured by Keyence Corporation), such that a film thickness is measured from the obtained cross-sectional image.

Film thicknesses of any five points on a measurement target is measured from the cross-sectional image, and an average is obtained as the film thickness.

Hereinafter, the electrophotographic photoreceptor according to the first embodiment is described in detail with reference to the drawings. In the drawings, the same or corresponding parts are denoted by the same reference numerals, and redundant description of these parts is omitted.

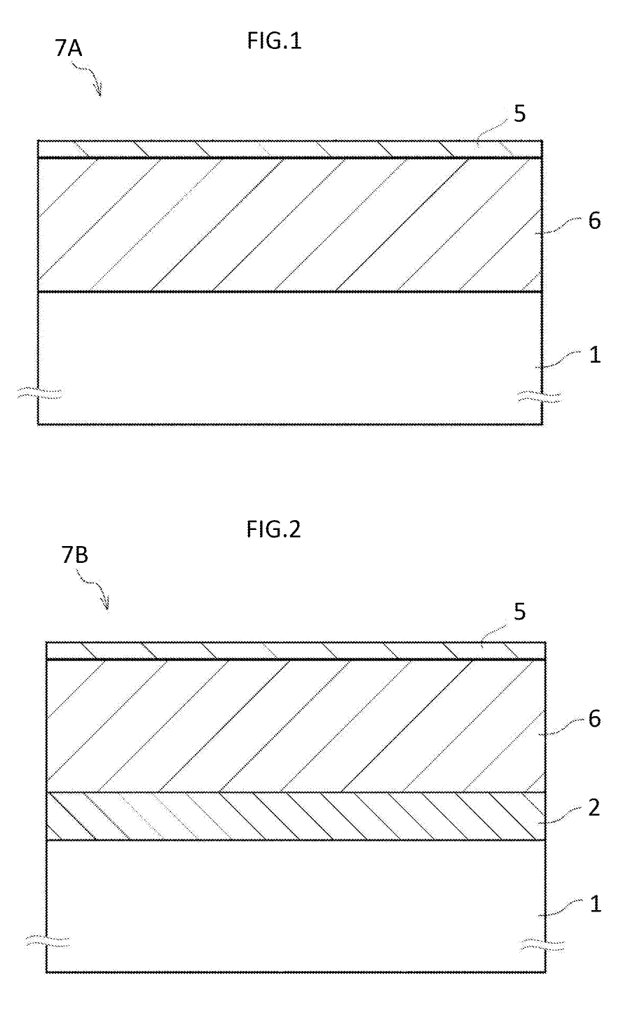

FIGS. 1 and 2 are schematic cross sectional views illustrating an example of a layer structure of the electrophotographic photoreceptor according to the first embodiment.

A photoreceptor 7A illustrated in FIG. 1 is provided with a single-layer type photosensitive layer 6 and an inorganic protective layer 5 in this order on a conductive substrate 1.

A photoreceptor 7B illustrated in FIG. 2 is provided with an undercoat layer 2, the single-layer type photosensitive layer 6, and the inorganic protective layer 5 in this order on the conductive substrate 1.

An intermediate layer may be provided as an arbitrary layer between the conductive substrate 1 and the single-layer type photosensitive layer 6 in FIG. 1 or between the conductive substrate 1 and the undercoat layer 2 in FIG. 2.

In the first embodiment, in the case of the photoreceptor 7A illustrated in FIG. 1, a total thickness of the layers interposed between the conductive substrate and the inorganic protective layer, that is, a thickness of the single-layer type photosensitive layer 6 is 10 μm to 25 μm.

In the case of the photoreceptor 7A illustrated in FIG. 2, a total thickness of the layers interposed between the conductive substrate and the inorganic protective layer, that is, a thickness of the undercoat layer 2 and the single-layer type photosensitive layer 6 is 10 μm to 25 μm.

Hereinafter, elements configuring the electrophotographic photoreceptor are described.

Reference numerals may be omitted in some cases.

(Conductive Substrate)

Examples of the conductive substrate include a metal plate including a metal (aluminum, copper, zinc, chromium, nickel, molybdenum, vanadium, indium, gold, platinum, etc) or an alloy (such as stainless steel), a metal drum, and a metal belt. For example, the conductive substrate includes a conductive compound (for example, a conductive polymer or indium oxide), a metal (for example, aluminum, palladium, gold) or a paper coating, vapor depositing, or laminating an alloy, a resin film a belt, and the like. Here, “conductivity” means that a volume resistivity is less than 10¹³ (1 cm.

When the electrophotographic photoreceptor is used in a laser printer, a surface of the conductive substrate is preferably roughened to 0.04 μm to 0.5 μm in terms of center line average roughness Ra in order to suppress interference fringes generated when laser light is irradiated. When incoherent light is used as a light source, the roughening for preventing interference fringes is not particularly necessary, but is suitable for a longer life by suppressing occurrence of defects due to unevenness of the surface of the conductive substrate.

Examples of the roughening method include wet honing that is performed by suspending a polishing agent in water and spraying the polishing agent on the conductive substrate, centerless grinding in which the conductive substrate is pressed to a rotating grindstone and is continuously ground, and anodizing treatment.

The roughening method further includes a method in which the surface of the conductive substrate is not roughened, a conductive or semi conductive powder is dispersed in a resin, and a layer is formed on the surface of the conductive substrate, such that the surface is roughened by particles dispersed in the layer.

In roughening treatment via anodic oxidation, an oxide film is formed on the surface of a conductive substrate by taking a conductive substrate made of metal (for example, aluminum) as an anode and anodizing the conductive substrate in an electrolyte solution. Examples of the electrolyte solution include such as a sulfuric acid solution and an oxalic acid solution. However, a porous anodic oxide film formed by anodic oxidation is chemically active in a state as it is and easily contaminated, and has large resistance variation due to the environment. Therefore, it is preferable to perform sealing treatment to the porous anodic oxide film, in which micropores of the oxide film are blocked by volume expansion via hydration reaction in pressurized water vapor or boiling water (or a metal salt such as nickel may be added) and converted into more stable hydrated oxide.

A thickness of the anodic oxide film is preferably 0.3 μm to 15 μm. When the film thickness is within the above range, barrier properties against injection tend to be exhibited, and an increase in residual potential due to repeated use tends to be suppressed.

The conductive substrate may be subjected to a treatment with an acidic treatment liquid or a boehmite treatment.

The treatment with an acidic treatment liquid is performed, for example, as follows. First, an acidic treatment liquid containing a phosphoric acid, a chromic acid, and a hydrofluoric acid is prepared. Blending ratios of the phosphoric acid, the chromic acid and the hydrofluoric acid in the acidic treatment liquid are, for example, as follows: the phosphoric acid is in a range of 10% by mass to 11% by mass, the chromic acid is in a range of 3% by mass to 5% by mass, and the hydrofluoric acid is in a range of 0.5% by mass to 2% by mass, and concentration of these acids may be in a range of 13.5% by mass to 18% by mass. A treatment temperature is preferably, for example, 42° C. to 48° C. A film thickness of the coating film is preferably 0.3 μm to 15 μm.

The boehmite treatment is performed, for example, by immersing the conductive substrate in pure water at 90° C. to 100° C. for 5 minutes to 60 minutes, or make the conductive substrate contact with heated water vapor at 90° C. to 120° C. for 5 minutes to 60 minutes. A film thickness of the coating film is preferably 0.1 μm to 5 μm. The conductive substrate may be further subjected to anodizing treatment using an electrolyte solution having low film solubility such as an adipic acid, a boric acid, a borate, a phosphate, a phthalate, a maleate, a benzoate, a tartrate, and a citrate. The conductive substrate may be further subjected to anodizing treatment using an electrolyte solution having low film solubility such as an adipic acid, a boric acid, a borate, a phosphate, a phthalate, a maleate, a benzoate, a tartrate, and a citrate.

A thickness of the conductive substrate may be 1 mm or more, preferably 1.2 mm or more, and more preferably 1.5 mm or more in order to ensure strength of the photoreceptor and suppress the occurrence of a scratch in the inorganic protective layer. A maximum thickness of the conductive substrate is not particularly limited, and may be, for example, 3.5 mm or less, 3 mm or less, or less than 3 mm for suppressing the occurrence of a scratch of the inorganic protective layer and for operability or manufacturability of the photoreceptor. When the thickness of the conductive substrate is in the above range, bending of the conductive substrate is easily suppressed, and the occurrence of a scratch in the inorganic protective layer is easily suppressed.

(Single-layer Type Photosensitive Layer)

The single-layer type photosensitive layer may be a single layer having a charge generating ability, a hole transport ability and an electron transport ability, and is preferably a photosensitive layer including a binder resin, a charge generation material, an electron transport material, and a hole transport material, and more preferably a photosensitive layer including a binder resin, a charge generation material, an electron transport material, a hole transport material, and silica particles.

—Binder Resin—

Examples of the binder resin include a polycarbonate resin, a polyester resin, a polyarylate resin, a methacrylic resin, an acrylic resin, a polyvinyl chloride resin, a polyvinylidene chloride resin, a vinylidene chloride-acrylonitrile copolymer, a vinyl chloride-vinyl acetate copolymer, a vinyl chloride-vinyl acetate maleic anhydride copolymer, a styrene-alkyd resin, poly-N-vinyl carbazole, and polysilane. These binder resins may be used alone or as a mixture of two or more.

Among these binder resins, the polycarbonate resin and the polyarylate resin are preferable in view of such as mechanical strength of the single-layer type photosensitive layer.

In view of film-forming properties of the single-layer type photosensitive layer, at least one of the polycarbonate resin having a viscosity-average molecular weight of 30, 000 to 80, 000 and the polyarylate resin having a viscosity-average molecular weight of 30, 000 to 80, 000 may be used.

The viscosity-average molecular weight is a value measured by the following method. 1 g of a resin is dissolved in 100 cm3 of methylene chloride, and specific viscosity qsp is measured with an Ubbelohde viscometer under a 25° C. measurement environment. Then, the intrinsic viscosity [η] (cm3/g) is obtained from a relational expression ηsp/c=[η]+0.45 [η]²c (where c is concentration (g/cm³)), and the viscosity-average molecular weight Mv is obtained from a relational expression [μ]=1.23×10⁻⁴ Mv^{0.83} given by H. Schnell.

A content of the binder resin to a total solid content excluding the silica particles in the single-layer type photosensitive layer is, for example, 35% by mass to 60% by mass, desirably 40% by mass to 55% by mass.

—Charge Generation Material—

Examples of the charge generation material include an azo pigment such as bisazo and trisazo, a condensed aromatic pigment such as dibromoanthanthrone, a perylene pigment, a pyrrolopyrrole pigment, a phthalocyanine pigment, zinc oxide, and trigonal selenium.

Among these, a metal phthalocyanine pigment or a metal-free phthalocyanine pigment may be used as the charge generation material to correspond to laser exposure in a near-infrared region. Specific examples of the charge generation material include hydroxygallium phthalocyanine, chlorogallium phthalocyanine, dichlorotin phthalocyanine, and titanyl phthalocyanine.

Meanwhile, in order to correspond to laser exposure in a near ultraviolet region, a condensed aromatic pigment such as dibromoanthanthrone, a thioindigo pigment, a porphyrazine compound, zinc oxide, trigonal selenium, and a bisazo pigment may be used.

That is, when a light source having an exposure wavelength of, for example, 380 nm to 500 nm is used, an inorganic pigment may be used as the charge generation material, and when a light source having an exposure wavelength of 700 nm to 800 nm is used, a metal and a metal-free phthalocyanine pigment may be used.

Above all, at least one selected from the hydroxygallium phthalocyanine pigment and the chlorogallium phthalocyanine pigment is preferably used as the charge generation material. These charge generation materials may be used alone or as a mixture of two or more. In view of sensitivity of the photoreceptor, a hydroxygallium phthalocyanine pigment may be used.

When the hydroxygallium phthalocyanine pigment and the chlorogallium phthalocyanine pigment are used in combination, a ratio of the hydroxygallium phthalocyanine pigment to the chlorogallium phthalocyanine pigment may be 9:1 to 3:7 (preferably 9:1 to 6:4) in terms of mass ratio.

The hydroxygallium phthalocyanine pigment is not particularly limited, and a V-type hydroxygallium phthalocyanine pigment may be used.

Particularly, the hydroxygallium phthalocyanine pigment is preferable in view that, for example, a hydroxygallium phthalocyanine pigment having a maximum peak wavelength in a range of 810 nm to 839 nm in a spectral absorption spectrum in a wavelength range of 600 nm to 900 nm has better dispersibility.

The hydroxygallium phthalocyanine pigment having a maximum peak wavelength in the range of 810 nm to 839 nm preferably has an average particle diameter in a specific range and a specific BET specific surface area. Specifically, the average particle diameter is preferably 0.20 μm or less, and more preferably 0.01 μm to 0.15 μm. Meanwhile, the BET specific surface area is preferably 45 m²/g or more, more preferably 50 m²/g or more, and still more preferably 55 m²/g to 120 m²/g. The average particle diameter is a volume average particle diameter measured by a laser diffraction scattering particle size distribution analyzer (LA-700 by Horiba, Ltd.). The BET specific surface area is a value measured by a nitrogen substitution method using a flow ratio surface area automatic measuring apparatus (Shimadzu flow soap II 2300).

The maximum particle diameter (maximum value of a primary particle diameter) of the hydroxygallium phthalocyanine pigment is preferably 1.2 μm or less, more preferably 1.0 μm or less, and still more preferably 0.3 m or less.

The hydroxygallium phthalocyanine pigment preferably has an average particle diameter of 0.2 μm or less, a maximum particle diameter of 1.2 μm or less, and a BET specific surface area of 45 m²/g or more.

The hydroxygallium phthalocyanine pigment preferably has a diffraction peak at a Bragg angle (2θ±0.2°) of at least 7.3°, 16.00, 24.9°, and 28.0° in an X-ray diffraction spectrum using a CuKα characteristic X-ray.

Meanwhile, the chlorogallium phthalocyanine pigment is preferably a compound having a diffraction peak at a Bragg angle (2θ±0.2°) of 7.4°, 16.6°, 25.50, and 28.3° in view of the sensitivity of the single-layer type photosensitive layer. Preferable ranges of a maximum peak wavelength, an average particle diameter, a maximum particle diameter, and a BET specific surface area of the chlorogallium phthalocyanine pigment are the same as those of the hydroxygallium phthalocyanine pigment.

The charge generation material may be used alone or in combination of two or more.

A content of the charge generation material with respect to the total solid content excluding the silica particles in the single-layer type photosensitive layer is preferably 0.8% by mass to 5% by mass, more preferably 0.8% by mass to 4% by mass, and still more preferably from 0.8% by mass to 3% by mass in view of suppressing density irregularity at beginning of image formation.

—Hole Transport Material—

The hole transport material is not particularly limited, and examples thereof include an oxadiazole derivative such as 2,5-bis(p-diethylaminophenyl)-1,3,4-oxadiazole, a pyrazoline derivative such as 1,3,5-triphenyl-pyrazoline and 1-[pyridyl-(2)]-3-(p-diethylaminostyryl)-5-(p-diethylaminostyryl) pyrazoline, an aromatic tertiary amino compound such as triphenylamine, N,N′-bis(3,4-dimethylphenyl) biphenyl-4-amine, tri(p-methylphenyl) aminyl-4-amine, and dibenzyl aniline, an aromatic tertiary diamino compound such as N,N′-Bis(3-methylphenyl)-N,N′-diphenylbenzidine, a 1,2,4-triazine derivative such as 3-(4′-dimethylaminophenyl)-5-6-di-(4′-methoxyphenyl)-1,2,4-triazine, an Hydrazone derivative such as 4-diethylaminobenzaldehyde-1,1-diphenylhydrazone, a quinazoline derivative such as 2-phenyl-4-styryl-quinazoline, a benzofuran derivative such as 6-hydroxy-2,3-di(p-methoxyphenyl) benzofuran, a α-stilbene derivative such as p-(2,2-diphenylvinyl)-N,N-diphenylaniline, an enamine derivative, a carbazole derivative such as N-ethylcarbazole, poly-N-vinylcarbazole and a derivative thereof, a polymer having a group composed of the above compounds in a main chain or a side chain, and the like. These hole transport materials may be used alone or in combination of two or more thereof.

Specific examples of the hole transport material include compounds represented by the following general formula (HT1) and compounds represented by the following general formula (HT2). Further, examples thereof include compounds represented by the following general formula (1). Among these compounds, the compounds represented by the following general formula (1) are preferably used in view of charge mobility.

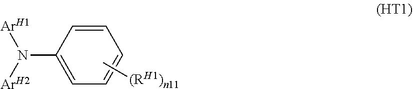

In the general formula (HT1), R^{H1} represents a hydrogen atom or a methyl group, n11 represents 1 or 2. Ar^{H1} and Ar^{H2} each independently represent a substituted or unsubstituted aryl group, —C₆H₄—C(R^{H3})═C(R^{H4})(R^{H5}), or —C₆H₄—CH═CH—CH═C(R^{H6})(R^{H7}), and R^{H3} to R^{H7} each independently represent a hydrogen atom, a substituted or unsubstituted alkyl group, or a substituted or unsubstituted aryl group. The substituent represents a halogen atom, an alkyl group having 1 to 5 carbon atoms, an alkoxy group having 1 to 5 carbon atoms, or a substituted amino group substituted with an alkyl group having 1 to 3 carbon atoms.

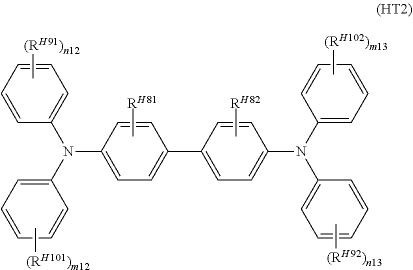

In the general formula (H2), R^{H81} and R^{H82} may be the same or different, and each independently represent a hydrogen atom, a halogen atom, an alkyl group having 1 to 5 carbon atoms, or an alkoxy group having 1 to 5 carbon atoms. R^{H91}, R^{H92}, R^{H101} and R^{H102} may be the same or different, and each independently represent a halogen atom, an alkyl group having 1 to 5 carbon atoms, an alkoxy group having 1 to 5 carbon atoms, an amino group substituted with an alkyl group having 1 to 2 carbon atoms, a substituted or unsubstituted aryl group, —C(R^{H11})═C(R^{H12})(R^{H13}), or —CH═CH—CH═C(R^{H14})(R^{H15}), and R^{H11} to R^{H15} each independently represent a hydrogen atom, a substituted or unsubstituted alkyl group, or a substituted or unsubstituted aryl group. m12, m13, n12 and n13 each independently represent an integer of 0 to 2.

Among the compounds represented by the general formula (HT1) and the compounds represented by the general formula (HT2), a compound represented by the general formula (HT1) having “—C₆H₄—CH═CH═C(R^{H6})(R^{H7})” and a compound represented by the general formula (HT2) having “—CH═CH—CH═C(R^{H14})(R^{H15})” are preferable.

Specific examples of the compounds represented by the general formula (HT1) and the compounds represented by the general formula (HT2) include the following structural formulas (HT-A) to (HT-G), but the hole transport material is not limited thereto.

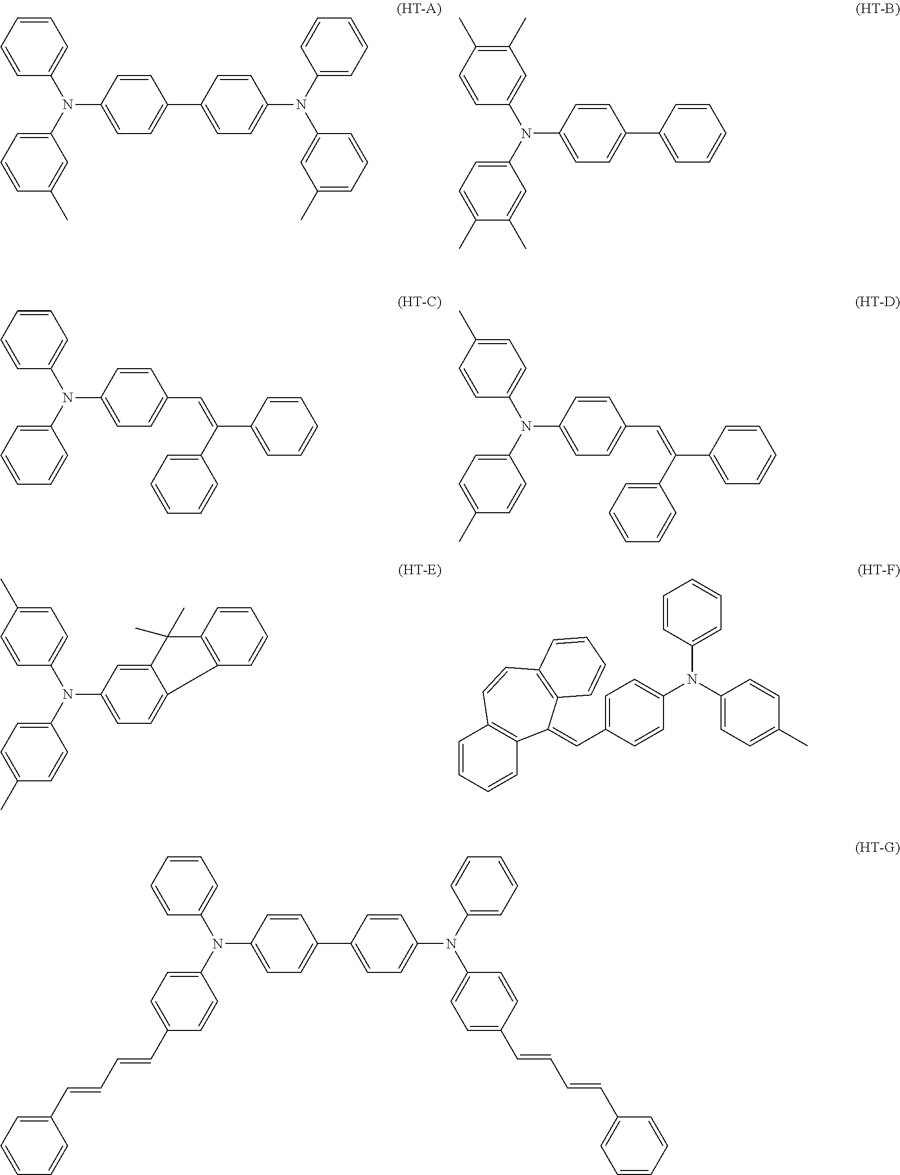

Next, the compounds represented by the general formula (1) are described.

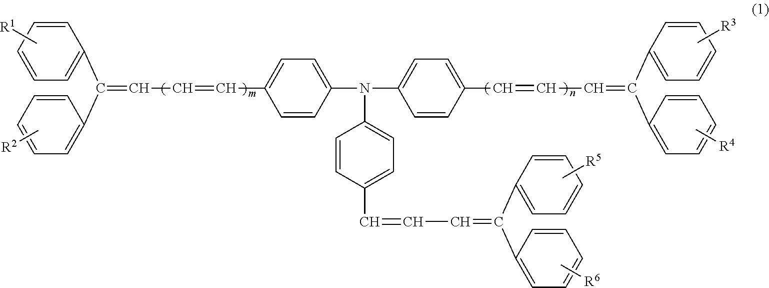

In the general formula (1), R¹, R², R³, R⁴, R⁵, and R⁶ each independently represent a hydrogen atom, a lower alkyl group, an alkoxy group, a phenoxy group, a halogen atom, or a phenyl group that may have a substituent selected from a lower alkyl group, a lower alkoxy group and a halogen atom. m and n each independently represent 0 or 1.

In the general formula (1), examples of the lower alkyl group represented by R¹ to R⁶ include a linear or branched alkyl group having 1 to 4 carbon atoms, and specific examples thereof include a methyl group, an ethyl group, an n-propyl group, an isopropyl group, an n-butyl group and an isobutyl group. Among these groups, the methyl group and the ethyl group are preferably used as the lower alkyl group.

In the general formula (1), examples of the alkoxy group represented by R¹ to R⁶ include an alkoxy group having 1 to 4 carbon atoms, and specific examples thereof include a methoxy group, an ethoxy group, a propoxy group, and a butoxy group.

In the general formula (1), examples of the halogen atom represented by R¹ to R⁶ include a fluorine atom, a chlorine atom, a bromine atom and an iodine atom.

In the general formula (1), examples of the phenyl group represented by R¹ to R⁶ include an unsubstituted phenyl group, a lower alkyl group-substituted phenyl group such as a p-tolyl group and a 2,4-dimethylphenyl group, a lower alkoxy group-substituted phenyl group such as a p-methoxyphenyl group, and a halogen atom-substituted phenyl group such as a p-chlorophenyl group.

Examples of the substituent that may be substituted on the phenyl group include a lower alkyl group, a lower alkoxy group and a halogen atom that are represented by R¹ to R⁶.

Among the compounds represented by the general formula (1), in view of high sensitivity, a hole transport material in which m and n are 1 is preferable, and a hole transport material in which R¹ to R⁶ each independently represent a hydrogen atom, a lower alkyl group having 1 to 4 carbon atoms, or an alkoxy group and m and n are 1 is more preferable.

Hereinafter, examples of the compounds represented by the general formula (1) include compounds (1-1) to (1-64), but the present invention is not limited thereto. A number attached before the substituent indicates a substitution position with respect to a benzene ring.

| Compound | m | n | R¹ | R² | R³ | R⁴ | R⁵ | R⁶ |
|---|---|---|---|---|---|---|---|---|
| 1-1 | 1 | 1 | H | H | H | H | H | H |
| 1-2 | 1 | 1 | 4-CH₃ | 4-CH₃ | 4-CH₃ | 4-CH₃ | 4-CH₃ | 4-CH₃ |
| 1-3 | 1 | 1 | 4-CH₃ | 4-CH₃ | H | H | 4-CH₃ | 4-CH₃ |
| 1-4 | 1 | 1 | 4-CH₃ | H | 4-CH₃ | H | 4-CH₃ | H |
| 1-5 | 1 | 1 | H | H | 4-CH₃ | 4-CH₃ | H | H |
| 1-6 | 1 | 1 | 3-CH₃ | 3-CH₃ | 3-CH₃ | 3-CH₃ | 3-CH₃ | 3-CH₃ |
| 1-7 | 1 | 1 | H | H | H | H | 4-Cl | 4-Cl |
| 1-8 | 1 | 1 | 4-OCH₃ | H | 4-OCH₃ | H | 4-OCH₃ | H |
| 1-9 | 1 | 1 | H | H | H | H | 4-OCH₃ | 4-OCH₃ |
| 1-10 | 1 | 1 | 4-OCH₃ | 4-OCH₃ | 4-OCH₃ | 4-OCH₃ | 4-OCH₃ | 4-OCH₃ |
| 1-11 | 1 | 1 | 4-OCH₃ | H | 4-OCH₃ | H | 4-OCH₃ | 4-OCH₃ |
| 1-12 | 1 | 1 | 4-CH₃ | H | 4-CH₃ | H | 4-CH₃ | 4-F |
| 1-13 | 1 | 1 | 3-CH₃ | H | 3-CH₃ | H | 3-CH₃ | H |
| 1-14 | 1 | 1 | 4-Cl | H | 4-Cl | H | 4-Cl | H |
| 1-15 | 1 | 1 | 4-Cl | 4-Cl | 4-Cl | 4-Cl | 4-Cl | 4-Cl |
| 1-16 | 1 | 1 | 3-CH₃ | 3-CH₃ | 3-CH₃ | 3-CH₃ | 3-CH₃ | 3-CH₃ |
| 1-17 | 1 | 1 | 4-CH₃ | 4-OCH₃ | 4-CH₃ | 4-OCH₃ | 4-CH₃ | 4-OCH₃ |
| 1-18 | 1 | 1 | 3-CH₃ | 4-OCH₃ | 3-CH₃ | 4-OCH₃ | 3-CH₃ | 4-OCH₃ |
| 1-19 | 1 | 1 | 3-CH₃ | 4-Cl | 3-CH₃ | 4-Cl | 3-CH₃ | 4-Cl |
| 1-20 | 1 | 1 | 4-CH₃ | 4-Cl | 4-CH₃ | 4-Cl | 4-CH₃ | 4-Cl |
| 1-21 | 1 | 0 | H | H | H | H | H | H |
| 1-22 | 1 | 0 | 4-CH₃ | 4-CH₃ | 4-CH₃ | 4-CH₃ | 4-CH₃ | 4-CH₃ |
| 1-23 | 1 | 0 | 4-CH₃ | 4-CH₃ | H | H | 4-CH₃ | 4-CH₃ |
| 1-24 | 1 | 0 | H | H | 4-CH₃ | 4-CH₃ | H | H |
| 1-25 | 1 | 0 | H | H | 3-CH₃ | 3-CH₃ | H | H |
| 1-26 | 1 | 0 | H | H | 4-Cl | 4-Cl | H | H |
| 1-27 | 1 | 0 | 4-CH₃ | H | H | H | 4-CH₃ | H |
| 1-28 | 1 | 0 | 4-OCH₃ | H | H | H | 4-OCH₃ | H |
| 1-29 | 1 | 0 | H | H | 4-OCH₃ | 4-OCH₃ | H | H |
| 1-30 | 1 | 0 | 4-OCH₃ | 4-OCH₃ | 4-OCH₃ | 4-OCH₃ | 4-OCH₃ | 4-OCH₃ |
| 1-31 | 1 | 0 | 4-OCH₃ | H | 4-OCH₃ | H | 4-OCH₃ | 4-OCH₃ |
| 1-32 | 1 | 0 | 4-CH₃ | H | 4-CH₃ | H | 4-CH₃ | 4-F |
| 1-33 | 1 | 0 | 3-CH₃ | H | 3-CH₃ | H | 3-CH₃ | H |
| 1-34 | 1 | 0 | 4-Cl | H | 4-Cl | H | 4-Cl | H |
| 1-35 | 1 | 0 | 4-Cl | 4-Cl | 4-Cl | 4-Cl | 4-Cl | 4-Cl |
| 1-36 | 1 | 0 | 3-CH₃ | 3-CH₃ | 3-CH₃ | 3-CH₃ | 3-CH₃ | 3-CH₃ |
| 1-37 | 1 | 0 | 4-CH₃ | 4-OCH₃ | 4-CH₃ | 4-OCH₃ | 4-CH₃ | 4-OCH₃ |
| 1-38 | 1 | 0 | 3-CH₃ | 4-OCH₃ | 3-CH₃ | 4-OCH₃ | 3-CH₃ | 4-OCH₃ |
| 1-39 | 1 | 0 | 3-CH₃ | 4-Cl | 3-CH₃ | 4-Cl | 3-CH₃ | 4-Cl |
| 1-40 | 1 | 0 | 4-CH₃ | 4-Cl | 4-CH₃ | 4-Cl | 4-CH₃ | 4-Cl |
| 1-41 | 0 | 0 | H | H | H | H | H | H |
| 1-42 | 0 | 0 | 4-CH₃ | 4-CH₃ | 4-CH₃ | 4-CH₃ | 4-CH₃ | 4-CH₃ |
| 1-43 | 0 | 0 | 4-CH₃ | 4-CH₃ | 4-CH₃ | 4-CH₃ | H | H |
| 1-44 | 0 | 0 | 4-CH₃ | H | 4-CH₃ | H | H | H |
| 1-45 | 0 | 0 | H | H | H | H | 4-CH₃ | 4-CH₃ |
| 1-46 | 0 | 0 | 3-CH₃ | 3-CH₃ | 3-CH₃ | 3-CH₃ | H | H |
| 1-47 | 0 | 0 | H | H | H | H | 4-Cl | 4-Cl |
| 1-48 | 0 | 0 | 4-OCH₃ | H | 4-OCH₃ | H | H | H |
| 1-49 | 0 | 0 | H | H | H | H | 4-OCH₃ | 4-OCH₃ |
| 1-50 | 0 | 0 | 4-OCH₃ | 4-OCH₃ | 4-OCH₃ | 4-OCH₃ | 4-OCH₃ | 4-OCH₃ |
| 1-51 | 0 | 0 | 4-OCH₃ | H | 4-OCH₃ | H | 4-OCH₃ | 4-OCH₃ |
| 1-52 | 0 | 0 | 4-CH₃ | H | 4-CH₃ | H | 4-CH₃ | 4-F |
| 1-53 | 0 | 0 | 3-CH₃ | H | 3-CH₃ | H | 3-CH₃ | H |
| 1-54 | 0 | 0 | 4-Cl | H | 4-Cl | H | 4-Cl | H |
| 1-55 | 0 | 0 | 4-Cl | 4-Cl | 4-Cl | 4-Cl | 4-Cl | 4-Cl |
| 1-56 | 0 | 0 | 3-CH₃ | 3-CH₃ | 3-CH₃ | 3-CH₃ | 3-CH₃ | 3-CH₃ |
| 1-57 | 0 | 0 | 4-CH₃ | 4-OCH₃ | 4-CH₃ | 4-OCH₃ | 4-CH₃ | 4-OCH₃ |
| 1-58 | 0 | 0 | 3-CH₃ | 4-OCH₃ | 3-CH₃ | 4-OCH₃ | 3-CH₃ | 4-OCH₃ |
| 1-59 | 0 | 0 | 3-CH₃ | 4-Cl | 3-CH₃ | 4-Cl | 3-CH₃ | 4-Cl |
| 1-60 | 0 | 0 | 4-CH₃ | 4-Cl | 4-CH₃ | 4-Cl | 4-CH₃ | 4-Cl |
| 1-61 | 1 | 1 | 4-C₃H₇ | 4-C₃H₇ | 4-C₃H₇ | 4-C₃H₇ | 4-C₃H₇ | 4-C₃H₇ |
| 1-62 | 1 | 1 | 4-OC₆H₅ | 4-OC₆H₅ | 4-OC₆H₅ | 4-OC₆H₅ | 4-OC₆H₅ | 4-OC₆H₅ |
| 1-63 | 1 | 1 | H | 4-CH₃ | H | 4-CH₃ | H | 4-CH₃ |
| 1-64 | 1 | 1 | 4-C₆H₅ | 4-C₆H₅ | 4-C₆H₅ | 4-C₆H₅ | 4-C₆H₅ | 4-C₆H₅ |

Abbreviations in the above compounds have the following meanings.
4-CH₃: a methyl group substituted at a 4-position of a phenyl group;
3-CH₃: a methyl group substituted at a 3-position of a phenyl group;
4-Cl: a chlorine atom substituting at a 4-position of a phenyl group;
4-OCH₃: a methoxy group substituted at a 4-position of a phenyl group;
4-F: a fluorine atom substituting at a 4-position of a phenyl group;
4-C₃H₇: a propyl group substituted at a 4-position of a phenyl group;
4-C₆H₅: a phenyl group substituted at a 4-position of a phenyl group; and
4-PhO: a phenoxy group substituted with a 4-position of a phenyl group.

<Electron Transport Material>

The electron transport material is not particularly limited, and examples thereof include a quinone compound such as chloranilic and bromoil, a tetracyanoquinodimethane compound, a fluorenone compound such as 2,4,7-trinitro-9-fluorenone, 2,4,5,7-tetranitro-9-fluorenone, and 9-dicyanomethylene-9-fluorenone-4-carboxylate, an oxadiazole compound such as 2-(4-biphenyl)-5-(4-t-butylphenyl)-1,3,4-oxadiazole, 2,5-bis(4-naphthyl)-1,3,4-oxadiazole, and 2,5-bis(4-diethya a laminophenyl)1,3,4-oxadiazole, an xanthone compound, a thiophene compound, a dinaphthoquinone compound such as 3,3′-di-tert-pentyl-dinaphthoquinone, a diphenoquinone compound such as 3,3′-di-tert-butyl-5,5′-dimethyldiphenoquinone and 3,3′,5,5′-tetra-tert-butyl-4,4′-diphenoquinone, a polymer having a group composed of the above compounds in a main chain or a side chain, and the like. These electron transport materials may be used alone or in combination of two or more.

The electron transport material is preferably a compound represented by the following Formula (2) in view of high sensitivity.

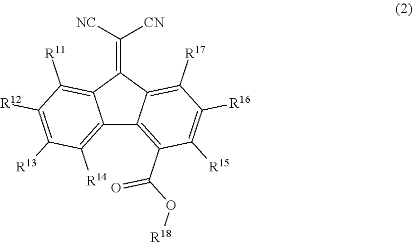

In the general formula (2), R¹¹, R¹², ^{R13}, R¹⁴, R¹⁵, R¹⁶, and R¹⁷ each independently represent a hydrogen atom, a halogen atom, an alkyl group, an alkoxy group, an aryl group, or an aralkyl group. R¹⁸ represents an alkyl group, -L¹⁹-O—R²⁰, an aryl group, or an aralkyl group. L¹⁹ represents an alkylene group, and R²⁰ represents an alkyl group.

In the general formula (2), examples of the halogen atom represented by R¹¹ to R¹⁷ include a fluorine atom, a chlorine atom, a bromine atom and an iodine atom.

In the general formula (2), examples of the alkyl group represented by R¹¹ to R¹⁷ include a linear or branched alkyl group having 1 to 4 (preferably 1 to 3) carbon atoms, and specific examples thereof include a methyl group, an ethyl group, an n-propyl group, an isopropyl group, an n-butyl group and an isobutyl group.

In the general formula (2), examples of the alkoxy group represented by R¹¹ to R¹⁷ include an alkoxy group having 1 to 4 (preferably 1 to 3) carbon atoms and specific examples thereof include a methoxy group, an ethoxy group, a propoxy group, and a butoxy group.

In the general formula (2), examples of the aryl group represented by R¹¹ to R¹⁷ include a phenyl group and a tolyl group. Among these groups, the phenyl group is preferably used as the aryl group represented by R¹¹ to R¹⁷.

In the general formula (2), examples of the aralkyl group represented by R¹¹ to R¹⁷ include a benzyl group, a phenethyl group, and a phenylpropyl group.

In the general formula (2), examples of the alkyl group represented by R¹⁸ include a linear alkyl group having 1 to 12 carbon atoms (preferably having 5 to 10 carbon atoms) and a branched alkyl group having 3 to 10 carbon atoms (preferably having 5 to 10 carbon atoms).

Examples of the linear alkyl group having 1 to 12 carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, and an n-dodecyl group.

Examples of the branched alkyl group having 3 to 10 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, sec-octyl group, tert-octyl group, an isononyl group, a sec-nonyl group, a tert-nonyl group, an isodecyl group, a sec-decyl group, and a tert-decyl group.

In the general formula (2), in the group represented by -L¹⁹-O—R²⁰ represented by R¹⁸, L¹⁹ represents an alkylene group, and R²⁰ represents an alkyl group.

Examples of the alkylene group represented by L¹⁹ include a linear or branched alkylene group having 1 to 12 carbon atoms, and examples thereof include a methylene group, an ethylene group, an n-propylene group, an isopropylene group, an n-butylene group, an isobutylene group, a sec-butylene group, a tert-butylene group, an n-pentylene group, an isopentylene group, an neopentylene group, and a tert-pentylene group. Examples of the alkyl group represented by R²⁰ include the same groups as those described above for R¹¹ to R⁷.

In the general formula (2), examples of the aralkyl group represented by R¹⁸ include a phenyl group, a methylphenyl group, a dimethylphenyl group, and an ethylphenyl group.

The aryl group represented by R¹⁸ is preferably an alkyl substituted aryl group substituted with an alkyl group in view of solubility. Examples of the alkyl group of the alkyl-substituted aryl group include the same groups as those described for R¹¹ to R⁷.

In the general formula (2), examples of the aralkyl group represented by R¹⁸ include a group represented by -L²¹-Ar. L²¹ represents an alkylene group, and Ar represents an aryl group.

Examples of the alkylene group represented by L²¹ include a linear or branched alkylene group having 1 to 12 carbon atoms, and examples thereof include a methylene group, an ethylene group, an n-propylene group, an isopropylene group, an n-butylene group, an isobutylene group, a sec-butylene group, a tert-butylene group, an n-pentylene group, an isopentylene group, an neopentylene group, and a tert-pentylene group.

Examples of the aralkyl group represented by Ar include a phenyl group, a methylphenyl group, a dimethylphenyl group, and an ethylphenyl group.

In the general formula (2), specific examples of the aralkyl group represented by R¹⁸ include a benzyl group, a methylbenzyl group, a dimethylbenzyl group, a phenylethyl group, a methylphenylethyl group, a phenylpropyl group, and a phenylbutyl group.

The electron transport material of the general formula (2) is preferably an electron transport material in which R18 represents an alkyl group or an aralkyl group having 5 to 10 carbon atoms, particularly, an electron transport material in which R¹¹ to R¹⁷ each independently represent a hydrogen atom, a halogen atom or an alkyl group and R¹⁸ represents an alkyl group or an aralkyl group having 5 to 10 carbon atoms.

Exemplary compounds of the electron transport material of the general formula (2) are shown below, but the present invention is not limited thereto. The following exemplary compound numbers are described below as exemplary compounds (2-number). Specifically, for example, Exemplified Compound 15 is hereinafter referred to as “Exemplary Compound (2-15)”.

| Exemplified | | | | | | | | |
|---|---|---|---|---|---|---|---|---|
| Compound | R¹¹ | R¹² | R¹³ | R¹⁴ | R¹⁵ | R¹⁶ | R¹⁷ | R¹⁸ |
| 1 | H | H | H | H | H | H | H | —n-C₇H₁₅ |
| 2 | H | H | H | H | H | H | H | —n-C₈H₁₇ |
| 3 | H | H | H | H | H | H | H | —n-C₅H₁₁ |
| 4 | H | H | H | H | H | H | H | —n-C₁₀H₂₁ |
| 5 | Cl | Cl | Cl | Cl | Cl | Cl | Cl | —n-C₇H₁₅ |
| 6 | H | Cl | H | Cl | H | Cl | Cl | —n-C₇H₁₅ |
| 7 | CH₃ | CH₃ | CH₃ | CH₃ | CH₃ | CH₃ | CH₃ | —n-C₇H₁₅ |
| 8 | C₄H₉ | C₄H₉ | C₄H₉ | C₄H₉ | C₄H₉ | C₄H₉ | C₄H₉ | —n-C₇H₁₅ |
| 9 | CH₃O | H | CH₃O | H | CH₃O | H | CH₃O | —n-C₈H₁₇ |
| 10 | C₆H₅ | C₆H₅ | C₆H₅ | C₆H₅ | C₆H₅ | C₆H₅ | C₆H₅ | —n-C₈H₁₇ |
| 11 | H | H | H | H | H | H | H | —n-C₄H₉ |
| 12 | H | H | H | H | H | H | H | —n-C₁₁H₂₃ |
| 13 | H | H | H | H | H | H | H | —n-C₉H₁₉ |
| 14 | H | H | H | H | H | H | H | —CH₂—CH(C₂H₅)—C₄H₉ |
| 15 | H | H | H | H | H | H | H | —(CH₂)₂—Ph |
| 16 | H | H | H | H | H | H | H | —CH₂—Ph |
| 17 | H | H | H | H | H | H | H | —n-C₁₂H₂₅ |
| 18 | H | H | H | H | H | H | H | —C₂H₄—O—CH₃ |

Abbreviations in the above compounds have the following meanings.
Ph: a phenyl group

Specific examples of the electron transport material further include compounds represented by the following structural formulas (ET-A) to (ET-E) as other electron transport materials in addition to the electron transport material represented by the general formula (2).

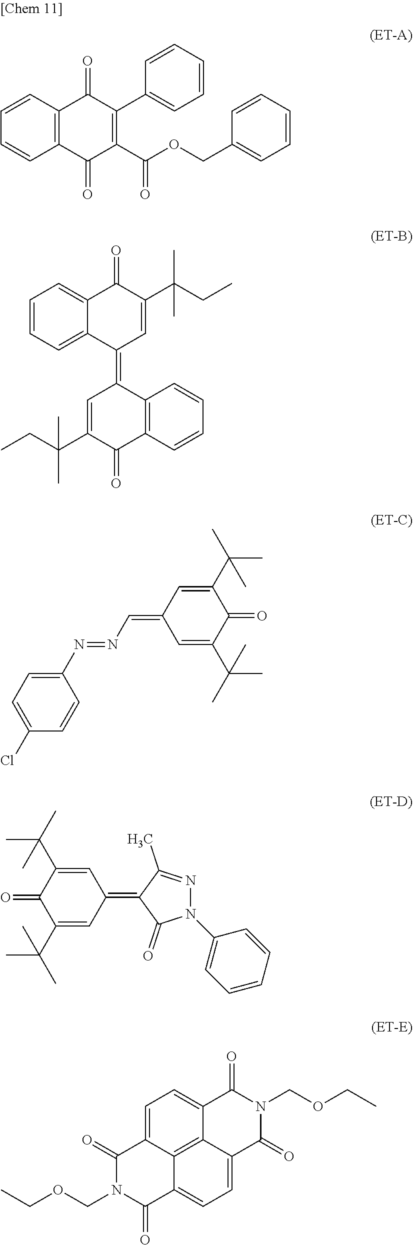

The electron transport material of the general formula (2) may be used alone or in combination of two or more. When the electron transport material represented by the general formula (2) is used, an electron transport material represented by the general formula (2) and an electron transport material other than the electron transport material represented by the general formula (2) (for example, electron transport materials of the compounds represented by the above structural formulas (ET-A) to (ET-E)) may be used in combination.

A content of the electron transport material other than the electron transport material represented by the general formula (2) is preferably 10% by mass or less with respect to an entire electron transport material.

A content of a total electron transport material to a total solid content excluding the silica particles in the single-layer type photosensitive layer may be 4% by mass to 30% by mass, and preferably 6% by mass to 20% by mass.

—Mass Ratio of Hole Transport Material and Electron Transport Material—

A ratio of the hole transport material and the electron transport material is preferably 50/50 to 90/10, and more preferably 60/40 to 80/20 in terms of mass ratio (hole transport material/electron transport material).

—Silica Particle—

Examples of a silica particle include a dry silica particle and a wet silica particle.

Examples of the dry silica particle include a combustion method silica (fumed silica) obtained by burning a silane compound and deflagration method silica obtained by explosively burning metallic silicon powder.

Examples of the wet silica particle include a wet silica particle (a precipitated silica synthesized and aggregated under alkaline condition, a gel method silica particle synthesized and aggregated under acidic condition) obtained by neutralization reaction of sodium silicate and a mineral acid, a colloidal silica particle (a silica sol particle) obtained by polymerizing an acidic silicic acid with alkalinity and a sol-gel method silica particle obtained by hydrolysis of an organosilane compound (for example, alkoxysilane).

Among the particles, from the viewpoint of generation of residual potential and suppression of image defect (suppression of decrease in thin line reproducibility) due to deterioration of electrical properties, it is preferable to use combustion method silica particles having a small number of silanol groups on the surface and having a low void structure as the silica particle.

A volume average particle diameter of the silica particle is, for example, preferably 20 nm to 200 nm. A lower limit of the volume average particle diameter of the silica particle may be 40 nm or more, or may be 50 nm or more. An upper limit of the volume average particle diameter of the silica particle may be 150 nm or less, 120 nm or less, or 110 nm or less.

The volume average particle diameter of the silica particles is determined by separating the silica particles from the layer, observing 100 primary particles of the silica particles at a magnification of 40,000 times with a scanning electron microscope (SEM) apparatus, measuring the longest diameter and the shortest diameter for each particle by image analysis of the primary particles, and measuring the sphere equivalent diameter from this intermediate value. The 50% diameter (D50 v) at the cumulative frequency of the obtained sphere equivalent diameter is determined and it is measured as the volume average particle diameter of the silica particles.

It is preferable that the surface of the silica particles is surface-treated with a hydrophobic treatment agent. Therefore, silanol groups on the surface of the silica particles are reduced, and the generation of the residual potential is easily suppressed. Examples of the hydrophobic treatment agent include well-known silane compounds such as chlorosilane, alkoxysilane, and silazane.

Among them, a silane compound having a trimethylsilyl group, a decylsilyl group, or a phenylsilyl group is preferable as a hydrophobic treatment agent from the viewpoint of easily suppressing generation of the residual potential. That is, the surface of the silica particle preferably has a trimethylsilyl group, a decylsilyl group, or a phenylsilyl group.

Examples of the silane compound having a trimethylsilyl group include trimethylchlorosilane, trimethylmethoxysilane, 1,1,1,3,3,3-hexamethyldisilazane, and the like.

Examples of the silane compound having a decylsilyl group include decyltrichlorosilane, decyldimethylchlorosilane, decyltrimethoxysilane, and the like. Examples of the silane compound having a phenyl group include triphenylmethoxysilane, triphenylchlorosilane, and the like.

A condensation rate (a ratio of Si—O—Si in the bonding of SiO₄— in the silica particles: hereinafter also referred to as “a condensation ratio of the hydrophobic treatment agent”) of the hydrophobilized silica particles is, for example, preferably 90% or more, more preferably 91% or more, and still more preferably 95% or more, with respect to the silanol groups on the surface of the silica particles.

When the condensation rate of the hydrophobic treatment agent is within the above range, the silanol groups of the silica particles are further reduced, and the generation of residual potential is easily suppressed.

The condensation rate of the hydrophobic treatment agent indicates a proportion of condensed silicon to a site capable of binding to silicon in the condensation portion detected by NMR and is measured in the following manner.

First, silica particles are separated from the layer. The separated silica particles are subjected to Si CP/MAS NMR analysis with AVANCE III 400 manufactured by Bruker, peak area corresponding to the number of substitution of SiO is determined, values of 2-substituted (Si(OH)₂ (0-Si)₂—), 3-substituted (Si (OH) (0-Si)₃—) and 4-substituted (Si (0-Si)₄—) are separately taken as Q2, Q3, Q4, and the condensation rate of the hydrophobic treatment agent is calculated by the formula: (Q 2×2+Q 3×3+Q 4×4)/4×(Q 2+Q 3+Q 4).

The volume resistivity of the silica particles is, for example, 10¹¹ Ωcm or more, preferably 10¹² Ωcm or more, and more preferably 10¹³ Ωcm or more.

When the volume resistivity of the silica particles is within the above range, deterioration of electrical properties is suppressed.

The volume resistivity of the silica particles is measured in the following manner. The measurement environment shall be a temperature of 20° C. and a humidity of 50% RH.

First, silica particles are separated from the layer. Then, on a surface of a circular jig on which an electrode plate of 20 cm² is arranged, separated silica particles to be measured are placed to have a thickness of about 1 mm to 3 mm so as to form a silica particle layer. An electrode plate of 20 cm² similar to that described above is placed thereon and the silica particle layer is sandwiched therebetween. In order to eliminate voids between the silica particles, a load of 4 kg is applied to the electrode plate placed on the silica particle layer, and the thickness (cm) of the silica particle layer is measured. Both electrodes above and below the silica particle layer are connected to an electrometer and a high voltage power generator. A high voltage is applied to both electrodes so that the electric field has a predetermined value, and the volume resistivity (Ωcm) of the silica particles is calculated by reading the current value (A) flowed at this time. The calculation formula of the volume resistivity (Ωcm) of silica particles is as shown in the following formula.

In the formula, ρ is the volume resistivity (Ωcm) of the silica particles, E is the applied voltage (V). I is the current value (A), I₀ is the current value (A) at the applied voltage of 0 V, and L is the thickness (cm) of the silica particle layer respectively. In this evaluation, the volume resistivity when the applied voltage is 1000 V is used.

ρ=E×20/(I−I₀)/L Formula:

The silica particles contained in the single-layer type photosensitive layer may be of one kind, or may be a mixture of two or more kinds of silica particles. The content of the silica particles relative to the total solid component of the single-layer type photosensitive layer is as described above.

—Other Additives—

The single-layer type photosensitive layer may contain known additives such as an antioxidant, a light stabilizer, a thermal stabilizer, fluorine resin particles, silicone oil and the like.

—Film Elastic Modulus of Single-Layer Type Photosensitive Layer—

The film elastic modulus of the single-layer type photosensitive layer is preferably 5 GPa or more, and more preferably 8 GPa or more, from the viewpoint of suppressing the occurrence of scratches in the inorganic protective layer.

In order to set the elastic modulus of the single-layer type photosensitive layer within the above range, for example, a method of adjusting a particle size and content of silica particles, or a method of adjusting the kind and content of each component other than the silica particles is used.

The method for measuring the film elastic modulus of the single-layer type photosensitive layer will be described later.

—Thickness of Single-layer Type Photosensitive Layer—

The thickness of the single-layer type photosensitive layer is preferably set in the range of 10 μm to 25 μm, more preferably 15 μm to 25 μm, and still more preferably 20 μm to 25 μm.

—Formation of Single-Layer Type Photosensitive Layer—

The single-layer type photosensitive layer is formed using a coating fluid for forming a photosensitive layer in which the above components are added to a solvent. Examples of the solvent include ordinary organic solvents such as aromatic hydrocarbons such as benzene, toluene, xylene and chlorobenzene, halogenated aliphatic hydrocarbons, ketones such as acetone and 2-butanone, halogenated aliphatic hydrocarbons such as methylene chloride, chloroform, and ethylene chloride, and cyclic or linear ethers such as tetrahydrofuran and ethyl ether. These solvents are used alone or in combination of two or more.

As a method for dispersing the particles (for example, silica particles and charge generation material) in the photosensitive layer forming coating fluid, media dispersing machines such as a ball mill, a vibration ball mill, an attritor, a sand mill, and a horizontal sand mill, or a medialess dispersing machine such as stirring, ultrasonic dispersing machine, roll mill, high pressure homogenizer is used. Examples of the high pressure homogenizer include a collision method in which the dispersion solution is dispersed in a liquid-liquid collision or a liquid-wall collision in a high pressure state, a penetration method in which a fine flow path is penetrated and dispersed in a high pressure state, and the like.

Examples of a method for applying the photosensitive layer forming coating fluid include a dip coating method, a push-up coating method, a wire bar coating method, a spray coating method, a blade coating method, a knife coating method, a curtain coating method, and the like.

(Inorganic Protective Layer)

The inorganic protective layer may be a layer containing an inorganic material, and it is preferably configured by a metal oxide layer from the viewpoint of mechanical strength.

Here, the metal oxide layer refers to a layer of a metal oxide (for example, a CVD film of a metal oxide, an evaporated film of a metal oxide, a sputtered film of a metal oxide, etc.), and aggregates or aggregates of metal oxide particles are excluded.

—Composition of Inorganic Protective Layer—

The inorganic protective layer configured by configured by a metal oxide layer is preferably a metal oxide layer made of a metal oxide containing a Group 13 element and oxygen since it is excellent in mechanical strength, translucency and conductivity. Examples of the metal oxide containing a Group 13 element and oxygen include metal oxides such as gallium oxide, aluminum oxide, indium oxide, and boron oxide, or a mixed crystal thereof.

Among the metal oxides containing a Group 13 element and oxygen, the gallium oxide is particularly preferable from the viewpoint of excellent mechanical strength and translucency, particularly having n-type conductivity and excellent conductivity controllability.

That is, the inorganic protective layer is preferably an inorganic protective layer configured by a metal oxide layer containing gallium oxide.

The inorganic protective layer configured by a metal oxide layer may contain, for example, a Group 13 element (preferably gallium) and oxygen, and may contain hydrogen and carbon as necessary.

The inorganic protective layer is configured by the metal oxide layer containing a Group 13 element (preferably gallium), oxygen, and hydrogen, so that various physical properties of the inorganic protective layer configured by the metal oxide layer can be controlled easily. For example, in the inorganic protective layer configured by a metal oxide layer containing gallium, oxygen, and hydrogen (for example, an inorganic protective layer made of gallium oxide containing hydrogen), control of volume resistivity is easily controlled in a range of 10⁹ Ωcm to 10¹⁴ Ωcm by changing the composition ratio [O]/[Ga] from 1.0 to 1.5.

In particular, the inorganic protective layer configured by a metal oxide layer contains a Group 13 element, oxygen, and hydrogen, a sum of element composition ratios of Group 13 element, oxygen, and hydrogen to all elements composing the inorganic protective layer is preferably 90 atom % or more.

In addition, by controlling the element ratio of oxygen to the group 13 element (oxygen/group 13 element), the film elastic modulus can be easily controlled. Regarding the element ratio of oxygen to the group 13 element (oxygen/group 13 element), the higher the oxygen composition ratio is, the higher the film elastic modulus tends to be, for example, preferably 1.0 or more and less than 1.5, more preferably 1.03 to 1.47, still more preferably 1.05 to 1.45, and even more preferably 1.10 to 1.40.

When the element composition ratio (oxygen/group 13 element) of the material forming the inorganic protective layer configured by the metal oxide layer is in the above range, an image defect caused by scratches on the surface of the photoreceptor is suppressed and affinity with the fatty acid metal salt supplied to the surface of the photoreceptor is improved and contamination in the apparatus by fatty acid metal salts is suppressed. In the same respect, it is preferable that the group 13 element is gallium.

Further, since the sum of element composition ratios of the Group 13 element (particularly, gallium), oxygen, and hydrogen to all elements composing the inorganic protective layer configured by the metal oxide layer is 90 atom % or more, for example, in a case where a Group 15 elements such as N, P, As and the like is contaminated, influences such as bonding with the Group 13 element (particularly gallium) are suppressed, and it is easy to find out an appropriate range of oxygen and Group 13 element (particularly gallium) composition ratio (oxygen/Group 13 element (especially gallium)) which can improve the hardness and electrical properties of the inorganic protective layer.

In view of the above, the sum of the element composition ratios is preferably 95 atom % or more, more preferably 96 atom % or more, and still more preferably 97 atom % or more.

The inorganic protective layer configured by the metal oxide layer may contain other elements for controlling the conductivity type in addition to the Group 13 element, oxygen, hydrogen and carbon.

In order to control the conductivity type, the inorganic protective layer configured by the metal oxide layer may contain one or more elements selected from C, Si, Ge and Sn in a case of n type, or may contain one or more elements selected from N, Be, Mg, Ca and Sr in a case of p type.

Here, in a case where the inorganic protective layer configured by the metal oxide layer contains gallium, oxygen and hydrogen if necessary, preferred element composition ratios are as follows from the viewpoint of excellent mechanical in strength, translucency, flexibility and excellent in conductivity controllability.

The element composition ratio of gallium with respect to all the constituent elements of the inorganic protective layer is, for example, preferably 15 to 50 atom %, more preferably 20 to 40 atom %, and still more preferably 20 to 30 atom %.

The element composition ratio of oxygen with respect to all the constituent elements of the inorganic protective layer is, for example, preferably 30 to 70 atom %, more preferably 40 to 60 atom %, and still more preferably 45 to 55 atom %.

The element composition ratio of hydrogen with respect to all the constituent elements of the inorganic protective layer is, for example, preferably 10 to 40 atom %, more preferably 15 to 35 atom %, and still more preferably 20 to 30 atom %.

The confirmation of each element in the inorganic protective layer, the element composition ratio, the atomic ratio, and the like are determined by Rutherford Backscattering Spectrometry (hereinafter referred to as “RBS”) including the distribution in a thickness direction.

In RBS, NEC 3SDH Pelletron is used as an accelerator, CE & A company RBS-400 is used as an end station, and 3S-R10 is used as a system. The HYPRA program of CE & A Inc is used for analysis.

Measurement conditions of RBS are He++ ion beam energy 2.275 eV, detection angle 160°, and Grazing Angle for incident beam is about 109°.

Specifically, the RBS measurement is performed as follows.

First, a He++ ion beam is perpendicularly incident on the sample, the detector is set at 160° with respect to the ion beam, and the signal of backscattered He is measured. The composition ratio and film thickness are determined from the energy and intensity of the detected He. In order to improve the accuracy of determining the composition ratio and the film thickness, the spectrum may be measured at two detection angles. Accuracy is improved through cross-checking by measuring at two detection angles with different depth resolution and backscattering dynamics.

The number of He atoms backscattered by a target atoms is determined only by three factors: 1) the atomic number of the target atom, 2) the energy of the He atom before the scattering, and 3) a scattering angle.

The density is calculated from the measured composition by calculation and is used to calculate the thickness. The density error is within 20%.

The element composition ratio of hydrogen is obtained by Hydrogen Forward Scattering (hereinafter referred to as “HFS”).

In HFS measurement, NEC 3SDH Pelletron is used as the accelerator, CE & A company RBS-400 is used as the end station, and 3S-R10 is used as the system. The HYPRA program of CE & A Inc and the like is used for analysis. The measurement conditions of HFS are as follows.

He++ ion beam energy: 2.275 eV,
Detection angle: Grazing angle 30° for 160° incident beam.

The HFS measurement picks up a hydrogen signal scattered in front of the sample by setting the detector to 30° with respect to the He++ ion beam and the sample to 75° from the normal. At this time, it is preferable to cover the detector with aluminum foil and remove He atoms to be scattered together with hydrogen. The quantification is carried out by comparing the counts of hydrogen between a reference sample and a sample to be measured after normalizing with stopping power. As the reference sample, a sample obtained by ion-implanting H into Si and muscovite are used.

It is known that muscovite has a hydrogen concentration of 6.5 atom %.

H adsorbed on the outermost surface, is corrected by, for example, subtracting the amount of H adsorbed on the clean Si surface.

The inorganic protective layer configured by the metal oxide layer may have a distribution of the composition ratio in the thickness direction or a multilayer structure depending on the purpose.

—Physical Properties of Inorganic Protective Layer—

A surface roughness Ra (arithmetic average surface roughness Ra) on an outer peripheral surface (that is, an surface of an electrophotographic photoreceptor 7A or 7B) of the inorganic protective layer configured by the metal oxide layer is, for example, 5 nm or less, preferably 4.5 nm or less, and more preferably 4 nm or less. Charging unevenness is suppressed by setting the surface roughness Ra within the above range.

In order to set the surface roughness Ra within the above range, for example, a method such as setting the surface roughness Ra of a surface of a charge transport layer on an inorganic protective layer side within the above-mentioned range, or the like can be mentioned.

Further, the measurement of surface roughness Ra on the outer peripheral surface of the inorganic protective layer is similar with the method of measuring the surface roughness Ra of the surface of the charge transport layer on the inorganic protective layer side except that it is directly measured on the outer peripheral surface of the inorganic protective layer.

The volume resistivity of the inorganic protective layer configured by the metal oxide layer is preferably 5.0×10⁷ Ωcm or more and less than 1.0×10¹² Ωcm. In view of easily suppressing the occurrence of image flow and image defects caused by scratches on the surface of the photoreceptor, the volume resistivity of the inorganic protective layer is preferably 8.0×10⁷ Ωcm to 7.0×10¹¹ Ωcm, more preferably 1.0×10⁸ Ωcm to 5.0×10¹¹ Ωcm, and still more preferably 5.0×10⁸ Ωcm to 2.0×10¹¹ Ωcm.

The volume resistivity is calculated from a resistance value measured under the condition of a frequency of 1 kHz and a voltage of 1 V using an LCR meter ZM 2371 manufactured by nF company based on an electrode area and a thickness of the sample.

The sample to be measured may be a sample obtained by forming a film on an aluminum substrate under the same conditions as when forming the inorganic protective layer to be measured and forming a gold electrode on the film by vacuum evaporation, or may also be a sample in which the inorganic protective layer is peeled off from the electrophotographic photoreceptor after fabrication, partly etched, and sandwiched between a pair of electrodes.

The inorganic protective layer configured by the metal oxide layer is preferably a non-single crystal film such as a microcrystalline film, a polycrystalline film, or an amorphous film. Among them, amorphous is particularly preferable in terms of surface smoothness, but a microcrystalline film is more preferable in terms of hardness.

A growth cross section of the inorganic protective layer may have a columnar structure, but in terms of lubricity, a structure with high flatness is preferable, and amorphous is preferable.

Crystallinity and amorphousness are determined by the presence or absence of points and lines of the diffraction image obtained by RHEED (reflection high-energy electron diffraction) measurement.

The inorganic protective layer configured by the metal oxide layer has a film elastic modulus of 30 GPa to 80 GPa, more preferably 40 GPa to 65 GPa.

When this elastic modulus is within the above range, generation of the concave portion (scratch), peeling and cracking of the inorganic protective layer are easily suppressed.

A method for measuring the film elastic modulus of the inorganic protective layer configured by the metal oxide layer will be described later.

A thickness of the inorganic protective layer is, for example, preferably 1.0 μm to 10.0 μm, and more preferably 3.0 μm to 10 μm.

When the film thickness is within the above range, generation of the concave portion (scratch), peeling and cracking of the inorganic protective layer are easily suppressed.

—Formation of Inorganic Protective Layer—

The protective layer is formed by, for example, a known vapor phase film forming method such as a plasma CVD (Chemical Vapor Deposition) method, a metal organic vapor phase epitaxy method, a molecular beam epitaxy method, vapor deposition, sputtering or the like.

Hereinafter, the formation of the inorganic protective layer will be described with reference to a specific example while referring to an example of a film forming apparatus in the drawings. In the following description, a method of forming an inorganic protective layer containing gallium, oxygen, and hydrogen is described, but the present invention is not limited thereto, and a well-known forming method may be applied depending on the intended composition of the inorganic protective layer.

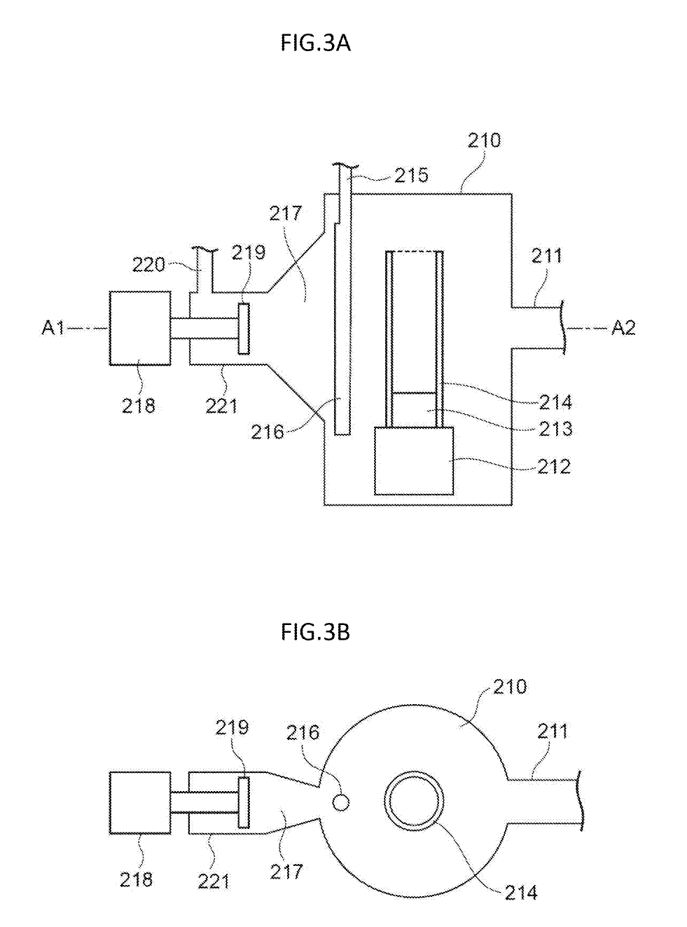

FIGS. 3A and 3B are schematic diagrams showing one example of a film forming apparatus used for forming an inorganic protective layer of an electrophotographic photoreceptor according to the present embodiment, in which FIG. 3A shows a schematic cross sectional view when the film forming apparatus is viewed from a side, and FIG. 3B shows a schematic cross sectional view between A1 and A2 of the film forming apparatus shown in FIG. 3A. In FIGS. 3A and 3B, reference numeral 210 denotes a film forming chamber, 211 denotes an exhaust port, 212 denotes a substrate rotating portion, 213 denotes a substrate supporting member, 214 denotes a substrate, 215 denotes a gas introduction pipe, 216 denotes a shower nozzle having an opening for injecting gas introduced from the gas introduction pipe 215, 217 denotes a plasma diffusion portion, 218 denotes a high-frequency power supply unit, 219 denotes a plate electrode, 220 denotes a gas introduction pipe, and 221 denotes a high-frequency discharge tube unit.

In the film forming apparatus shown in FIGS. 3A and 3B, the exhaust port 211 connected to a vacuum evacuation apparatus (not shown) is provided on one end of the film forming chamber 210, and a plasma generating apparatus configured by the high-frequency power supply unit 218, the plate electrode 219 and the high-frequency discharge tube unit 221 is provided on the other side of the film forming chamber 210 which is opposite to the side where the exhaust port 211 is provided.

The plasma generating apparatus includes the high-frequency discharge tube unit 221, the plate electrode 219 disposed in the high-frequency discharge tube unit 221 and having a discharge surface provided on an exhaust port 211 side, and the high-frequency power supply unit 218 which is disposed outside the high-frequency discharge tube unit 221 and is connected to a surface which is opposite to the discharge surface of the plate electrode 219 The gas introduction pipe 220 is connected to the high-frequency discharge tube 221 so as to supply gas into the high-frequency discharge tube unit 221, and the other end of the gas introduction pipe 220 is connected to a first gas supply source (not shown).

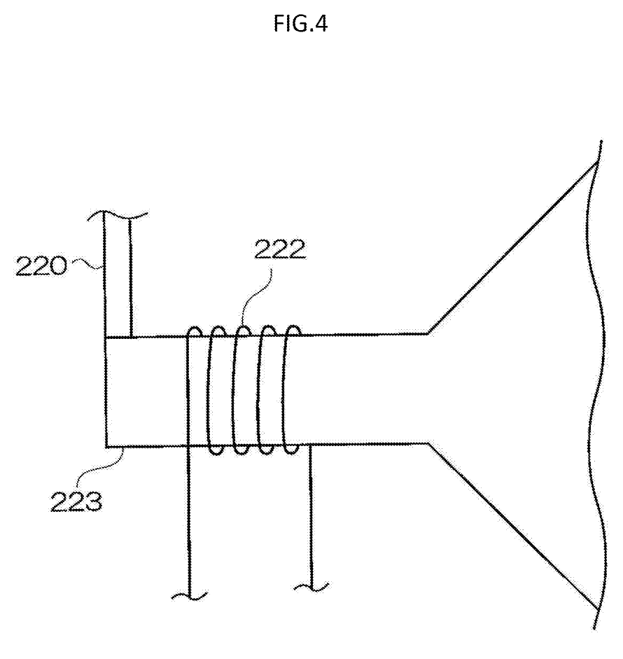

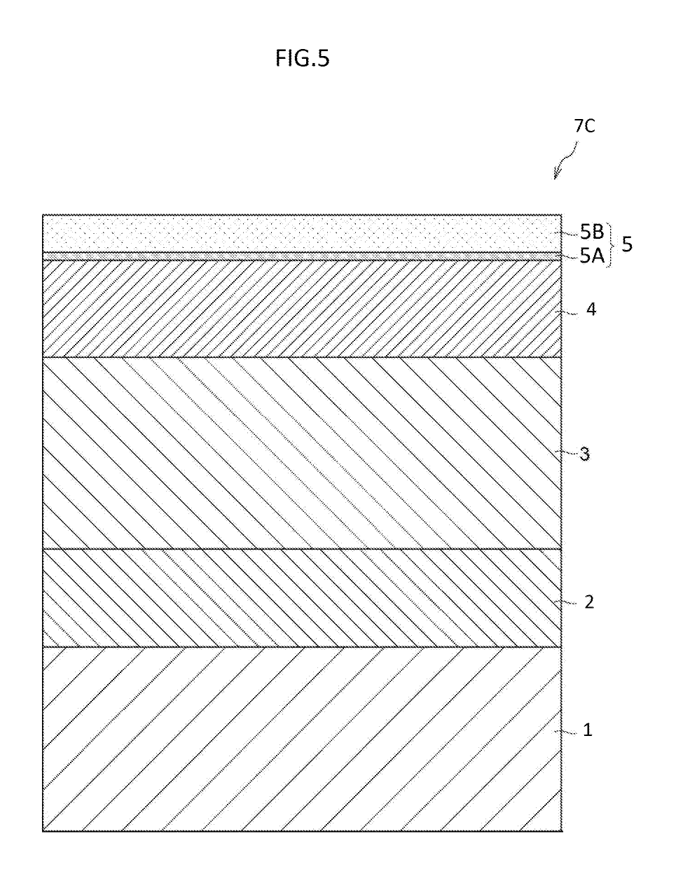

Instead of the plasma generating apparatus provided in the film forming apparatus shown in FIGS. 3A and 3B, a plasma generating apparatus shown in FIG. 4 may be used. FIG. 4 is a schematic view showing another example of the plasma generating apparatus used in the film forming apparatus shown in FIGS. 3A and 3B, and is a side view of the plasma generating apparatus. In FIG. 4, reference numeral 222 denotes a high frequency coil, 223 denotes a quartz tube, and 220 denotes the same as shown in FIGS. 3A and 3B. The plasma generating apparatus includes the quartz tube 223 and the high frequency coil 222 provided along an outer peripheral surface of the quartz tube 223, the quartz tube 223 being connecting to one side of the film forming chamber 210 (not shown in FIG. 4). Further, the gas introduction pipe 220 is connected to the other side of the quartz tube 223 so as to introduce gas into the quartz tube 223.

In FIGS. 3A and 3B, a rod-shaped shower nozzle 216 extending along the discharge surface is connected to a discharge surface side of the plate electrode 219, one end of the shower nozzle 216 is connected to the gas introduction pipe 215, and the gas introduction pipe 215 is connected to a second gas supply source (not shown) provided outside the film forming chamber 210.

Further, in the film forming chamber 210, the substrate rotating portion 212 is provided, and the cylindrical substrate 214 is attached to the substrate rotating portion 212 via the substrate supporting member 213 so that a longitudinal direction of the shower nozzle 216 and an axial direction of the substrate 214 face each other. During film formation, the substrate rotating portion 212 rotates, so that the substrate 214 rotates in a circumferential direction. As the substrate 214, a laminate for manufacturing a photoreceptor on which a single-layer type photosensitive layer is formed is used.

The inorganic protective layer is formed, for example, as follows.

First, oxygen gas (or helium (He) diluted oxygen gas), helium (He) gas, and hydrogen (H₂) gas as needed are introduced into the high-frequency discharge tube unit 221 from the gas introduction pipe 220, and a radio wave of 13.56 MHz is supplied from the high-frequency power supply unit 218 to the plate electrode 219. At this time, the plasma diffusion portion 217 is formed so as to spread radially from the discharge surface side of the plate electrode 219 to the exhaust port 211 side. Here, the gas introduced from the gas introduction pipe 220 flows from the plate electrode 219 side to the exhaust port 211 side in the film forming chamber 210. The plate electrode 219 may be surrounded by an earth shield around the electrode.

Next, trimethyl gallium gas is introduced into the film forming chamber 210 via the gas introducing pipe 215 and the shower nozzle 216 located on a downstream side of the plate electrode 219 as an activating means, so that a non-single crystal film containing gallium, oxygen and hydrogen is formed on the surface of the substrate 214.

As the substrate 214, a laminate for manufacturing a photoreceptor on which a single-layer type photosensitive layer is formed is used.

Since the single-layer type photosensitive layer is provided, temperature of the surface of the substrate 214 at the time of forming the inorganic protective layer is preferably 150° C. or less, more preferably 100° C. or less, and still more preferably 30° C. to 100° C.

Even the temperature of the surface of the substrate 214 is set to 150° C. or less at the beginning of the film formation, in a case where the temperature is higher than 150° C. due to the influence of plasma, the single-layer type photosensitive layer may be damaged by heat. Therefore, it is preferable to control the surface temperature of the substrate 214 in consideration of the influence.

The temperature of the surface of the substrate 214 may be controlled by at least one of heating means and cooling means (not shown in figure), or may be left to a natural temperature increase during discharge. A heater may be provided inside or outside of the substrate 214 when heating the substrate 214. A cooling gas or liquid may be circulated inside the substrate 214 when cooling the substrate 214.

When it is desired to avoid an increase in the surface temperature of the substrate 214 due to the discharge, it is effective to adjust a gas flow with high energy which hits the surface of the substrate 214. In this case, conditions such as a gas flow rate, discharge output, pressure, etc. are adjusted so that the temperature is set as required.

Further, instead of the trimethyl gallium gas, an organometallic compound containing aluminum or a hydride such as diborane may be used, or two or more of these may be mixed.

For example, at an initial stage of the formation of the inorganic protective layer, trimethyl indium is introduced into the film forming chamber 210 through the gas introduction pipe 215 and the shower nozzle 216, so that when a film containing nitrogen and indium is formed on the substrate 214, the film is continuously formed, and ultraviolet rays which deteriorate the single-layer type photosensitive layer is absorbed. Therefore, damage to the single-layer type photosensitive layer due to generation of ultraviolet rays during film formation is suppressed.

As a method of doping a dopant at the time of film formation, SiH₃ and SnH₄ are used for n type, biscyclopentadienyl magnesium, dimethyl calcium, dimethyl strontium etc. are used in a gaseous state for p type. Further, in order to dope the dopant element into the surface layer, a known method such as a thermal diffusion method or an ion implantation method may be adopted.

Specifically, for example, gas containing at least one of the dopant elements is introduced into the film forming chamber 210 through the gas introduction pipe 215 and the shower nozzle 216 so as to obtain an inorganic protective layer of conductive type such as n type, p type or the like.

In the film forming apparatus shown in FIGS. 3, 3B and 4, active nitrogen or active hydrogen formed by discharge energy may be independently controlled by providing a plurality of active apparatus, or a gas containing a nitrogen atom and a hydrogen atom simultaneously such as NH₃ may be used. H₂ may be further added. Also, a condition under which the active hydrogen is released from the organometallic compound may be used.

Accordingly, a carbon atom, a gallium atom, a nitrogen atom, a hydrogen atom, and the like, which are activated, are on the surface of the substrate 214 in a controlled state. The activated hydrogen atom has an effect of desorbing hydrogen of a hydrocarbon group such as a methyl group or an ethyl group configuring the organometallic compound as a molecule.

Therefore, a hard film (inorganic protective layer) configuring a three-dimensional bond is formed.

A plasma generating unit of the film forming apparatus shown in FIGS. 3A, 3B and 4 uses a high frequency oscillator, but the invention is not limited thereto. For example, a microwave oscillation apparatus may be used, or an apparatus of an electro cyclotron resonance system or a helicon plasma system may be used. In the case of the high frequency oscillation apparatus, an induction type or a capacitance type may be used.

Further, two or more of these apparatus may be used in combination, or two or more apparatus of the same type may be used. In order to suppress an increase in temperature of the surface of the substrate 214 by irradiation with plasma, the high frequency oscillator is preferable, but an apparatus that suppresses irradiation of heat may be provided.

In the case where two or more different types of plasma generating apparatus (plasma generating unit) are used, it is preferable to simultaneously discharge at the same pressure. Further, a pressure difference may be provided between a region to be discharged and a region to be formed (a portion where the substrate is provided). These apparatus may be disposed in series with respect to a gas flow formed into a portion discharged from a portion into which the gas is introduced in the film forming apparatus, or may be disposed to face a film forming surface of the substrate.

For example, in a case where the two types of plasma generating unit is provided in series with respect to the gas flow, in the film forming apparatus shown in FIG. 3 as an example, it is used as a second plasma generating apparatus for causing discharge in the film forming chamber 210 with the shower nozzle 216 as an electrode. In this case, a high frequency voltage is applied to the shower nozzle 216 via the gas introduction pipe 215, for example, causing the discharge in the film forming chamber 210 with the shower nozzle 216 as an electrode. Alternatively, instead of utilizing the shower nozzle 216 as an electrode, a cylindrical electrode is provided between the substrate 214 and the plate electrode 219 in the film forming chamber 210, and discharge is caused in the film forming chamber 210 by the cylindrical electrode.

In addition, when two types of different plasma generating apparatus is used under the same pressure, for example, in a case where the microwave oscillation apparatus and the high frequency oscillator are used, the excitation energy of the excited species can be greatly changed, which is effective for controlling the film quality. In addition, the discharging may be performed in the vicinity of atmospheric pressure (70000 Pa to 110000 Pa). When the discharging is performed in the vicinity of atmospheric pressure, it is preferable to use He as a carrier gas.

The inorganic protective layer can be formed by, for example, placing a substrate 214 which is a laminate for manufacturing a photoreceptor laminated up to the charge transport layer in the film forming chamber 210, and introducing mixed gas having different compositions so as to form the inorganic protective layer.

As the film forming conditions, for example, in the case of discharging by high frequency discharge, in order to perform high-quality film formation at a low temperature, it is preferable to set the frequency within a range of 10 kHz to 50 MHz. Although the output depends on the size of the substrate 214, it is preferable to set it in the range of 0.01 W/cm² to 0.2 W/cm² with respect to the surface area of the substrate. A rotation speed of the substrate 214 is preferably in a range of 0.1 rpm to 500 rpm.

(Undercoat Layer)

The undercoat layer is a layer provided between a conductive substrate and a single-layer type photosensitive layer.

The undercoat layer is not particularly limited, and examples thereof include a layer containing a binder resin and a charge transport material (for example, the hole transport material described above or the like), a layer containing a binder resin and an inorganic particle (for example, a metal oxide particle), a layer containing a binder resin and a resin particle, a layer formed of a cured film (crosslinked film), a layer containing various particles in a cured film and the like.

Examples of the binder resin contained in the undercoat layer include, for example, polymer compounds of acetal resins (such as polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins.

Examples of an inorganic particle contained in the undercoat layer include, for example, an inorganic particle having a powder resistance (volume resistivity) of 10² Ωcm to 10¹¹ Ωcm. As the inorganic particle having this resistance value, metal oxide particles such as tin oxide particles, titanium oxide particles, zinc oxide particles, zirconium oxide particles and the like are preferable, and zinc oxide particles are particularly preferable. The specific surface area of the inorganic particle according to the BET method is preferably 10 m²/g or more, for example.

The volume average particle diameter of the inorganic particles is, for example, 50 nm to 2000 nm (preferably 60 nm to 1000 nm).

The content of the inorganic particle is preferably 10 mass % to 90 mass %, and more preferably 40 mass % to 80 mass %, based on the binder resins.

The inorganic particle may be subjected to a surface treatment. Two or more kinds of inorganic particles, which have different surface treatments or different particle diameters, may be used.

Examples of the surface treatment agent include a silane coupling agent, a titanate coupling agent, an aluminum coupling agent, a surfactant, and the like. In particular, a silane coupling agent is preferable, and a silane coupling agent having an amino group is more preferable.

Examples of the silane coupling agent having an amino group may include 3-aminopropyltriethoxysilane, N-2-(aminoethyl)-3-aminopropyltrimethoxysilane, N-2-(aminoethyl)-3-aminopropylmethyldimethoxysilane, N,N-bis (2-hydroxyethyl)-3-aminopropyltriethoxysilane or the like, and it is not limited thereto.

Two or more types of silane coupling agents may be mixed and used. For example, a silane coupling agent having an amino group and other silane coupling agents may be used in combination. Examples of other silane coupling agents include vinyltrimethoxysilane, 3-methacryloxypropyl-tris(2-methoxyethoxy)silane, 2-(3,4-epoxycyclohexyl) ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, 3-chloropropyltrimethoxysilane or the like, and it is not limited thereto.

The surface treatment method with the surface treatment agent may be any method as long as it is a known method, and either a dry method or a wet method may be used.

An amount of the surface treatment agent to be treated is, for example, preferably 0.5% by mass to 10% by mass with respect to the inorganic particles.

Here, it is preferable that the undercoat layer contains an electron accepting compound (acceptor compound) together with the inorganic particles from the viewpoint of enhancing the long-term stability of electrical properties and the carrier blocking property.

Examples of the electron accepting compound include electron transporting substances such as quinone compounds such as chloranil and bromoanil; tetracyanoquinodimethane compounds; fluorenone compounds such as 2,4,7-trinitrofluorenone and 2,4,5,7-tetranitro-9-fluorenone; oxadiazole compound such as 2-(4-biphenyl)-5-(4-t-butylphenyl)-1,3,4-oxadiazole, 2,5-bis(4-naphthyl)-1,3,4-oxadiazole, 2,5-bis(4-diethylaminophenyl)-1,3,4 oxadiazole; xanthone compounds; thiophene compounds; and diphenoquinone compounds such as 3,3′,5,5′ tetra-t-butyldiphenoquinone.

In particular, as the electron accepting compound, a compound having an anthraquinone structure is preferable. As the compound having an anthraquinone structure, for example, a hydroxyanthraquinone compound, an aminoanthraquinone compound, an aminohydroxyanthraquinone compound and the like are preferable, and specifically, for example, anthraquinone, alizarin, quinizarin, antharufine, purpurin, and the like are preferable.

The electron accepting compound may be dispersed in the undercoat layer together with the inorganic particles or may be contained in a state of adhering to the surface of the inorganic particles.

As a method for adhering the electron accepting compound to the surface of the inorganic particle, for example, a dry method or a wet method can be included.

In the dry method, for example, while stirring the inorganic particles with a mixer or the like having a large shear force, an electron accepting compound is directly dropped or dissolved in an organic solvent and dropped and then sprayed together with dry air or nitrogen gas so as to adhere the electron accepting compound to the surface of inorganic particles. When dropping or spraying the electron accepting compound, it is preferable to carry out at the temperature not higher than the boiling point of the solvent. After dropping or spraying the electron accepting compound, baking may be carried out at 100° C. or higher. Baking is not particularly limited as long as it is performed at a temperature and time at which electrophotographic characteristics are obtained.

In the wet method, for example, an electron accepting compound is added while dispersing inorganic particles in a solvent by stirring, ultrasonic wave, sand mill, attritor, ball mill or the like, after stirring or dispersing, the solvent is removed, and the electron accepting compound is adhered to the surface of the inorganic particles. The solvent removal method is performed for example, by filtration or distillation. After removing the solvent, baking may be carried out at 100° C. or higher. Baking is not particularly limited as long as it is performed at a temperature and time at which electrophotographic characteristics are obtained. In the wet method, moisture contained in the inorganic particles may be removed before adding the electron accepting compound. Examples of the wet method include a method of removing while stirring and heating in a solvent, and a method of removing by azeotropic distillation with a solvent.

The adhesion of the electron-accepting compound may be carried out before or after the surface treatment by the surface treatment agent is applied to the inorganic particles, and may also be carried out at the same time with the surface treatment by the surface treatment agent.

The content of the electron accepting compound is preferably 0.01 mass % to 20 mass %, and more preferably 0.01 mass % to 10 mass %, based on the inorganic particles.

Examples of the binder resin used in the undercoat layer include, for example, polymer compounds of acetal resins (such as polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; a zirconium chelate compound; a titanium chelate compound; an aluminum chelate compound; a titanium alkoxide compound; an organotitanium compound; and a known material such as a silane coupling agent.

Examples of the binder resin used in the undercoat layer include a charge transporting resin having a charge transporting group, a conductive resin (such as polyaniline), and the like.

Among them, resins which are insoluble in the coating solvent of the upper layer are suitable as the binder resin used for the undercoat layer, and in particular, a resin obtained by the reaction of at least one resin selected from the group consisting of thermosetting resins such as urea resins, phenol resins, phenol-formaldehyde resins, melamine resins, urethane resins, unsaturated polyester resins, alkyd resins and epoxy resins; polyamide resins, polyester resins, polyether resins, methacrylic resins, acrylic resins, polyvinyl alcohol resins and polyvinyl acetal resins with a curing agent is preferable.

When two or more of these binder resins are used in combination, the mixing ratio is set as required.

Various additives may be contained in the undercoat layer so as to improve electrical properties, environmental stability, and image quality.

Examples of the additives include known materials such as electron transporting pigments such as polycondensation type and azo type, zirconium chelate compounds, titanium chelate compounds, aluminum chelate compounds, titanium alkoxide compounds, organic titanium compounds, and silane coupling agents. The silane coupling agent is used for surface treatment of inorganic particles as described above, but it may be added to the undercoat layer as an additive.

Examples of the silane coupling agents include vinyltrimethoxysilane, 3-methacryloxypropyl-tris(2-methoxyethoxy)silane, 2-(3,4-epoxycyclohexyl) ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N, N-bis(2-hydroxyethyl)-3-aminopropyltriethoxysilane, 3-chloropropyltrimethoxysilane or the like.

Examples of the zirconium chelate compound include zirconium butoxide, ethyl zirconium acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, zirconium methacrylate butoxide, stearate zirconium butoxide, isostearate zirconium butoxide, and the like.

Examples of the titanium chelate compounds include tetraisopropyl titanate, tetranormal butyl titanate, butyl titanate dimer, tetra(2-ethylhexyl)titanate, titanium acetylacetonate, polytitanium acetylacetonate, titanium octylene glycolate, titanium lactate ammonium salt, titanium lactate, titanium lactate ethyl ester, titanium triethanolaminate, polyhydroxy titanium stearate, and the like.

Examples of the aluminum chelate compounds include aluminum isopropylate, monobutoxy aluminum diisopropylate, aluminum butyrate, diethyl acetoacetate aluminum diisopropylate, aluminum tris(ethyl acetoacetate), and the like.

These compounds may be used alone or as a mixture or a polycondensate of a plurality of the compounds.

The undercoat layer preferably has a Vickers hardness of 35 or more.

The surface roughness (average roughness of ten points) of the undercoat layer is preferably adjusted from 1/(4n) (where n is the refractive index of the upper layer) to ½ of the exposure laser wavelength A used for the purpose of suppression of Moire image.

A resin particle is added to the undercoat layer so as to adjust the surface roughness. Examples of the resin particle include a silicone resin particle, a crosslinked polymethyl methacrylate resin particle and the like. Further, the surface of the undercoat layer is abraded so as to adjust the surface roughness. Examples of the abrasion method include buffing, sandblasting, wet honing, grinding and the like.

The formation of the undercoat layer is not particularly limited, and well-known forming methods are used, for example, a coating film of a coating fluid for forming the undercoat layer in which the above components are added into a solvent is formed, and the coating film is dried, and heated as necessary.

Examples of the solvent for preparing the coating fluid for forming the undercoat layer include known organic solvents such as an alcohol solvent, an aromatic hydrocarbon solvent, a halogenated hydrocarbon solvent, a ketone solvent, a ketone alcohol solvent, an ether solvent, a ester solvent and the like.

Specifically, examples of the solvents include ordinary organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing the inorganic particles when preparing the coating fluid for forming the undercoat layer include known methods such as a roll mill, a ball mill, a vibrating ball mill, an attritor, a sand mill, a colloid mill and a paint shaker.

Examples of a method for applying the coating fluid for forming the undercoat layer on the conductive substrate include usual methods such as a blade coating method, a wire bar coating method, a spray coating method, a dip coating method, a bead coating method, an air knife coating method, and a curtain coating method.

A film thickness of the undercoat layer is, for example, set preferably 15 μm or more, and more preferably within a range of 20 μm to 50 μm.

The formation of the undercoat layer is preferably carried out by, for example, coating the coating fluid for forming the undercoat layer on the conductive substrate by a dip coating method and drying.

The film elastic modulus of the undercoat layer is preferably 5 GPa or more, and more preferably 10 GPa or more.

The film thickness of the undercoat layer is, for example, in the range of 0.1 μm to 20 μm.

Here, a method for measuring the film elastic modulus of the single-layer type photosensitive layer, the inorganic protective layer, and the undercoat layer will be described.

A Nano Indenter SA2 manufactured by MTS Systems is used, a depth profile is obtained by a continuous stiffness method (CSM) (U.S. Pat. No. 4,848,141), and the film elastic modulus of each layer adopts an average value obtained from measurement values at an indentation depth of 100 nm to 300 nm. The measurement conditions are as follows.
Measurement environment: 23° C., 55% RH
Working indenter: triangular pyramid indenter which is a Diamond made regular triangular pyramid indenter (Berkovic indenter)
Test mode: CSM mode

The measurement sample may be a sample formed on the substrate under the same conditions as when forming the single-layer type photosensitive layer, the inorganic protective layer, and the undercoat layer to be measured.

In addition, the measurement sample may be a sample from which the single-layer type photosensitive layer, the inorganic protective layer, and the undercoat layer are taken out from the electrophotographic photoreceptor after fabrication.

When measuring the film elastic modulus of the single-layer type photosensitive layer, the inorganic protective layer and the undercoat layer from the electrophotographic photoreceptor after fabrication, the following procedure is carried out.

First, the photoconductor after fabrication is cut into 2 cm square. The film elastic modulus of the inorganic protective layer is measured, and then the inorganic protective layer is scraped off with sandpaper or the like. Then, the film elasticity modulus of the exposed single-layer type photosensitive layer is measured, and after measurement, the single-layer type photosensitive layer (and also the intermediate layer as necessary) is scraped off with sandpaper or the like. Next, the film elastic modulus of the exposed undercoat layer is measured.

(Intermediate Layer)

Although not shown, an intermediate layer may further be provided between the undercoat layer and the photosensitive layer.

The intermediate layer is, for example, a layer containing a resin. Examples of the resin used in the intermediate layer include, for example, polymer compounds of acetal resins (such as polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate maleic anhydride resins, silicone resins, silicone-alkyd resins, phenol-formaldehyde resins and melamine resins.

The intermediate layer may be a layer containing an organometallic compound. Examples of the organometallic compound used in the intermediate layer include organometallic compounds containing metal atoms such as zirconium, titanium, aluminum, manganese, and silicon.

These compounds used in the intermediate layer may be used alone or as a mixture or a polycondensate of a plurality of the compounds.

Among these, the intermediate layer is preferably a layer containing an organometallic compound containing a zirconium atom or a silicon atom.

The formation of the intermediate layer is not particularly limited, and well-known forming methods are used, for example, a coating film of a coating liquid for forming the intermediate layer in which the above components are added into a solvent is formed, and the coating film is dried, and heated as necessary.

As a coating method for forming the intermediate layer, general methods such as a dip coating method, a push-up coating method, a wire bar coating method, a spray coating method, a blade coating method, a knife coating method, a curtain coating method, and the like are used.

A thickness of the intermediate layer is, for example, preferably set to a range of 0.1 μm to 3 μm. The intermediate layer may be used as the undercoat layer.

[Electrophotographic Photoreceptor for Positive Charging]

An electrophotographic photoreceptor for positive charging according to a second embodiment includes a conductive substrate; an organic photosensitive layer provided on the conductive substrate; and an inorganic protective layer provided on the organic photosensitive layer. The inorganic protective layer contains a Group 13 element and oxygen in which a sum of element composition ratios of the Group 13 element and the oxygen with respect to all elements constituting the inorganic protective layer is 0.70 or more, and includes at least one combination of a first region in which an element ratio (oxygen/Group 13 element) of the oxygen to the Group 13 element is 1.10 to 1.30, and a second region in which an element ratio (oxygen/Group 13 element) of the oxygen to the Group 13 element is 1.40 to 1.50 on the organic photosensitive layer in this order, the second region being an uppermost layer.

An electrophotographic photoreceptor for positive charging according to a third embodiment includes a conductive substrate; an organic photosensitive layer provided on the conductive substrate; and an inorganic protective layer provided on the organic photosensitive layer. The inorganic protective layer contains a Group 13 element and oxygen in which a sum of element composition ratios of the Group 13 element and the oxygen with respect to all elements constituting the inorganic protective layer is 0.70 or more, and includes at least one combination of a first region having a volume resistivity of 2.0×10⁷ Ωcm to 1.0×10¹⁰ Ωcm and a second region having a volume resistivity of 2.0×10¹⁰ Ωcm or more on the organic photosensitive layer in this order, the second region being an uppermost layer.

In the electrophotographic photoreceptors for positive charging according to the second embodiment and the third embodiment (in the specification, matters that are common in the second embodiment and the third embodiment are referred to as “other embodiments”), specifically, in the case where the organic photosensitive layer is a single-layer type organic photosensitive layer, the organic photosensitive layer contains for example a charge generation material, a charge transport material, and a binder resin.

Meanwhile, in a case where the organic photosensitive layer is a function allocation type organic photosensitive layer, the organic photosensitive layer is preferably an organic photosensitive layer including a charge transport layer and a charge generation layer on/above the conductive substrate in this order. The charge transport layer contains, for example, a charge transport material and a binder resin. The charge transport layer may include two or more layers.

In the following description, the electrophotographic photoreceptor for positive charging may be simply referred to as an “electrophotographic photoreceptor”.

The inorganic protective layer, for example, may be scratched (dent scratches or streaky scratches) by rubbing a carrier between the electrophotographic photoreceptor and a transfer unit.

In order to improve mechanical strength of the inorganic protective layer, for example, it is considered to increase a thickness of the inorganic protective layer. However, when the thickness of the inorganic protective layer is increased, charges accumulate easily in the inorganic protective layer, so that residual potential may increase.

On the other hand, in order to suppress the increase of residual potential, it is considered to reduce a stoichiometric proportion of oxygen to Group 13 element in a material forming the inorganic protective layer. The inorganic protective layer having a small stoichiometric proportion oxygen to Group 13 element easily suppresses the charge accumulation. However, when the stoichiometric proportion of oxygen to Group 13 element in the material forming the inorganic protective layer is made small, the inorganic protective layer is colored easily, so that the amount of exposure for lowering potential is increased. Therefore, the sensitivity may decrease.

In contrast, the electrophotographic photoreceptor according to other embodiments is an electrophotographic photoreceptor for positive charging, the inorganic protective layer contains a Group 13 element and oxygen, and a sum of the element composition ratios of the Group 13 element and oxygen with respect to all elements constituting the inorganic protective layer is 0.70 or more.

Further, in the electrophotographic photoreceptor of the second embodiment, the inorganic protective layer includes the first region in which the element ratio (oxygen/Group 13 element) of the oxygen to the Group 13 element is 1.10 to 1.30, and the second region in which the element ratio (oxygen/Group 13 element) of the oxygen to the Group 13 element is 1.40 to 1.50 on the photosensitive layer in this order. The second region is the upmost layer of the inorganic protective layer.

Further, in the electrophotographic photoreceptor of the third embodiment, the inorganic protective layer includes the first region having a volume resistivity of 2.0×10⁷ Ωcm to 1.0×10¹⁰ Ωcm and the second region having a volume resistivity of 2.0×10¹⁰ Ωcm or more on the photosensitive layer in this order. The second region is the upmost layer of the inorganic protective layer.

In the electrophotographic photoreceptor of the second embodiment, the second region of the inorganic protective layer having a large stoichiometric proportion of oxygen to Group 13 element is formed on the first region having a small stoichiometric proportion of oxygen to Group 13 element. In the first region having a small stoichiometric proportion of oxygen to Group 13 element, oxygen deficiency occurs, so that electric charges move easily. As a result, when an electric field is applied, electrons in the second region are supplied to the first region, so that the charge accumulation is suppressed, and the potential tends to decrease. As a result, it is considered that the increase of residual potential of the inorganic protective layer is suppressed. Further, the first region having a small stoichiometric proportion of oxygen to Group 13 element is easy to be colored as compared with the second region having a large stoichiometric proportion of oxygen to Group 13 element. Since the second region which is formed on the first region and is easy to be colored is the uppermost layer of the inorganic protective layer, the decrease in light transmittance is suppressed, so that it is considered that the decrease in sensitivity is suppressed.

Further, in the electrophotographic photoreceptor of the third embodiment, the second region of the inorganic protective layer having a high volume resistivity is formed on the first region having a low volume resistivity. Since electrons in the first region flow easily due to low resistance, electrons in the second region are supplied to the first region, so that it is considered that the charge accumulation is suppressed. As a result, it is considered that the increase of residual potential is suppressed. Further, it is considered that the amount of exposure for attenuating surface potential is reduced form the viewpoint that the second region which has high resistance and is difficult to be colored is the uppermost layer of the inorganic protective layer and the viewpoint that the first region which has low resistance and in which the charges move easily are formed below the second region. As a result, it is considered that the decrease of residual potential is suppressed.

From the above, it is presumed that in the electrophotographic photoreceptor according to other embodiments, the increase of residual potential is suppressed while ensuring the sensitivity with the above configuration even in a case where the entire thickness of the inorganic protective layer is increased.

The combinations of the first region and the second region are repeatedly laminated to the photosensitive layer in this order from a photosensitive layer side, so that the increase of residual potential is easily suppressed while ensuring the sensitivity even in a case where the entire thickness of the inorganic protective layer is increased. When the inorganic protective layer having an aimed thickness is formed by repeatedly laminating the combinations of the first region and the second region on the photosensitive layer (for example, the number of repetitions is 3 to 10), a number of first regions and second regions having a small thickness are provided. Therefore, since the number of first regions in which electrons flow easily are formed in contact with the second regions, the charges move easily in the entire inorganic protective layer, and the charge accumulation in the second regions is reduced, so that it is considered that the increase of residual potential is suppressed easily. Further, since the thickness of the second region is thin, it is considered that the sensitivity is ensured easily.

Further, in the electrophotographic photoreceptor according to other embodiments, the increase of residual potential is suppressed while ensuring the sensitivity even in a case where the entire thickness of the inorganic protective layer is increased, so that the entire thickness of the inorganic protective layer can be increased. Therefore, the scratches of the inorganic protective layer are suppressed easily. Further, since an outermost surface is formed by the second region, the mechanical strength of the inorganic protective layer is improved easily, and the occurrence of scratches on the inorganic protective layer is also easily suppressed from this viewpoint.

Here, the organic photosensitive layer of the electrophotographic photoreceptor according to other embodiments may contain silica particles. It is considered that the silica particles are used in the organic photosensitive layer to function as a reinforcing material of the organic photosensitive layer. Therefore, the organic photosensitive layer is difficult to be deformed, so that it is considered that cracking of the inorganic protective layer is suppressed.

For example, in a case where the organic photosensitive layer is a single-layer organic photosensitive layer, the organic photosensitive layer may further contain silica particles. For example, in a case where the organic photosensitive layer is a function allocation type organic photosensitive layer, the charge transport layer may further contain silica particles. However, in a case where the charge transport layer includes two or more layers and silica particles are used, the charge transport layer of a layer constituting a surface (an uppermost layer of the charge transport layer) preferably contains a charge transport material, a binder resin, and silica particles.

Hereinafter, the electrophotographic photoreceptor according to other embodiments will be described in detail with reference to the drawings. In the drawings, the same or corresponding parts are denoted by the same reference numerals, and redundant description thereof is omitted.

FIGS. 5 to 8 are schematic cross sectional views showing other examples of the electrophotographic photoreceptors according to other embodiments.

An electrophotographic photoreceptor 7C shown in FIG. 5 is a so-called function allocation type photoreceptor (or a laminated photoreceptor), and has a structure in which an undercoat layer 2 is provided on a conductive substrate 1, and a charge transport layer 3, a charge generation layer 4, and an inorganic protective layer 5 are sequentially formed on the undercoat layer. In the electrophotographic photoreceptor 7C, the charge transport layer 3 and the charge generation layer 4 constitute an organic photosensitive layer. Further, a first region 5A and a second region 5B of the inorganic protective layer 5 are formed on the charge generation layer 4. The charge transport layer 3 includes a charge transport material and a binder resin, and contains silica particles as necessary.

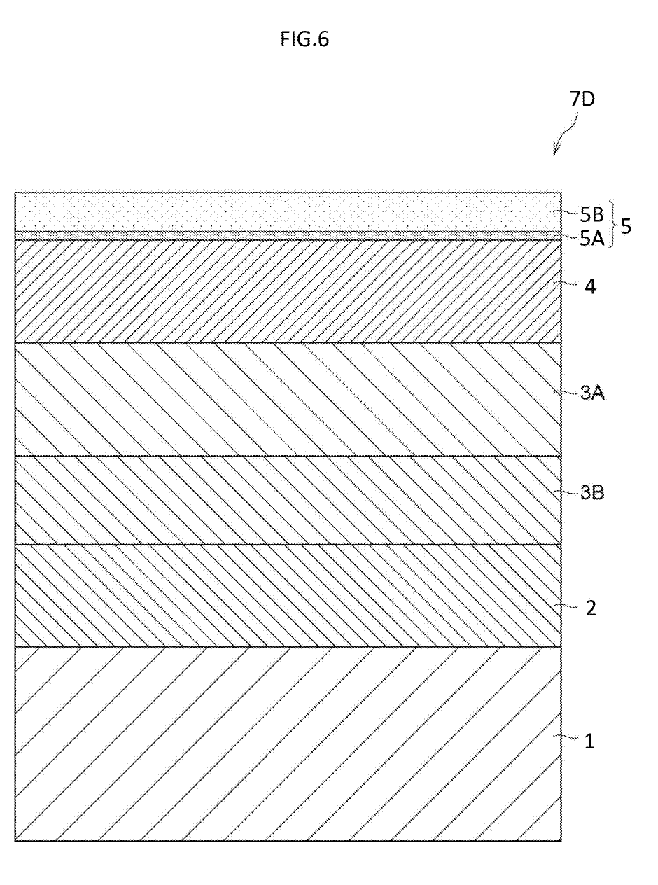

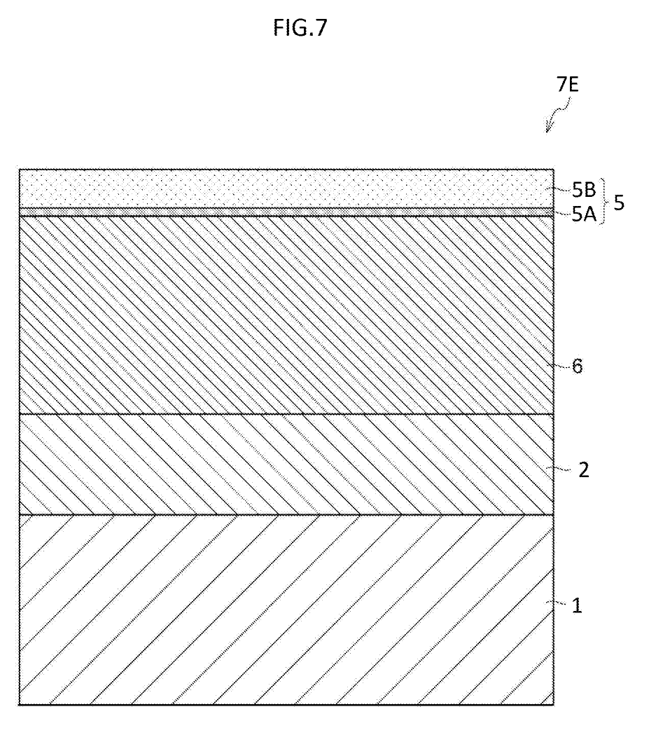

Similarly to the electrophotographic photoreceptor 7C shown in FIG. 5, an electrophotographic photoreceptor 7D shown in FIG. 6 is a function allocation type photoreceptor in which the charge generation layer 4 and the charge transport layer 3 are separated in function, and the charge transport layer 3 is further separated in function. Further, an electrophotographic photoreceptor 7E shown in FIG. 7 contains a charge generation material and a charge transport material in the same layer (single-layer type organic photosensitive layer 6 (charge generation/charge transport layer)).

The electrophotographic photoreceptor 7D shown in FIG. 6 has a structure in which the undercoat layer 2 is provided on the conductive substrate 1, and a charge transport layer 3B, a charge transport layer 3A, the charge generation layer 4, and the inorganic protective layer 5 are sequentially formed on the undercoat layer. In the electrophotographic photoreceptor 7C, the charge transport layer 3A, the charge transport layer 3B, and the charge generation layer 4 constitute an organic photosensitive layer.

Further, similarly to the electrophotographic photoreceptor 7C shown in FIG. 5, the first region 5A and the second region 5B are formed above the charge generation layer 2. The charge transport layer 3A and the charge transport layer 3B contain a charge transport material and a binder resin. Further, the charge transport layer 3A contains silica particles as necessary. In a case where the silica particles are used, the charge transport layer 3A contains silica particles and the charge transport layer 3B may contain or may not contain silica particles.

An electrophotographic photoreceptor 7E shown in FIG. 7 has a structure in which the undercoat layer 2 is provided on the conductive substrate 1, and a single-layer type organic photosensitive layer 6 and the inorganic protective layer 5 are sequentially formed on the undercoat layer.

The single-layer type organic photosensitive layer 6 includes a charge transport material and a binder resin, and includes silica particles as necessary.

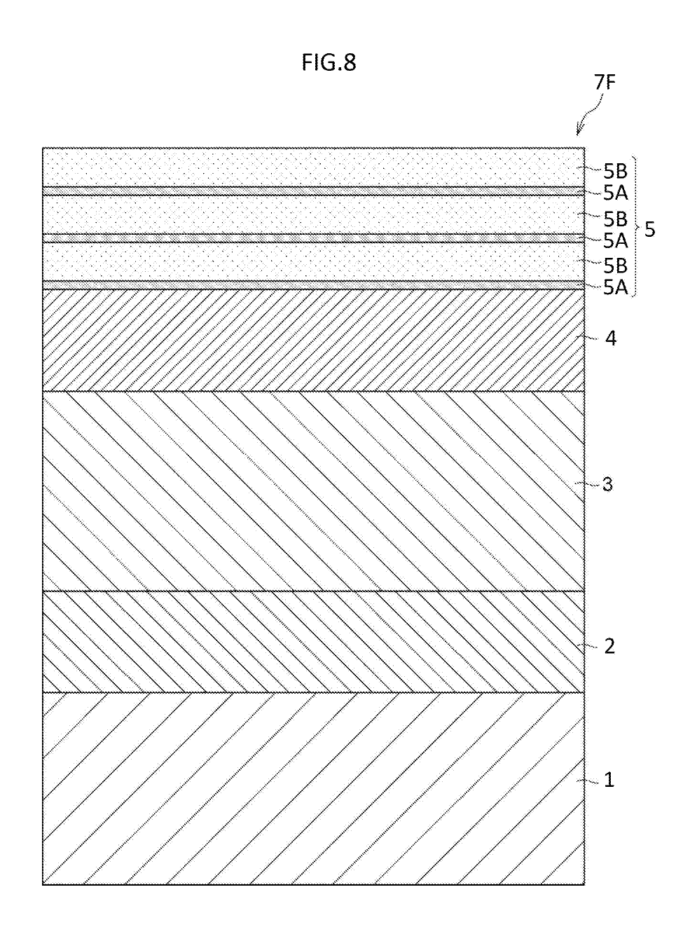

Similarly to the electrophotographic photoreceptor 7C shown in FIG. 5, an electrophotographic photoreceptor 7F shown in FIG. 8 has a structure in which the undercoat layer 2 is provided on the conductive substrate 1, and the charge transport layer 3, the charge generation layer 4, and the inorganic protective layer 5 are sequentially formed on the undercoat layer. Further, similarly to the electrophotographic photoreceptor 7C shown in FIG. 5, the inorganic protective layer 5 has a first region 5A and a second region 5B formed on the charge generation layer 4. However, in the inorganic protective layer 5 of the electrophotographic photoreceptor 7F, the first region 5A and the second region 5B are repeatedly laminated in this order from a charge transport layer 3 side. In the electrophotographic photoreceptor 7F, the number of repeating lamination of the first region 5A and the second region 5B is three.

The charge transport layer 3 includes a charge transport material and a binder resin, and contains silica particles as necessary. Further, the number of repeating the lamination of the first region 5A and the second region 5B is not limited to three, and may be four or more.

In each electrophotographic photoreceptor shown in FIGS. 5, 6, 7, and 8, the undercoat layer 2 may be provided or may not be provided. Further, in each electrophotographic photoreceptors shown in FIGS. 5, 6, and 7, the first region 5A and the second region 5B may be repeatedly laminated in this order as in the electrophotographic photoreceptor 7D shown in FIG. 8.

Hereinafter, each element will be described based on the electrophotographic photoreceptor 7C shown in FIG. 5 as a representative example. Description of the same constituent as that of the first embodiment is omitted. Reference numerals may be omitted in some cases.

(Conductive Substrate and Undercoat Layer)

The configurations of the conductive substrate and the undercoat layer are similar to those of the first embodiment.

(Charge Transport Layer)

The charge transport layer is, for example, a layer containing a charge transport material and a binder resin. The charge transport layer may be a layer containing a polymer charge transport material. Further, the charge transport layer may contain silica particles as necessary.

Examples of the charge transport material include electron transport compounds such as quinone compounds such as p-benzoquinone, chloranil, bromanil and anthraquinone; tetracyanoquinodimethane compounds; fluorenone compounds such as 2,4,7-trinitrofluorenone; xanthone compounds; benzophenone compounds; cyanovinyl compounds; and ethylene compounds. Examples of the charge transport material also include hole transport compounds such as triarylamine compounds, benzidine compounds, aryl alkane compounds, aryl substituted ethylenic compounds, stilbene compounds, anthracene compounds, and hydrazone compounds. These charge transport materials may be used alone or in combination of two or more, but are not limited thereto.

As the charge transport material, a triarylamine derivative represented by the following structural formula (a-1) and a benzidine derivative represented by the following structural formula (a-2) are preferable from the viewpoint of charge mobility.

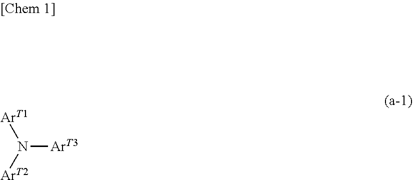

In the structural formula (a-1), Ar^{T1}, Ar^{T2} and Ar^{T3} each independently represent a substituted or unsubstituted aryl group, —C₆H₄—C(R^{T4})—C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of substituent of each of the above groups include a halogen atom, an alkyl group having 1 to 5 carbon atoms, or an alkoxy group having 1 to 5 carbon atoms. Further, the substituent of each of the above groups also includes a substituted amino group substituted with an alkyl group having 1 to 3 carbon atoms.

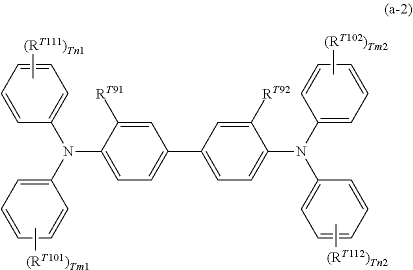

In the structural formula (a-2), R^{T9} and R^{T92} each independently represent a hydrogen atom, a halogen atom, an alkyl group having 1 to 5 carbon atoms, or an alkoxy group having 1 to 5 carbon atoms. R^{T101}, R^{T102}, R^{T111} and R^{T112} each independently represent a halogen atom, an alkyl group having 1 to 5 carbon atoms, an alkoxy group having 1 to 5 carbon atoms, an amino group substituted with an alkyl group having 1 to 2 carbon atoms, a substituted or unsubstituted aryl group, —C(R^{T12})═C (R^{T13})(R^{T14}), or —CH═CH—CH═C(R^{T15})(R^{T16}); and R^{T12}, R^{T13}, R^{T14}, R^{T15} and R^{T16} each independently represent a hydrogen atom, a substituted or unsubstituted alkyl group, or a substituted or unsubstituted aryl group. Tm1, Tm2, Tn1 and Tn2 each independently represent an integer of 0 to 2.

Examples of substituent of each of the above groups include a halogen atom, an alkyl group having 1 to 5 carbon atoms, or an alkoxy group having 1 to 5 carbon atoms. Further, the substituent of each of the above groups also includes a substituted amino group substituted with an alkyl group having 1 to 3 carbon atoms.

Here, in the triarylamine derivative represented by the structural formula (a-1) and the benzidine derivative represented by the structural formula (a-2), a benzidine derivative having “—C₆H₄—CH═CH—CH—C(R^{T7})(R^{T8})” is preferable from the viewpoint of charge mobility.

As the polymer charge transport material, known materials having charge transport properties such as poly-N-vinylcarbazole and polysilane are used. Particularly, the polyester polymer charge transport materials disclosed in JP-A-8-176293 and JP-A-8-208820 are particularly preferable. The polymer charge transport material may be used alone or in combination with a binder resin.

The charge transport layer may contain silica particles. Content of the silica particles with respect to the entire charge transport layer containing the silica particles is preferably 40 mass % to 80 mass %, from the viewpoint of suppressing the occurrence of scratches of the inorganic protective layer. From the similar viewpoint, a lower limit of the content of the silica particles may be 45 mass % or more, or 50 mass % or more. Further, an upper limit of the content of the silica particles may be 75 mass % or less, or 70 mass % or less, for example, from the viewpoint of dispersibility of the silica particles and the like.

Examples of the silica particles include dry silica particles and wet silica particles.

Examples of the dry silica particle include a combustion method silica (fumed silica) obtained by burning a silane compound and deflagration method silica obtained by explosively burning metallic silicon powder.

Examples of the wet silica particle include a wet silica particle (a precipitated silica synthesized and aggregated under an alkaline condition, a gel method silica particle synthesized and aggregated under an acidic condition) obtained by neutralization reaction of sodium silicate and a mineral acid, a colloidal silica particle (a silica sol particle) obtained by polymerizing an acidic silicic acid with alkalinity and a sol-gel method silica particle obtained by hydrolysis of an organosilane compound (for example, alkoxysilane).

Among these particles, from the viewpoint of suppressing the generation of residual potential and image defect (suppression of decrease in thin line reproducibility) due to deterioration of electrical properties, it is preferable to use the combustion method silica particle having a small number of silanol groups on the surface and having a low void structure as the silica particle.

A volume average particle diameter of the silica particle may be, for example, 20 nm to 200 nm. A lower limit of the volume average particle diameter of the silica particle may be 40 nm or more, or 50 nm or more. An upper limit of the volume average particle diameter of the silica particle may be 150 nm or less, 120 nm or less, or 100 nm or less.

The volume average particle diameter of the silica particles is determined by separating the silica particles from the layer, observing 100 primary particles of the silica particles at a magnification of 40,000 times with a scanning electron microscope (SEM) apparatus, measuring the longest diameter and the shortest diameter for each particle by image analysis of the primary particles, and measuring a sphere equivalent diameter from this intermediate value. The 50% diameter (D50v) at the cumulative frequency of the obtained sphere equivalent diameter is determined and is measured as the volume average particle diameter of the silica particles.

The surface of the silica particles is preferably surface-treated with a hydrophobic treatment agent. Therefore, silanol groups on the surface of the silica particles are reduced, and the generation of the residual potential is easily suppressed.

Examples of the hydrophobic treatment agent include well-known silane compounds such as chlorosilane, alkoxysilane, and silazane.

Among them, a silane compound having a trimethylsilyl group, a decylsilyl group, or a phenylsilyl group is preferable as the hydrophobic treatment agent from the viewpoint of easily suppressing the generation of residual potential. That is, the surface of the silica particle preferably has a trimethylsilyl group, a decylsilyl group, or a phenylsilyl group.

Examples of the silane compound having a trimethylsilyl group include trimethylchlorosilane, trimethylmethoxysilane, 1,1,1,3,3,3-hexamethyldisilazane, and the like.

Examples of the silane compound having a decylsilyl group include decyltrichlorosilane, decyldimethylchlorosilane, decyltrimethoxysilane, and the like.

Examples of the silane compound having a phenyl group include triphenylmethoxysilane, triphenylchlorosilane, and the like.

A condensation rate (a ratio of Si—O—Si in the bonding of SiO₄— in the silica particles: hereinafter also referred to as “a condensation ratio of the hydrophobic treatment agent”) of the hydrophobilized silica particles is, for example, preferably 90% or more, more preferably 91% or more, and still more preferably 95% or more, with respect to the silanol groups on the surface of the silica particles.

When the condensation rate of the hydrophobic treatment agent is within the above range, the silanol groups of the silica particles are further reduced, and the generation of residual potential is easily suppressed.

The condensation rate of the hydrophobic treatment agent indicates a proportion of condensed silicon to a site capable of binding to silicon in the condensation portion detected by NMR and is measured in the following manner.

First, the silica particles are separated from the layer. The separated silica particles are subjected to Si CP/MAS NMR analysis with AVANCE 111 400 manufactured by Bruker, a peak area corresponding to the number of substitution of SiO is determined, values of 2-substituted (Si(OH)₂(0-Si)₂—), 3-substituted (Si(OH)(0-Si)₃—) and 4-substituted (Si(0-Si)₄-) are separately taken as Q2, Q3, Q4, and the condensation rate of the hydrophobic treatment agent is calculated by the formula: (Q2×2+Q3×3+Q4×4)/4×(Q2+Q3+Q4).

The volume resistivity of the silica particles may be, for example, 10¹¹ Ωcm or more, preferably 10¹² Ωcm or more, and more preferably 10¹³ Ωcm or more.

When the volume resistivity of the silica particles is within the above range, deterioration of electrical properties is suppressed.

The volume resistivity of the silica particles is measured in the following manner. The measurement environment is set to a temperature of 20° C. and a humidity of 50% RH.

First, the silica particles are separated from the layer. Further, on a surface of a circular jig on which an electrode plate of 20 cm² is arranged, separated silica particles to be measured are placed to have a thickness of about 1 mm to 3 mm so as to form a silica particle layer. An electrode plate of 20 cm² similar to that described above is placed thereon and the silica particle layer is sandwiched therebetween. In order to eliminate voids between the silica particles, a load of 4 kg is applied to the electrode plate placed on the silica particle layer, and the thickness (cm) of the silica particle layer is measured. Both electrodes above and below the silica particle layer are connected to an electrometer and a high voltage power generator. A high voltage is applied to both electrodes so that the electric field has a predetermined value, and the volume resistivity ((cm) of the silica particles is calculated by reading a current value (A) flowed at this time. The calculation formula of the volume resistivity ((cm) of silica particles is as shown in the following formula.

In the formula, ρ is the volume resistivity (Ωcm) of the silica particles. E is the applied voltage (V), 1 is the current value (A), I₀ is the current value (A) at the applied voltage of 0 V, and L is the thickness (cm) of the silica particle layer respectively. In this evaluation, the volume resistivity when the applied voltage is 1000 V is used.

ρ=E×20/(I−I₀)/L Formula:

Examples of the binder resin used in the charge transport layer include, for example, specifically, a polycarbonate resin (a homopolymerization type of bisphenol A, bisphenol Z, bisphenol C, and bisphenol TP, etc. or a copolymerized type thereof), a polyarylate resin, a polyester resin, a methacrylic resin, an acrylic resin, a polyvinyl chloride resin, a polyvinylidene chloride resin, a polystyrene resin, an acrylonitrile-styrene copolymer, an acrylonitrile-butadiene-styrene copolymer, a polyvinyl acetate resin, a styrene-butadiene copolymer, a vinyl chloride-vinyl acetate copolymer, a vinyl chloride-vinyl acetate maleic anhydride copolymer, a silicone resin, a silicone-alkyd resin, a phenol-formaldehyde resin, a styrene-acrylic copolymer, an adamantyl-alkyd resin, a poly-N-vinylcarbazole resin, a polyvinyl butyral resin, a polyphenylene ether resin, and the like. One of these binder resins is used alone or in combination of two or more.

A compounding ratio of the charge transport material and the binder resin is preferably from 10:1 to 1:5 by mass ratio.

Among the above binder resins, the polycarbonate resin (a homopolymerized type of bisphenol A, bisphenol Z, bisphenol C, and bisphenol TP, etc. or a copolymerized type thereof) are preferable. The polycarbonate resin may be used alone, or may be used in combination of two or more thereof. Further, from the similar viewpoint, among the polycarbonate resins, it is more preferable to include a homopolymerized polycarbonate resin of bisphenol Z.

From the viewpoint of suppressing the occurrence of scratches on the inorganic protective layer, for example, the viscosity-average molecular weight of the binder resin is preferably 50,000 or less. The viscosity-average molecular weight may be less than 50000, 45000 or less, or 35000 or less. A lower limit of the viscosity-average molecular weight is preferably 20000 or more from the viewpoint of maintaining properties as a binder resin.

From the viewpoint of suppressing the occurrence of scratches on the inorganic protective layer, it is preferable to use the binder resin having a viscosity-average molecular weight of 50, 000 or less and the above silica particles in combination.

Here, the following point measurement method is used to measure the viscosity-average molecular weight of the binder resin.

First, the inorganic protective layer is peeled off from the photoreceptor to be measured, and then the photosensitive layer to be measured is exposed. Further, a part of the photosensitive layer is scraped to prepare a measurement sample.

Next, the binder resin is extracted from the measurement sample. 1 g of the extracted resin is dissolved in 100 cm³ of methylene chloride, and specific viscosity ηsp thereof is measured with an Ubbelohde viscometer under a 25° C. measurement environment. Further, the intrinsic viscosity [η] (cm³/g) is obtained from a relational expression ηsp/c=[η]+0.45 [η]²c (where c is concentration (g/cm³)), and the viscosity-average molecular weight My is obtained from a relational expression [η]=1.23×10⁻⁴ Mv^{0.83} given by H. Schnell.

Other well-known additives may be contained in the charge transport layer.

The formation of the charge transport layer is not particularly limited, and well-known forming methods are used, for example, a coating film of a coating liquid for forming the charge transport layer in which the above components are added into a solvent is formed, and the coating film is dried, and heated as necessary.

Examples of the solvent for preparing the coating liquid for forming the charge transport layer include ordinary organic solvents such as aromatic hydrocarbons such as benzene, toluene, xylene and chlorobenzene; Ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination of two or more.

Examples of a method for applying the coating fluid for forming the charge transport layer on the charge generation layer include usual methods such as a blade coating method, a wire bar coating method, a spray coating method, a dip coating method, a bead coating method, an air knife coating method, and a curtain coating method.

In a case where particles (for example, silica particles or fluororesin particles) are dispersed in the coating fluid for forming the charge transport layer, as a method for dispersing the particles, for example, a media dispersing machine such as a ball mill, a vibration ball mill, an attritor, a sand mill, and a horizontal sand mill; or a medialess dispersing machine such as a stirring, ultrasonic dispersing machine, a roll mill, and a high pressure homogenizer is used. Examples of the high pressure homogenizer include, for example, one of a collision type in which the dispersion solution is dispersed in a liquid-liquid collision or a liquid-wall collision in a high pressure state, or one of a penetration type in which a fine flow path is penetrated and the dispersion solution is dispersed in a high pressure state, and the like.

The elastic modulus of the charge transport layer may be, for example, 5 GPa or more, and preferably 6 GPa or more. When this elastic modulus is within the above range, generation of cracking of the inorganic protective layer are easily suppressed. In order to set the elastic modulus of the charge transport layer within the above range, for example, a method of adjusting a particle size and content of silica particles, or a method of adjusting the kind and content of the charge transport materiel is used.

The elastic modulus of the charge transport layer is measured as follows.

First, the inorganic protective layer is peeled off, the charge generation layer is removed, and then a layer to be measured is exposed. Further, a part of the layer is cut out with a cutter and the like, and a measurement sample is obtained.

For the measurement sample, a Nano Indenter SA2 manufactured by MTS Systems is used, a depth profile is obtained by a continuous stiffness method (CSM) (U.S. Pat. No. 4,848,141), and an average value obtained from measurement values at an indentation depth of 30 nm to 100 nm is used.

The thickness of the charge transport layer may be, for example, 10 μm to 40 m, preferably 10 μm to 35 μm, and more preferably 15 μm to 35 μm.

When the thickness of the charge transport layer is within the above range, the cracking of the inorganic protective layer and the generation of residual potential is easily suppressed.

(Charge Generation Layer)

The charge generation layer is, for example, a layer containing a charge transport material and a binder resin. Further, the charge generation layer may be a vapor deposition layer of the charge generation material. The vapor deposition layer of the charge generation material is suitable for a case of using an incoherent light source such as a Light Emitting Diode (LED) or an organic Electro-Luminescence (EL) image array.

Examples of the charge generation material include an azo pigment such as bisazo and trisazo; a condensed aromatic pigment such as dibromoanthanthrone: a perylene pigment; a pyrrolopyrrole pigment; a phthalocyanine pigment; zinc oxide; trigonal selenium, and the like.

Among these, it is preferable to use a metal phthalocyanine pigment or a metal-free phthalocyanine pigment as the charge generation material to correspond to laser exposure in a near-infrared region. Specifically, it is preferable to use, for example, hydroxygallium phthalocyanine disclosed in such as JP-A-5-263007 and JP-A-5-279591, chlorogallium phthalocyanine disclosed in such as JP-A-5-98181, dichlorotin phthalocyanine disclosed in such as JP-A-5-140472 and JP-A-5-140473, and titanyl phthalocyanine disclosed in such as JP-A-4-189873.

Meanwhile, in order to correspond to laser exposure in a near ultraviolet region, it is preferable to use a condensed aromatic pigment such as dibromoanthanthrone; a thioindigo pigment; a porphyrazine compound; zinc oxide; trigonal selenium; and a bisazo pigment disclosed in JP-A-2004-78147 and JP-A-2005-181992.

The above charge generation material may be used also in a case of using an incoherent light source such as an LED having an emission center wavelength in a range of 450 nm to 780 nm, an organic EL image array and the like, but from the viewpoint of resolution, when the photosensitive layer is used as a thin film having a thickness of 20 μm or less, the electric field intensity in the photosensitive layer is increased, so that charge reduction due to charge injection from the substrate, that is, image defect called a black point tends to occur. This is remarkable when a charge generation material which is prone to cause dark current in a p-type semiconductor such as trigonal selenium or a phthalocyanine pigment is used.

In contrast, in a case of using an n-type semiconductor such as an azo pigment, a condensed aromatic pigment, a perylene pigment as the charge generation material, dark current is difficult to occur, and the image defects called a black point can suppressed even used as a thin film. Examples of the n-type charge generation material include compounds (CG-1) to (CG-27) described in paragraphs [0288] to [0291] of JP-A-2012-155282, but it is not limited thereto.

The charge generation material of n-type is determined by using a normally used time-of-flight method to determine polarity of flowing photocurrent, and one that allows electrons to flow more easily as carriers than holes is the n-type.

The binder resin used in the charge generation layer is selected from a wide range of insulating resins, and further the binder resin may be selected from organic photoconductive polymers such as poly-N-vinylcarbazole, polyvinylanthracene, polyvinylpyrene, polysilane and the like.

Examples of the binder resin, for example, include such as a polyvinyl butyral resin, a polyarylate resin (such as a polymer of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinyl pyridine resin, a cellulose resin, a urethane resin, a epoxy resin, a casein, a polyvinyl alcohol resin, and a polyvinylpyrrolidone resin. Here, “insulativity” means that a volume resistivity is 10¹³ Ωcm or more.

These binder resins are used alone or as a mixture of two or more.

A compounding ratio of the charge transport material and the binder resin is preferably in a range of 10:1 to 1:10 by mass ratio.

In addition, other well-known additives may be contained in the charge generation layer.

The formation of the charge generation layer is not particularly limited, and well-known forming methods are used, for example, a coating film of a coating liquid for forming the charge generation layer in which the above components are added into a solvent is formed, and the coating film is dried, and heated as necessary. The charge generation layer may be formed by vapor deposition of the charge generation material. The formation of the charge generation layer by vapor deposition is particularly suitable for a case where a condensed ring aromatic pigment or a perylene pigment is used as the charge generation material.

Examples of the solvent for preparing the coating liquid for forming the charge generation layer include such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination of two or more.

As a method for dispersing the particles (for example, the charge generation material) in the coating fluid for forming the charge generation layer, for example, a media dispersing machines such as a ball mill, a vibration ball mill, an attritor, a sand mill, and a horizontal sand mill; or a medialess dispersing machine such as a stirring, ultrasonic dispersing machine, a roll mill, and a high pressure homogenizer is used. Examples of the high pressure homogenizer include, for example, one of a collision type in which the dispersion solution is dispersed in a liquid-liquid collision or a liquid-wall collision in a high pressure state, or one of a penetration type in which a fine flow path is penetrated and the dispersion solution is dispersed in a high pressure state, and the like.

During the dispersion, it is effective to set the average particle diameter of the charge generation material in the coating liquid for forming charge generation layer to be 0.5 μm or less, preferably 0.3 μm or less, and more preferably 0.15 μm or less.

Examples of a method for applying the coating fluid for forming the charge generation layer on the undercoat layer include usual methods such as a blade coating method, a wire bar coating method, a spray coating method, a dip coating method, a bead coating method, an air knife coating method, and a curtain coating method.

A film thickness of the charge generation layer is, for example, set preferably within a range of 0.1 μm to 5.0 μm, and more preferably within a range of 0.2 μm to 2.0 μm.

(Inorganic Protective Layer)

—Composition of Inorganic Protective Layer—

The inorganic protective layer in the electrophotographic photoreceptors of the second embodiment and the third embodiment is constituted by the following materials.

That is, the inorganic protective layer contains a Group 13 element and oxygen, and a sum of the element composition ratios of the Group 13 element and oxygen with respect to all elements constituting the inorganic protective layer is 0.70 or more.

Particularly, the materials constituting the inorganic protective layer in the electrophotographic photoreceptor of the second embodiment include the first region in which the element composition ratio (oxygen/Group 13 element) of the oxygen and the Group 13 element is 1.10 to 1.30, and the second region in which the element composition ratio of the oxygen and the Group 13 element is 1.40 to 1.50. Further, the first region and the second region are provided on the photosensitive layer in this order and the second region is the uppermost layer. From the viewpoint of suppressing the increase of residual potential while ensuring the sensitivity, the Group 13 element is preferably gallium. Further, since the Group 13 element is gallium, scratches of the inorganic protective layer are easily suppressed.

From the viewpoint of suppressing the increase of residual potential while ensuring the sensitivity, the element composition ratio (oxygen/Group 13 element) of the oxygen and the Group 13 element in the first region may be 1.2 to 1.3, and preferably 1.25 to 1.3. From the similar viewpoint, the element composition ratio (oxygen/Group 13 element) of the oxygen and the Group 13 element in the second region may be 1.45 to 1.5, and preferably 1.47 to 1.5.

Here, when the element composition ratios (oxygen/Group 13 element) of the oxygen and the Group 13 element in the first region and the second region are in the above ranges, the volume resistivity in each region is easily controlled. That is, the volume resistivity in the first region and the volume resistivity in the second region tend to satisfy the range of 2.0×10⁷ Ωcm to 1.0×10¹⁰ Ωcm and the range of 2.0×10¹⁰ Ωcm to 1.0×10¹¹ Ωcm respectively. Form this viewpoint, the materials constituting each region of the inorganic protective layer in the electrophotographic photoreceptor of the third embodiment is preferably similar to the materials constituting each region of the inorganic protective layer in the electrophotographic photoreceptor of the second embodiment.

Further, since the sum of element composition ratios of the Group 13 element (particularly, gallium) and the oxygen with respect to all elements constituting the inorganic protective layer is 0.7 or more, for example, in a case where a Group 15 elements such as N, P, As and the like is contaminated, influences such as bonding with the Group 13 element (particularly gallium) are suppressed, and it is easy to find out an appropriate range of the oxygen and the Group 13 element (particularly gallium) composition ratio (oxygen/Group 13 element (especially gallium)) which can improve the hardness and electrical properties of the inorganic protective layer. In the above viewpoint, the sum of the element composition ratios may be 0.75 or more, preferably 0.80 or more, and more preferably 0.85 or more.

The inorganic protective layer may contain hydrogen in addition to the above inorganic materials. In order to control the conductivity type, the inorganic protective layer may contain one or more elements selected from C, Si, Ge and Sn in a case of n type. For example, in a case of p type, the inorganic protective layer may contain one or more elements selected from N, Be, Mg, Ca and Sr.

Here, in a case where the inorganic protective layer contains gallium and oxygen and contains hydrogen as necessary, preferred element composition ratios are as follows from the viewpoint of being excellent in mechanical strength, translucency, flexibility and excellent in conductivity controllability.

The element composition ratio of gallium with respect to all the constituent elements of the inorganic protective layer, for example, may be 0.20 to 0.50, preferably 0.25 to 0.40, and more preferably 0.30 to 0.40.

The element composition ratio of oxygen with respect to all the constituent elements of the inorganic protective layer, for example, may be 0.30 to 0.70, preferably 0.30 to 0.60, and more preferably 0.35 to 0.55.

The element composition ratio of hydrogen with respect to all the constituent elements of the inorganic protective layer, for example, may be 0.10 to 0.40, preferably 0.10 to 0.30, and more preferably 0.15 to 0.25.

Here, the element composition ratio, an atomic ratio and the like of each element in the inorganic protective layer are determined by Rutherford Backscattering Spectrometry (hereinafter referred to as “RBS”) including distribution in a thickness direction.

In RBS, 3SDH Pelletron made by NEC Corporation is used as an accelerator. RBS-400 made by CE & A Inc is used as an end station, and 3S-R10 is used as a system. The HYPRA program of CE & A Inc and the like is used for analysis.

Measurement conditions of RBS are set such that He++ ion beam energy is 2.275 eV, a detection angle is 160°, and Grazing Angle for the incident beam is about 109°.

Specifically, the RBS measurement is performed as follows.

First, incidence of the He++ ion beam is perpendicular to the sample, a detector is set at 160° with respect to the ion beam, and a signal of backscattered He is measured. The composition ratio and film thickness are determined based on the energy and intensity of the detected He. In order to improve accuracy of determining the composition ratio and the film thickness, the spectrum may be measured at two detection angles. The accuracy is improved by measurement and cross-check at two detection angles with different depth resolution and backscattering dynamics.

The number of He atoms backscattered by a target atom is determined only by three factors: 1) the atomic number of the target atom, 2) energy of the He atom before the scattering, and 3) a scattering angle.

Assuming density is calculated from the measured compositions, the thickness is calculated by use of the density. The density error is within 20%.

The element composition ratio of hydrogen is obtained by Hydrogen Forward Scattering (hereinafter referred to as “HFS”).

In HFS measurement, 3SDH Pelletron made by NEC Corporation is used as an accelerator, RBS-400 made by CE & A Inc is used as an end station, and 3S-R10 is used as a system. The HYPRA program of CE & A Inc is used for analysis. Further, the measurement conditions of HFS are as follows. ⋅He++ ion beam energy: 2.275 eV, ⋅detection angle: 160°, ⋅Grazing angle for incident beam: 30°.

The HFS measurement picks up a hydrogen signal scattered at a front side of the sample by setting the detector to 30° with respect to the He++ ion beam and the sample to 75° from a normal line thereof. At this time, it is preferable to cover the detector with aluminum foil and remove He atoms to be scattered together with hydrogen. The quantification is carried out by comparing the counts of hydrogen between a reference sample and a sample to be measured after normalizing with stopping power. As the reference sample, a sample obtained by ion-implanting H into Si and muscovite are used.

It is known that muscovite has a hydrogen concentration of 6.5 atom %.

H adsorbed on the outermost surface, is corrected by, for example, subtracting the amount of H adsorbed on the clean Si surface.

—Properties of Inorganic Protective Layer—

As described above, the inorganic protective layer in the electrophotographic photoreceptor of the third embodiment includes the first region having a volume resistivity of 2.0×10⁷ Ωcm to 1.0×10¹⁰ Ωcm and the second region having a volume resistivity of 2.0×10¹⁰ Ωcm or more.

From the viewpoint of suppressing the increase of residual potential while ensuring the sensitivity, the volume resistivity of the first region may be 1.0×10⁸ Ωcm to 1.0×10¹⁰ Ωcm, and preferably 5.0×10⁸ Ωcm to 5.0×10⁹ Ωcm. From the similar viewpoint, the volume resistivity of the second region may be 3.0×10⁰ (cm or more, and preferably 4.0×10¹⁰ Ωcm or more. An upper limit of the volume resistivity of the second region is not particularly limited, and, for example, may be 1.0×10¹¹ Ωcm or less.

Further, the volume resistivity in each region of the inorganic protective layer of the electrophotographic photoreceptor of the second embodiment is preferably satisfied with the range of the volume resistivity in each region of the inorganic protective layer of the electrophotographic photoreceptor of the third embodiment.

The volume resistivity is calculated from a resistance value measured by using an LCR meter ZM 2371 manufactured by nF company under the condition of a frequency of 1 kHz and a voltage of 1 V based on an electrode area and a thickness of the sample.

The measurement sample may be a sample obtained by forming a film on an aluminum substrate under the same conditions as when forming the inorganic protective layer to be measured and forming a gold electrode on the film by vacuum deposition, or may be a sample in which the inorganic protective layer is peeled off from the electrophotographic photoreceptor after fabrication, partly etched, and sandwiched between a pair of electrodes.

The inorganic protective layer is preferably a non-single crystal film such as a microcrystalline film, a polycrystalline film, or an amorphous film. Among them, the amorphous film is particularly preferable in terms of surface smoothness, but a microcrystalline film is more preferable in terms of hardness.

A growth cross section of the inorganic protective layer may have a columnar structure, but in terms of lubricity, a structure with high flatness is preferable, and the amorphous film is preferable.

Crystallinity and amorphousness are determined by the presence or absence of points and lines of a diffraction image obtained by reflection high-energy electron diffraction (RHEED) measurement.

The elastic modulus of the entire inorganic protective layer may be 30 GPa to 80 GPa, and preferably 40 GPa to 65 GPa.

When the elastic modulus is within the above range, generation of a concave portion (dent scratches), peeling and cracking of the inorganic protective layer are easily suppressed.

A Nano Indenter SA2 manufactured by MTS Systems is used, a depth profile is obtained by a continuous stiffness method (CSM) (U.S. Pat. No. 4,848,141), and the elastic modulus adopts an average value obtained from measurement values at an indentation depth of 30 nm to 100 nm. The measurement conditions are as follows. ⋅Measurement environment: 23° C., 55% RH, ⋅Working indenter: triangular pyramid indenter which is a Diamond made regular triangular pyramid indenter (Berkovic indenter), ⋅Test mode: CSM mode

The measurement sample may be a sample obtained by forming a film on a substrate under the same conditions as when forming the inorganic protective layer to be measured, or may be a sample in which the inorganic protective layer is peeled off from the electrophotographic photoreceptor after fabrication and partly etched.

In the electrophotographic photoreceptor according to the second embodiment and the third embodiment, from a viewpoint of securing the sensitivity and suppressing the increase of the residual potential, the thickness of the first region may be smaller than the thickness of the second region. Further, similarly, a ratio of the thickness of the second region to the thickness of the first region (the thickness of the second region/the thickness of the first region) may be 3 to 100 (preferably 10 to 100, more preferably 10 to 30).

Further, from the viewpoint of securing the sensitivity and suppressing the increase of the residual potential, the thickness of the first region may be 0.01 μm to 0.5 μm (preferably 0.03 μm to 0.10 μm). In addition, similarly, the thickness of the second region may be 0.3 μm to 3.5 μm (preferably 0.4 μm to 1.0 μm).

In the electrophotographic photoreceptor according to the second embodiment and the third embodiment,

the total thickness of the inorganic protective layer is, for example, preferably more than 1.5 μm and 10 μm or less, more preferably 3 μm to 10 μm, and much more preferably 3 μm to 6 μm.
When the total film thickness of the inorganic protective layer is within the above range, occurrence of scratches on the inorganic protective layer is easily suppressed.
As in the first embodiment, the inorganic protective layer can be formed by the vapor phase film forming method. For example, in FIGS. 3A and 3B, the substrate 214 in the film forming chamber 210 can be formed in the same manner as in the first embodiment except that a photoreceptor or the like laminated up to the organic photosensitive layer is used in advance.

Incidentally, the element composition ratios (oxygen/the group 13 element) and the volume resistivities of the first region and the second region of the inorganic protective layer are adjusted, for example, by controlling the pressure of the plasma generating device and the high-frequency power. The element composition ratio and the volume resistivity are also adjusted by a flow rate ratio of trimethylgallium, oxygen diluted with helium, and hydrogen supplied to the plasma generator. Specifically, the element composition ratio and the volume resistivity are adjusted by the flow rate ratio of trimethylgallium to oxygen diluted with helium. Regarding the thickness of each of the first region and the second region, trimethylgallium supplied to the plasma generator and oxygen diluted with helium are adjusted according to the supply time.

Although the example where the organic photosensitive layer is of a function separation type and the charge transport layer is of a single-layer type as the electrophotographic photoreceptor has been described above, in a case of the electrophotographic photoreceptor shown in FIG. 6 (an example where the organic photosensitive layer is of a functionally separation type and the charge transport layer is of a multilayer type), the charge transport layer 3A which comes into contact with the inorganic protective layer 5 may have the same configuration as the charge transport layer 3 of the electrophotographic photoreceptor shown in FIG. 5, and the charge transport layer 3B which does not come into contact with the inorganic protective layer 5 may have the same configuration as the well-known charge transport layer.

However, the film thickness of the charge transport layer 3A may be 1 μm to 15 μm. Further, the film thickness of the charge transport layer 3B may be 15 μm to 29 μm.

On the other hand, in a case of the electrophotographic photoreceptor (an example where the organic photosensitive layer is a single-layer type) shown in FIG. 7, the single-layer type organic photosensitive layer 6 (the charge generation layer/the charge transport layer) may have the same configuration except that it contains the charge transport layer 3 of the electrophotographic photoreceptor and the charge generation material.

However, the content of the charge generation material in the single-layer type organic photosensitive layer 6 may be 0.1 mass % to 10 mass % (preferably 0.8 mass % to 5 mass %) with respect to the entire single-layer type organic photosensitive layer. The content of the charge transporting material is preferably 5 mass % to 50 mass % with respect to the total solid content.

Further, the film thickness of the single-layer type organic photosensitive layer 6 may be 15 μm to 30 μm.

The single-layer type organic photosensitive layer 6 is not limited to the above and may be an amorphous silicon photosensitive layer formed of a material containing amorphous silicon. The amorphous silicon type photosensitive layer may be formed to contain, for example, amorphous silicon and an impurity (dopant) such as boron. The amorphous silicon photosensitive layer is formed by a chemical vapor phase method or the like.

Furthermore, the inorganic protective layer may be formed by repeatedly laminating a combination of the first region and the second region in multilayers on the photosensitive layer in this order.

For example, in the electrophotographic photoreceptor shown in FIG. 8, an example is shown in which the inorganic protective layer is configured by repeatedly laminating the combination of the first region and the second region in this order three times. The combination in which the first region and the second region are laminated in this order from the photosensitive layer side is regarded as one unit, and the number of repetitions represents the number of repetitions of this unit. The number of repetitions of repeatedly laminating the combination of the first region and the second region may be, for example, twice. The number of repetitions of the first region and the second region may be one to ten in terms of further suppressing the increase of the residual potential while securing the sensitivity. The number of repetitions may be three or more, four or more, or five or more. The number of repetitions may be 9 or less, or 8 or less.

In the formation of the inorganic protective layer, each layer may be continuously formed by introducing a mixed gas having different compositions depending on the intended element composition ratio or the volume resistivity. Each layer may be selected depending on the intended element composition ratio or the volume resistivity.

[Image forming apparatus (and process cartridge)] The image forming apparatus according to the present embodiment includes an electrophotographic photoreceptor, a charging unit which charges the surface of the electrophotographic photoreceptor, an electrostatic latent image forming unit which forms an electrostatic latent image on the surface of the charged electrophotographic photoreceptor, a developing unit which develops the electrostatic latent image formed on the surface of the electrophotographic photoreceptor with a developer including toner to form a toner image, and a transfer unit which transfers the toner image onto the surface of the record medium. The electrophotographic photoreceptor according to the present embodiment is applied as the electrophotographic photoreceptor.

A well-known image forming apparatus, such as an apparatus including a fixing unit which fixes the toner image transferred onto the surface of the recording medium; a direct transfer type apparatus directly transferring the toner image formed on the surface of the electrophotographic photoreceptor onto the recording medium; an intermediate transfer type apparatus primarily transferring the toner image formed on the surface of the electrophotographic photoreceptor onto the surface of the intermediate transfer member and secondarily transferring the toner image transferred onto the surface of the intermediate transfer member onto the surface of the record medium; an apparatus including the cleaning unit which cleans the surface of the electrophotographic photoreceptor after the transfer of the toner image and before charging; an apparatus including a discharging unit which irradiates discharging light on the surface of the electrophotographic photoreceptor before charging for discharging; and an apparatus including an electrophotographic photoreceptor heating member for raising the temperature of the electrophotographic photoreceptor and reducing the relative temperature is applied to the image forming apparatus according to the present embodiment.

In the case of an intermediate transfer type apparatus, a configuration including, for example, the intermediate transfer member in which the toner image is transferred onto a surface thereof, a primary transfer unit which primarily transfers the toner image formed onto the surface of the electrophotographic photoreceptor, and a secondary transfer unit which secondarily transfers the toner image transferred onto the surface of the intermediate transfer member onto the surface of the recording medium is applied to the transfer unit.

The image forming apparatus according to the present embodiment may be either a dry developing type image forming apparatus or a wet developing type image forming apparatus (a development type using a liquid developer).

In the image forming apparatus according to the present embodiment, for example, the portion including the electrophotographic photoreceptor may be a cartridge structure (process cartridge) which is detachable from the image forming apparatus. For example, a process cartridge including the electrophotographic photoreceptor according to the present embodiment is preferably used as the process cartridge. The process cartridge may include, in addition to the electrophotographic photoreceptor, at least one selected from a group consisting of the charging unit, the electrostatic latent image forming unit, the developing unit, and the transfer unit.

An example of the image forming apparatus according to the present embodiment is shown below, but the present invention is not limited thereto. Main parts shown in the drawings will be described and descriptions of other parts will be omitted.

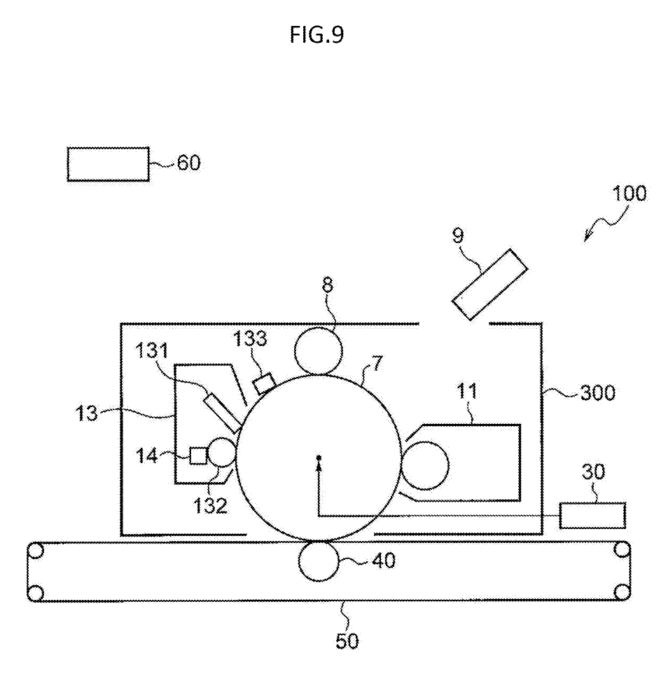

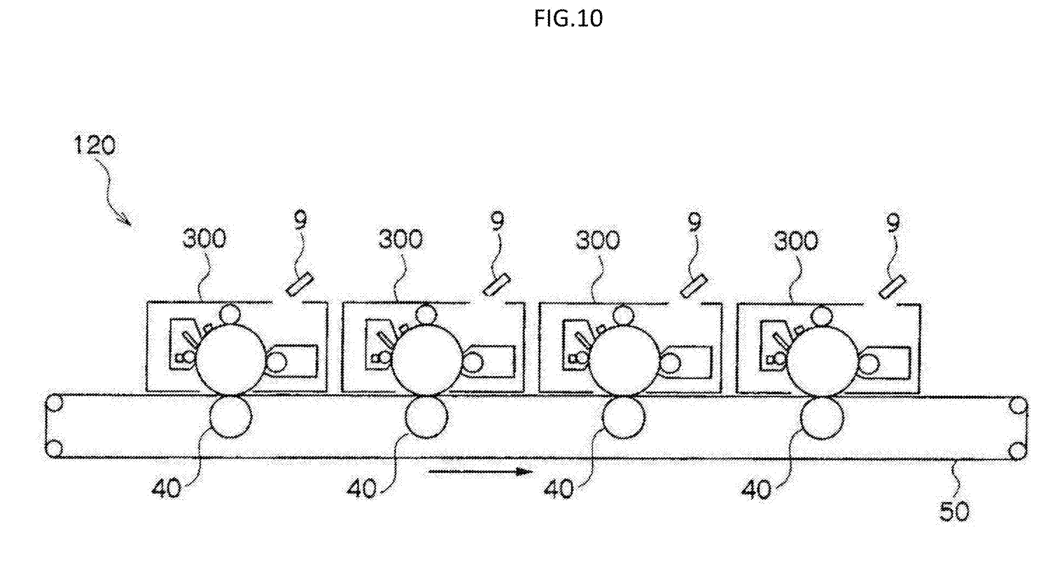

FIG. 9 is a schematic configuration diagram showing an example of the image forming apparatus according to the present embodiment.

As shown in FIG. 9, the image forming apparatus 100 according to the present embodiment includes a process cartridge 300 including the electrophotographic photoreceptor 7, an exposure device 9 (an example of the electrostatic latent image forming unit), a transfer device 40 (a primary transfer device), and an intermediate transfer member 50. In the image forming apparatus 100, the exposure device 9 is disposed at a position capable of being exposed on the electrophotographic photoreceptor 7 from the opening of the process cartridge 300, the transfer device 40 is disposed at a position facing the electrophotographic photoreceptor 7 via the intermediate transfer member 50, and a part of the intermediate transfer member 50 is disposed in contact with the electrophotographic photoreceptor 7. Although not shown, a secondary transfer device which transfers the toner image transferred onto the intermediate transfer member 50 onto the recording medium (for example, paper) is also provided. The intermediate transfer member 50, the transfer device 40 (the primary transfer device), and the secondary transfer device (not shown) correspond to an example of the transfer unit. In the image forming apparatus 100, a control device 60 (an example of a control unit) controls the operation of each device and each member in the image forming apparatus 100 and is connected to each device and each member.

The process cartridge 300 in FIG. 9 integrally supports the electrophotographic photoreceptor 7, a charging device 8 (an example of the charging unit), a developing device 11 (an example of the developing unit), and a cleaning device 13 (an example of the cleaning unit) in a housing. The cleaning device 13 includes a cleaning blade 131 (an example of the cleaning member), and the cleaning blade 131 is disposed so as to be brought into contact with the surface of the electrophotographic photoreceptor 7. The cleaning member may be a conductive or insulating fibrous member instead of an aspect of the cleaning blade 131, and may be used alone or in combination with the cleaning blade 131.

Incidentally, FIG. 9 shows an example in which the (roll-shaped) fibrous member 132 supplying the lubricant 14 to the surface of the electrophotographic photoreceptor 7 and the (flat brush shaped) fibrous member 133 assisting the cleaning are included as the image forming apparatus, but they are arranged as necessary.

Hereinafter, each configuration of the image forming apparatus according to this embodiment will be described.

—Charging Device—

As the charging device 8, a contact type charger using, for example, a conductive or semiconductive charging roller, a charging brush, a charging film, a charging rubber blade, a charging tube, or the like is used. Further, a known charging device such as a non-contact type roller charger, a scorotron charger or a corotron charger using corona discharge is also used.

—Exposure Device—

Examples of the exposure device 9 include an optical system device for exposing light such as semiconductor laser light, LED light, liquid crystal shutter light or the like in a predetermined imaging manner on the surface of the electrophotographic photoreceptor 7. A wavelength of the light source is within a spectral sensitivity range of the electrophotographic photoreceptor. As a wavelength of a semiconductor laser, a near-infrared light having an oscillation wavelength near 780 nm is a mainstream. However, the present invention is not limited to this wavelength, and is also possible to use an oscillation wavelength laser of the order of 600 nm or a laser having an oscillation wavelength of 400 nm to 450 nm as the blue laser. In order to form a color image, a surface emitting type laser light source which is capable of outputting multiple beams is also effective.

—Developing Device—

Examples of the developing device 11 include a general developing device which develops by being brought into contact or not into contact with the developer. The developing device 11 is not particularly limited as long as the developing device 11 has the above-described function and is selected according to the purpose. For example, a known developing device having a function of attaching a one-component developer or a two-component developer to the electrophotographic photoreceptor 7 using a brush, a roller or the like is exemplified. Above all, the developing roller in which the developer is held on the surface is preferably used.

The developer used in the developing device 11 may be a one-component developer of a single toner or a two-component developer containing a toner and a carrier. The developer may be either magnetic or non-magnetic. Well-known developers are applied as the developers.

—Cleaning Device—

A cleaning blade type device including the cleaning blade 131 is used as the cleaning device 13.

In addition to the cleaning blade type, a fur brush cleaning type and a development simultaneous cleaning type may be employed.

—Transfer Device—

Examples of the transfer device 40 include a known transfer charger such as a contact type transfer charger using a belt, a roller, a film, a rubber blade, or the like, and a scorotron transfer charger or a corotron transfer charger using corona discharge.

—Intermediate Transfer Member—

As the intermediate transfer member 50, a belt-shaped member (an intermediate transfer belt) including polyimide, polyamide imide, polycarbonate, polyarylate, polyester, rubber, or the like imparted with semiconductive properties is used. As the form of the intermediate transfer member, a drum shape other than the belt shape may be used.

—Control Device—

The control device 60 is configured as a computer which controls the entire apparatus and performs various calculations. Specifically, the control device 60 includes, for example, a Central Processing Unit (CPU), a Read Only Memory (ROM) storing various programs, a Random Access Memory (RAM) used as a work area during execution of the program, a nonvolatile memory storing various kinds of information, and an input/output interface (I/O). The CPU, the ROM, the RAM, the nonvolatile memory, and the I/O are connected via buses. Each unit of the image forming apparatus 100 such as the electrophotographic photoreceptor 7 (including a drive motor 30), the charging device 8, the exposure device 9, the developing device 11, and the transfer device 40 is connected to the I/O.

The CPU executes a program (for example, a control program of an image forming sequence or a recovery sequence, etc.) stored in the ROM or the nonvolatile memory, and controls the operation of each unit of the image forming apparatus 100. The RAM is used as a work memory. The ROM and the nonvolatile memory store, for example, programs executed by the CPU and data necessary for processing by the CPU. The control program and various data may be stored in another storage device such as a storage unit, or may be acquired from the outside via a communication unit.

Various drives may be connected to the control device 60. Examples of the various drives include a flexible disk, a magneto-optical disk, a CD-ROM, a DVD-ROM, and a device which reads data from a computer-readable portable recording medium such as a Universal Serial Bus (USB) memory and writes data to a recording medium. In a case where various drives are provided, the control program may be recorded on a portable recording medium and may be read and executed by a corresponding drive.

FIG. 10 is a schematic configuration diagram showing another example of the image forming apparatus according to the present embodiment.

An image forming apparatus 120 shown in FIG. 10 is a tandem multicolor image forming apparatus in which four process cartridges 300 are mounted. In the image forming apparatus 120, the four process cartridges 300 are disposed in parallel on the intermediate transfer member 50, and one electrophotographic photoreceptor with one color is used. The image forming apparatus 120 has the same configuration as the image forming apparatus 100 except that the image forming apparatus 120 is a tandem type.

Incidentally, the image forming apparatus 100 according to the present embodiment is not limited to the above configuration, for example, may be provided with a first discharging device for arranging the polarity of the residual toner and facilitating removal by the cleaning brush on a downstream side of a rotation direction of the electrophotographic photoreceptor 7 with respect to the transfer device 40 and on an upstream side of a rotation direction of the electrophotographic photoreceptor with respect to the cleaning device 13, and may be provided with a second discharging device for discharging a surface of the electrophotographic photoreceptor 7 on the downstream side of the rotation direction of the electrophotographic photoreceptor with respect to the cleaning device 13 and on the upstream side of the rotation direction of electrophotographic photoreceptor with respect to the charging device 8.

The image forming apparatus 100 according to the present embodiment is not limited to the above configuration, and may employ a known configuration, for example, a direct transfer type image forming apparatus which directly transfers the toner image formed on the electrophotographic photoreceptor 7 to the recording medium.

### Example

The present invention will be specifically described below with reference to examples, but the present invention is not limited to these Examples. In the following examples, “part” means part by mass.

[Preparation of Silica Particle]

### —Silica Particle (1)—

30 parts by mass of 1,1,1,3,3,3-hexamethyldisilazane (manufactured by Tokyo Chemical Industry Co., Ltd.) is added to 100 parts by mass of an untreated (hydrophilic) silica particle “trade name: OX50 (manufactured by Nippon Aerosil Co., Ltd.) as a hydrophobic treatment agent and reacted for 24 hours, and then filtered to obtain hydrophobized silica particle (1).

The condensation ratio of the silica particle (1) is 93% and had a trimethylsilyl group on the surface. The volume average particle diameter of the silica particle (1) is 40 nm.

### Example 1

—Formation of Single-Layer Type Photosensitive Layer—

V type hydroxygallium phthalocyanine pigment having diffraction peaks at positions where Bragg angles (2θ±0.2°) are at least 7.3°, 16.0°. 24.9° and 28.0° in the X-ray diffraction spectrum using CuKα characteristic X-ray as the charge generation material: 2 parts by mass (an amount to be 2 mass % with respect to the single-layer type photosensitive layer), 8 parts by mass of an exemplified compound (2-2) of the electron transport material represented by Formula (2), 14 parts by mass of the hole transport material represented by a structural formula (HT-D), 22 parts by mass of an exemplified compound (1-1) of the hole transport material represented by a general formula (1), 54 parts by mass of bisphenol Z polycarbonate resin (viscosity average molecular weight: 45,000) as a binder resin, 100 parts by mass of the silica particle (1) and 400 parts by mass of tetrahydrofuran as a solvent are mixed, and dispersion treatment is performed for 4 hours in a sand mill using glass bead having a diameter of 1 mm to obtain the coating liquid for forming the photosensitive layer.

An aluminum substrate (a tube having a diameter of 30 mm, a length of 244.5 mm, and a wall thickness of 0.7 mm) is prepared. The aluminum substrate is immersed in a water tank containing water having a pH of 8.1 so as to be washed. After the aluminum substrate taken out of the water tank is dried, the coating liquid for forming the photosensitive layer is dip-coated on the aluminum substrate and dried at 125° C. for 24 minutes to form a single-layer type photosensitive layer having a film thickness of 25 μm.

Through the above steps, an organic photoreceptor (1) in which only the single-layer type photosensitive layer is formed on the aluminum substrate is obtained.

—Formation of Inorganic Protective Layer—

Next, an inorganic protective layer configured by gallium oxide containing hydrogen is formed on the surface of the organic photoreceptor (1). The inorganic protective layer is formed by using the film forming device having the structure shown in FIG. 3.

First, the organic photoreceptor (1) is placed on the substrate supporting member 213 in the film forming chamber 210 of the film forming device, and the interior of the film forming chamber 210 is evacuated to a pressure of 0.1 Pa via the exhaust port 211.

Next, He diluted 40% oxygen gas (a flow rate of 1.6 sccm) and hydrogen gas (a flow rate of 50 sccm) are introduced into the high-frequency discharge tube unit 221 provided with the flat electrode 219 having a diameter of 85 mm from the gas introduction pipe 220, a radio wave of 13.56 MHz is set at an output of 150 W by the high frequency power supply unit 218 and a matching circuit (not shown in FIG. 9) to match with a tuner, and discharging from the plate electrode 219 is performed. The reflected wave at this time is 0 W at this time.

Next, trimethylgallium gas (a flow rate of 1.9 sccm) is introduced from the shower nozzle 216 into the plasma diffusion portion 217 in the film forming chamber 210 via the gas introduction pipe 215. At this time, the reaction pressure in the film forming chamber 210 measured by a Baratron vacuum gauge is 5.3 Pa.

In this state, film formation is conducted for 25 hours while the organic photoreceptor (1) is rotated at a speed of 500 rpm to form an inorganic protective layer having a film thickness of 5 μm on a surface of the charge transport layer of the organic photoreceptor (1).

The surface roughness Ra of the outer peripheral surface of the inorganic protective layer was 1.9 nm.

The element composition ratio (oxygen/gallium) of oxygen to gallium in the inorganic protective layer is 1.25.

Through the above process, the electrophotographic photoreceptor of Example 1, in which the single-layer type photosensitive layer and the inorganic protective layer are sequentially formed on a conductive substrate, is obtained.

### Example 2

An electrophotographic photoreceptor of Example 2 is obtained in the same manner as in Example 1 except that an inorganic protective layer having a thickness of 4 μm is formed by changing the film forming time in the film forming device to 20 hours.

### Example 3

An electrophotographic photoreceptor of Example 3 is obtained in the same manner as in Example 1 except that an inorganic protective layer having a thickness of 3 μm is formed by changing the film forming time in the film forming device to 15 hours.

### Example 4

An electrophotographic photoreceptor of Example 4 is obtained in the same manner as in Example 1 except that an inorganic protective layer having a thickness of 1 μm is formed by changing the film forming time in the film forming device to 5 hours.

### Example 5

An organic photoreceptor (2) is obtained by forming the single-layer type photosensitive layer in Example 1 with a thickness of 10 μm.

Next, an electrophotographic photoreceptor of Example 5 is obtained in the same manner as in Example 1 except that an inorganic protective layer having a thickness of 3 μm is formed by changing the film forming time in the film forming device to 15 hours by using the organic photoreceptor (2).

### Example 6

In the formation of the single-layer type photosensitive layer in Example 1, the coating solution for forming the photosensitive layer obtained by changing tetrahydrofuran to 250 parts by mass without containing the silica particle (1) is used, the single-layer type photosensitive layer having a film thickness of 10 μm is further formed and an organic photoconductor (3) is obtained.

Next, an electrophotographic photoreceptor of Example 6 is obtained in the same manner as in Example 1 except that the inorganic protective layer having a thickness of 3 μm is formed by changing the film forming time in the film forming device to 15 hours by using the organic photoreceptor (3).

### Example 7

—Formation of Undercoat Layer—

100 parts by mass of zinc oxide (an average particle size of 70 nm: manufactured by Tayca Corporation: a specific surface area value 15 m²/g) is stirred and mixed with 500 parts by mass of tetrahydrofuran, and then 1.3 parts by mass of a silane coupling agent (KBM 503: manufactured by Shin-Etsu Chemical Co., Ltd.) is added and stirred for 2 hours. Thereafter, tetrahydrofuran is distilled off under reduced pressure and baked at 120° C. for 3 hours to obtain zinc oxide surface-treated by the silane coupling agent.

110 parts by mass of the obtained surface-treated zinc oxide (the zinc oxide surface-treated by the silane coupling agent) is mixed and stirred with 500 parts by mass of tetrahydrofuran, a solution prepared by dissolving 0.6 part by mass of alizarin in 50 parts by mass of tetrahydrofuran is added, and the mixture is stirred at 50° C. for 5 hours. Thereafter, zinc oxide to which alizarin is added is filtered under reduced pressure, and further dried under reduced pressure at 60° C. to obtain alizarin-added zinc oxide.

60 parts by mass of the alizarin added zinc oxide, 13.5 parts by mass of a curing agent (blocked isocyanate sujoule 3175, manufactured by Sumitomo Bayer Co., Ltd.), 15 parts by mass of a butyral resin (S-LEC BM-1, manufactured by Sekisui Chemical Co., Ltd.) and 85 parts by mass of methyl ethyl ketone are mixed to obtain a mixed solution. 38 parts by mass of the mixed solution and 25 parts by mass of methyl ethyl ketone are mixed and dispersed for 2 hours in the sand mill using the glass bead having a diameter of 1 mm to obtain a dispersion solution.

0.005 part by mass of dioctyl tin dilaurate as a catalyst and 40 parts by mass of the silicone resin particle (Stoke 145, manufactured by Momentive Performance Materials Co., Ltd.) are added to the obtained dispersion solution to obtain a coating liquid for forming an undercoat layer.

The coating liquid for forming the undercoat layer is coated on the aluminum substrate by dip coating, followed by drying and curing at 170° C. for 40 minutes to form an undercoat layer having a thickness of 15 μm.

—Formation of Single-Layer Type Photosensitive Layer and Inorganic Protective Layer—

An organic photoreceptor (4) is obtained by forming the single-layer type photosensitive layer on the obtained undercoat layer in the same manner as in Example 1 except that the film thickness is set to 10 μm.

Next, an electrophotographic photoreceptor of Example 7 is obtained in the same manner as in Example 1 except that the inorganic protective layer having a thickness of 4 μm is formed by changing the film forming time in the film forming device to 20 hours by using the organic photoreceptor (4).

### Comparative Example 1

An organic photoreceptor (5) is obtained by forming the single-layer type photosensitive layer in Example 1 with a thickness of 28 μm.

Next, an electrophotographic photoreceptor of Comparative Example 1 is obtained in the same manner as in Example 1 except that the inorganic protective layer having a thickness of 3 μm is formed by changing the film forming time in the film forming device to 15 hours by using the organic photoreceptor (5).

(Measurement and Evaluation)

### —Film Elastic Modulus and Thickness Measurement—

The film elastic modulus of the undercoat layer, the single-layer type photosensitive layer, and the inorganic protective layer in the electrophotographic photoreceptor obtained in each example is measured by the methods described above.

The thickness of the undercoat layer, the single-layer type photosensitive layer, and the inorganic protective layer in the electrophotographic photoreceptor obtained in each example is measured by the method described above, and a total film thickness of the layer interposed between the conductive substrate and the inorganic protective layer is calculated. Results are shown in Table 1.

—Evaluation of Dents—

The electrophotographic photoreceptor obtained in each example is incorporated in the image forming apparatus (DocuCentre-V C7775 manufactured by Fuji Xerox Co., Ltd.), and the following evaluation is made.

After 10,000 full-length halftone images of 30% image density are continuously output on A4 paper in an environment of 20° C. and 40% RH, the surface of the electrophotographic photoreceptor (that is, the surface of the inorganic protective layer) is observed with an optical microscope (model number: VHX-100, manufactured by Keyence Corporation), 10 fields of view are measured at a magnification of 450 times, the number of dents (recesses) is counted, and the number of dents per unit area (1 mm×1 mm) (hereinafter also referred to as “the number of dents”) is calculated.

The evaluation criteria are as follows. Results are shown in Table 1.

—Evaluation Criteria—

A: the number of dents is five or less

B: the number of dents is more than 5 and 10 or less

C: the number of dents is more than 10 and 15 or less

D: the number of dents is more than 15 and 20 or less

E: the number of dents is more than 20

TABLE 1

| | | | | | | | Overall film | | |
|---|---|---|---|---|---|---|---|---|---|
| | | | Single-layer type | | | | thickness B of a | | |
| | | | photosensitive | | Inorganic | | layer between a | | |
| | Undercoat layer | | layer | | protective layer | | conductive | | |
| | Film | | Film | | Film | | substrate and an | | Evaluation |
| | elastic | Film | elastic | Film | elastic | Film | inorganic | | The |
| | modulus | thickness | modulus | Thickness | modulus | thickness A | protective layer | | number |
| | [GPa] | [μm] | [GPa] | [μm] | [GPa] | [μm] | [μm] | A/B | of dents |
| Example 1 | — | — | 8 | 25 | 100 | 5 | 25 | 0.20 | A |
| Example 2 | — | — | 8 | 75 | 100 | 4 | 25 | 0.16 | B |
| Example 3 | — | — | 8 | 25 | 100 | 3 | 25 | 0.12 | C |
| Example 4 | — | — | 8 | 25 | 100 | 1 | 25 | 0.01 | D |
| Example 5 | — | — | 8 | 10 | 100 | 3 | 10 | 0.30 | A |
| Example 6 | — | — | 3 | 10 | 100 | 3 | 10 | 0.30 | D |
| Example 7 | 13 | 15 | 8 | 10 | 100 | 4 | 25 | 0.16 | B |
| Comparative | — | — | 8 | 28 | 100 | 3 | 28 | 0.11 | E |
| Example 1 | | | | | | | | | |

From the above results, it can be seen that occurrence of dents is suppressed in the present embodiment as compared with the comparative example.

### Example 8

### —Preparation of Undercoat Layer—

100 parts by mass of zinc oxide (an average particle size of 70 nm: manufactured by Tayca Corporation: a specific surface area value 15 m²/g) is stirred and mixed with 500 parts by mass of tetrahydrofuran, 1.3 parts by mass of the silane coupling agent (KBM 503: manufactured by Shin-Etsu Chemical Co., Ltd.) is added and stirred for 2 hours. Thereafter, tetrahydrofuran is distilled off under the reduced pressure and baked at 120° C. for 3 hours to obtain the zinc oxide surface-treated by the silane coupling agent.

110 parts by mass of the surface-treated zinc oxide is mixed and stirred with 500 parts by mass of tetrahydrofuran, a solution prepared by dissolving 0.6 part by mass of alizarin in 50 parts by mass of tetrahydrofuran is added, and the mixture is stirred at 50° C. for 5 hours. Thereafter, the zinc oxide to which alizarin is added is filtered under reduced pressure, and further dried under reduced pressure at 60° C. to obtain alizarin-added zinc oxide.

60 parts by mass of the alizarin added zinc oxide, 13.5 parts by mass of the curing agent (blocked isocyanate sujoule 3175, manufactured by Sumitomo Bayer Co., Ltd.) and 85 parts by mass of the methyl ethyl ketone are mixed to obtain the mixed solution. 38 parts by mass of the mixed solution and 25 parts by mass of methyl ethyl ketone are mixed and dispersed for 2 hours in the sand mill using the glass bead having a diameter of 1 mm to obtain the dispersion solution.

0.005 part by mass of dioctyl tin dilaurate as the catalyst and 40 parts by mass of the silicone resin particle (Stoke 145, manufactured by Momentive Performance Materials Co., Ltd.) are added to the obtained dispersion solution to obtain the coating liquid for forming the undercoat layer.

The coating solution is coated on an aluminum substrate having an outer diameter of 30 mm, a length of 365 mm, and a thickness (a wall thickness) of 1.0 mm by dip coating, and dried and cured at 170° C. for 40 minutes to obtain an undercoat layer having a thickness of 19 μm.

—Preparation of Charge Transport Layer—

250 parts by mass of tetrahydrofuran is added to 65 parts by mass of the silica particle (1), while maintaining the liquid temperature at 20° C., 25 parts by mass of 4-(2,2-diphenylethyl)-4′,4″-dimethyl-triphenylamine and 25 parts by mass of a bisphenol Z type polycarbonate resin (viscosity average molecular weight: 30000) as the binder resin are added, stirred and mixed for 12 hours to obtain the coating liquid for forming the charge transport layer. The coating liquid for forming the charge transport layer is coated on the undercoat layer and dried at 135° C. for 40 minutes to form a charge transport layer having a thickness of 30 μm.

—Preparation of Charge Generation Layer—

A mixture composed of 15 parts by mass of hydroxygallium phthalocyanine having diffraction peaks at positions where the Bragg angles (2θ±0.2°) of the X-ray diffraction spectrum using the Cuk α characteristic X ray as the charge generation substance are at least 7.3°, 16.0°, 24.9°, 28.00, 15 parts by mass of hydroxygallium phthalocyanine having a diffraction peak, 10 parts by mass of a vinyl chloride.vinyl acetate copolymer (VMCH, Nippon Unicar Co., Ltd.) as a binder resin, and 200 parts by mass of n-butyl acetate is dispersed in a sand mill for 4 hours using glass beads having a diameter of 1 mm. 175 parts by mass of n-butyl acetate and 180 parts by mass of methyl ethyl ketone are added to the obtained dispersion solution and stirred to obtain the coating liquid for forming the charge generation layer.

The coating liquid for forming the charge generation layer is dip-coated on the charge transport layer and dried at normal temperature (25° C.) to form a charge generation layer having a thickness of 0.2 μm.

Through the steps described above, the organic photoreceptor (1) in which the undercoat layer, the charge transport layer, and the charge generation layer are sequentially laminated is obtained on the aluminum substrate.

—Formation of Inorganic Protective Layer—

First, conditions for forming the inorganic protective layer are shown in Table 2. The following film forming device is used to form the inorganic protective layer.
Method: installing a rotation introduction machine which is plasma CVD, a capacitively coupled type, whose frequency of high frequency power supply is 13.56 MHz, and which is a magnetic fluid type for rotation of the substrate
Vacuum chamber shape: cylindrical, a diameter 165 mm×a length of 1050 mm
Discharge electrode: 770 mm×85 mm in dimension, 40 mm in distance between the discharge electrode and the substrate
Method of disposing the photoreceptor: two organic photoconductors are coaxially disposed in the length direction of the vacuum chamber
Setting a gas flow rate by a mass flow controller
Vacuum evacuation using a rotary pump and a mechanical booster pump
Before film formation, vacuum reaching: 1.0×10⁻² Pa
   In Table 2, O₂ gas is He diluted 40% oxygen gas, H₂ gas is 100% hydrogen gas, TMG gas is 100% trimethylgallium gas, and He gas represents 100% helium gas.

Each characteristic in Table 2 is measured as follows.

Atomic ratio: a sample film formed to a thickness of 1.0 μm on a silicon substrate having a thickness of 0.5 mm is evaluated by an energy dispersive X-ray analyzer (EDS) and the above-described method.

Spectral transmittance: a sample film formed so as to have a thickness of 1.0 μm on a quartz substrate having a thickness of 1.0 mm is evaluated for light transmittance in a wavelength range of 300 nm to 800 nm with an ultraviolet-visible spectrophotometer.

Volume resistivity: a gold electrode with a diameter of 2 mm is formed on a sample film formed to have a thickness of 1.0 μm by a DC sputtering method on an aluminum substrate having a thickness of 1.0 mm and evaluated.

TABLE 2

| | Film forming condition number | | | | | |
|---|---|---|---|---|---|---|
| | Condition 1 | Condition 2 | Condition 3 | Condition 4 | Condition 5 | Condition 6 |
| O₂ gas flow | 13 | 10 | 15 | 6 | 8 | 4.9 |
| rate (sccm) | | | | | | |
| TMG gas flow | 10 | 10 | 15 | 7.5 | 10 | 7.5 |
| rate (sccm) | | | | | | |
| H₂ gas flow | 500 | 500 | 1000 | 500 | 500 | 1000 |
| rate (sccm) | | | | | | |
| He gas flow | 0 | 0 | 0 | 0 | 0 | 0 |
| rate (sccm) | | | | | | |
| Pressure (Pa) | 25 | 25 | 50 | 25 | 12.5 | 50 |
| High-frequency | 500 | 500 | 600 | 500 | 500 | 500 |
| power (W) | | | | | | |
| Rotation | 500 | 500 | 500 | 500 | 500 | 500 |
| number of | | | | | | |
| Substrate (rpm) | | | | | | |
| Atomic ratio | 1.48 | 1.40 | 1.43 | 1.26 | 1.28 | 1.14 |
| [0/Ga] | | | | | | |
| Transmittance | 90 | 83 | 88 | 77 | 78 | 50 |
| (T %) | | | | | | |
| (λ = 300 nm to | | | | | | |
| 800 nm) | | | | | | |
| Volume | 4.0 × 10¹⁰ | 5.3 × 10¹⁰ | 6.7 × 10¹⁰ | 2.6 × 10⁹ | 1.0 × 10¹⁰ | 1.2 × 10⁸ |
| resistivity | | | | | | |
| (Ω · cm) | | | | | | |
| Film forming | 54 | 56 | 34 | 73 | 69 | 87 |
| ratio | | | | | | |
| (minute/μm) | | | | | | |

(Formation of First Region)

The above-prepared organic photoreceptor (1) is placed on the substrate supporting member in the film forming chamber of the film forming device, and the interior of the film forming chamber is evacuated to a pressure of 0.01 Pa via the exhaust port. The evacuation is performed within 5 minutes after the substitution of the high concentration oxygen-containing gas.

Next, as shown in Table 3, a film is formed under condition 4. That is, He diluted 40% oxygen gas (6 sccm) and H₂ gas (500 sccm) are introduced into the high-frequency discharge tube unit provided with the flat electrode having a diameter of 85 mm from the gas introduction pipe, a radio wave of 13.56 MHz is set at an output of 500 W by the high frequency power supply unit and the matching circuit to match with the tuner, and discharging from the plate electrode is performed. The reflected wave at this time is 0 W at this time.

Next, a trimethylgallium gas (7.5 sccm) is introduced from the shower nozzle into the plasma diffusion portion in the film forming chamber via the gas introduction pipe. At this time, the reaction pressure in the film forming chamber measured by a Baratron vacuum gauge is 25 Pa.

In this state, film formation is conducted for 37 minutes while the organic photoreceptor (1) is rotated at a speed of 500 rpm to form a first region of the inorganic protective layer having a film thickness of 0.50 μm on the surface of the charge transport layer of the organic photoreceptor (1).

(Formation of Second Region)

Next, the high-frequency discharge is stopped, after changing to He diluted 40% oxygen gas (13 sccm), H 2 gas (500 sccm) trimethyl gallium gas (10 sccm), the high-frequency discharge is started again.

In this state, film formation is conducted for 189 minutes while the organic photoreceptor (1) forming the first region is rotated at a speed of 500 rpm to form a second region having a thickness of 3.5 μm on the first region.

In accordance with the above operation procedure, an inorganic protective layer having an overall thickness of 4.0 μm is formed in which the number of repetitions of the first region and the second region is set to one and the second region is the outermost layer. The time for forming the entire inorganic protective layer is 226 minutes.

Through the above process, the electrophotographic photosensitive member of Example 8 is obtained by sequentially forming the undercoat layer, the charge generation layer, the charge transport layer, and the inorganic protective layer (the first region+the second region) on the conductive substrate.

### Examples 9 to 22 and Comparative Examples 2 to 13

According to Table 3 and Table 4, the electrophotographic photoreceptor of each example is obtained in the same manner as in Example 8 except that the element composition ratio in the first region and the second region of the inorganic protective layer, the volume resistivity, the number of repetitions of the first region and the second region, the total thickness (film thickness) of the inorganic protective layer, the thickness of each region of the first region and the second region, the amount of the silica particle of the charge transport layer, the thickness (the wall thickness) of the conductive substrate are changed. The composition of the charge transport layer is adjusted such that the mass % of the silica particle is the value shown in Table 2 as the amount relative to the entire charge transport layer.

(Evaluation)

### —Evaluation of Photoreceptor Sensitivity and Residual Potential—

The sensitivity and the residual potential of each example are evaluated using a universal scanner capable of setting a predetermined charge potential and an exposure amount.
Evaluation of sensitivity: evaluated as half decay exposure when charged to −700 V. After charging to −700 V, a half exposure amount (mJ/m²) in which the surface potential of the photoreceptor immediately after charging is ½ (−350 V) by light irradiation (light source: semiconductor laser, a wavelength 780 nm, an output 5 mW) is measured.
Evaluation of residual potential: the potential (V) of the surface of the photoreceptor after light attenuation is measured.

Evaluation of Photoreceptor Recesses and scratches

In an image forming apparatus in which DocuCentre V 7775 manufactured by Fuji Xerox Co., Ltd. is modified for a electrophotographic photoreceptor for positive charging, the photoconductor obtained in each example is attached, ten images are formed continuously, and this is repeated to form a total of 10,000 images. Thereafter, the surface of the photoreceptor is observed with an optical microscope (field size of 500 μm×500 μm), and the number of recesses and scratches is counted and evaluated by the following evaluation criteria. The recesses (dents) and the scratches are determined as follows.
Definition of the shape of the recess: an elliptical shape with an aspect ratio of 0.8 to 1.2 within a maximum diameter of 50 μm
Definition of the shape of the scratch: a linear shape from 0.1 mm to 3 mm in length in a circumferential direction of the photoreceptor within 50 μm in width

### —Recess Evaluation Criteria—

A: no recesses are observed in observation of 10 fields of view (0)
B: one recess is observed in observation of 10 fields of view
C: two or more recesses are observed in observation of 10 fields of view, and four or less recesses are observed in observation of one field of view
D: two or more recesses are observed in observation of 10 fields of view and five or more recesses are observed in observation of one field of view

### —Scratch Evaluation Criteria—

A: no scratch is observed in observation of 20 fields of view (0)
B: no scratch is observed in observation of 10 fields of view (0), and 1 scratch is observed in observation of 20 fields of view
C: 1 scratch is observed in observation of 10 fields of view
D: 2 or more scratches are observed in observation of 10 fields of view

TABLE 3

| | | | | | Example | Example | Example | Example | Example | Example |
|---|---|---|---|---|---|---|---|---|---|---|
| | | | Example 8 | Example 9 | 10 | 11 | 12 | 13 | 14 | 15 |
| Inorganig | The | Film forming | Condition 1 | Condition 1 | Condition 1 | Condition 1 | Condition 1 | Condition 1 | Condition 1 | Condition 1 |
| protective | second | condition | | | | | | | | |
| layer | region | Film forming | 189 | 27 | 54 | 27 | 27 | 27 | 27 | 27 |
| | | time | | | | | | | | |
| | | (minute/ | | | | | | | | |
| | | cycle) | | | | | | | | |
| | | Thickness | 3.5 | 0.5 | 1.0 | 0.5 | 0.5 | 0.5 | 0.5 | 0.5 |
| | | (μm/cycle) | | | | | | | | |
| | | Element | 1.48 | 1.48 | 1.48 | 1.48 | 1.48 | 1.48 | 1.48 | 1.48 |
| | | composition | | | | | | | | |
| | | ratio | | | | | | | | |
| | | [O]/[Ga] | | | | | | | | |
| | | Volume | 4.0 × 10¹⁰ | 4.0 × 10¹⁰ | 4.0 × 10¹⁰ | 4.0 × 10¹⁰ | 4.0 × 10¹⁰ | 4.0 × 10¹⁰ | 4.0 × 10¹⁰ | 4.0 × 10¹⁰ |
| | | resistivity (Ω | | | | | | | | |
| | | cm) | | | | | | | | |
| | The | Film forming | Condition 4 | Condition 4 | Condition 4 | Condition 4 | Condition 4 | Condition 4 | Condition 6 | Condition 5 |
| | first | condition | | | | | | | | |
| | region | Film forming | 37 | 4 | 4 | 1 | 7 | 1 | 4 | 4 |
| | | time | | | | | | | | |
| | | (minute/ | | | | | | | | |
| | | cycle) | | | | | | | | |
| | | Thickness | 0.50 | 0.05 | 0.05 | 0.01 | 0.10 | 0.01 | 0.05 | 0.05 |
| | | (μm/cycle) | | | | | | | | |
| | | Element | 1.26 | 1.26 | 1.26 | 1.26 | 1.26 | 1.26 | 1.14 | 1.28 |
| | | composition | | | | | | | | |
| | | ratio | | | | | | | | |
| | | [O]/[Ga] | | | | | | | | |
| | | Volume | 2.6 × 10⁹ | 2.6 × 10⁹ | 2.6 × 10⁹ | 2.6 × 10⁹ | 2.6 × 10⁹ | 2.6 × 10⁹ | 1.2 × 10⁸ | 1.0 × 10¹⁰ |
| | | resistivity | | | | | | | | |
| | | (Ω cm) | | | | | | | | |

| | | | | | | | | | |
|---|---|---|---|---|---|---|---|---|---|
| | The number of | 1 | 8 | 4 | 9 | 8 | 6 | 6 | 10 |
| | repetitions (times) | | | | | | | | |
| | Overall film forming | 226 | 245 | 231 | 250 | 274 | 166 | 184 | 307 |
| | time (minute) | | | | | | | | |
| | [O] + [Ga] | 0.81 | 0.80 | 0.81 | 0.81 | 0.80 | 0.81 | 0.81 | 0.81 |
| | Overall thickness | 4.0 | 4.4 | 4.2 | 4.6 | 4.8 | 3.1 | 3.3 | 5.5 |
| | (mm) | | | | | | | | |
| Charge | The content of silica | 65 | 65 | 65 | 65 | 65 | 55 | 65 | 60 |
| transport | particle (mass %) | | | | | | | | |
| layer | | | | | | | | | |
| Coun- | Thickness (mm) | 1.0 | 1.0 | 1.0 | 1.0 | 1.0 | 1.5 | 1.0 | 1.0 |
| ductive | | | | | | | | | |
| substrate | | | | | | | | | |
| Evaluation | Sensitivity (mJ/m²) | 4.4 | 2.0 | 2.1 | 1.9 | 3.2 | 1.8 | 2.2 | 2.5 |
| | Residual potential (V) | +83 | +41 | +55 | +38 | +47 | +30 | +32 | +53 |
| | Recess | A | A | A | A | A | B | B | A |
| | Scratch | A | B | B | A | A | B | B | A |

| | | | Example | Example | Example | Example | Example | Example | Example |
|---|---|---|---|---|---|---|---|---|---|
| | | | 16 | 17 | 18 | 19 | 20 | 21 | 22 |
| Inorganig protective | The | Film forming | Condition 1 | Condition 2 | Condition 2 | Condition 3 | Condition 3 | Condition 1 | Condition 1 |
| layer | second | condition | | | | | | | |
| | region | Film forming | 54 | 196 | 17 | 119 | 27 | 54 | 54 |
| | | time | | | | | | | |
| | | (minute/cycle) | | | | | | | |
| | | Thickness | 1 | 3.5 | 0.3 | 3.5 | 0.8 | 1 | 1 |
| | | (μm/cycle) | | | | | | | |
| | | Element | 1.48 | 1.40 | 1.40 | 1.43 | 1.43 | 1.48 | 1.48 |
| | | composition | | | | | | | |
| | | ratio [O]/[Ga] | | | | | | | |
| | | Volume | 4.0 × 10¹⁰ | 5.3 × 10¹⁰ | 5.3 × 10¹⁰ | 6.7 × 10¹⁰ | 6.7 × 10¹⁰ | 4.0 × 10¹⁰ | 4.0 × 10¹⁰ |
| | | resistivity (Ω | | | | | | | |
| | | cm) | | | | | | | |
| | The | Film forming | Condition 4 | Condition 5 | Condition 5 | Condition 6 | Condition 6 | Condition 6 | Condition 6 |
| | first | condition | | | | | | | |
| | region | Film forming | 7 | 35 | 7 | 44 | 1 | 4 | 4 |
| | | time | | | | | | | |
| | | (minute/cycle) | | | | | | | |
| | | Thickness | 0.10 | 0.50 | 0.10 | 0.50 | 0.01 | 0.05 | 0.05 |
| | | (μm/cycle) | | | | | | | |
| | | Element | 1.26 | 1.28 | 1.28 | 1.14 | 1.14 | 1.14 | 1.14 |
| | | composition | | | | | | | |
| | | ratio | | | | | | | |
| | | [O]/[Ga] | | | | | | | |
| | | Volume | 2.6 × 10⁹ | 1.0 × 10¹⁰ | 1.0 × 10¹⁰ | 1.2 × 10⁸ | 1.2 × 10⁸ | 1.2 × 10⁸ | 1.2 × 10⁸ |
| | | resistivity | | | | | | | |
| | | (Ω cm) | | | | | | | |

| | | | | | | | | |
|---|---|---|---|---|---|---|---|---|
| | The number of | 9 | 1 | 10 | 1 | 5 | 5 | 5 |
| | repetitions (times) | | | | | | | |
| | Overall film forming | 552 | 231 | 237 | 163 | 140 | 292 | 292 |
| | time (minute) | | | | | | | |
| | [O] + [Ga] | 0.81 | 0.80 | 0.79 | 0.78 | 0.79 | 0.80 | 0.80 |
| | Overall thickness (mm) | 9.9 | 4.0 | 4.0 | 4.0 | 4.1 | 5.3 | 5.3 |
| Charge transport | The content of silica | 40 | 65 | 65 | 60 | 60 | 0 | 0 |
| | particle layer (mass %) | | | | | | | |
| Counductive substrate | Thickness (mm) | 1.0 | 1.0 | 1.0 | 1.0 | 1.0 | 1.5 | 3.5 |
| Evaluation | Sensitivity (mJ/m²) | 3.3 | 4.1 | 2.9 | 4.8 | 1.9 | 2.6 | 2.5 |
| | Residual potential (V) | +76 | +89 | +50 | +63 | +35 | +3 | +44 |
| | Recess | A | A | A | A | A | B | A |
| | Scratch | B | A | B | A | A | B | B |

TABLE 4

| | | | Comparative | Comparative | Comparative | Comparative | Comparative | Comparative |
|---|---|---|---|---|---|---|---|---|
| | | | Example 2 | Example 3 | Example 4 | Example 5 | Example 6 | Example 7 |
| Inorganig | The | Film | Condition 4 | Condition 4 | Condition 4 | Condition 4 | Condition 4 | Condition 4 |
| protective | second | forming | | | | | | |
| layer | region | condition | | | | | | |
| | | Film | 0.4 | 0.4 | 11 | 11 | 37 | 37 |
| | | forming | | | | | | |
| | | time | | | | | | |
| | | (minute/cycle) | | | | | | |
| | | Thickness | 0.005 | 0.005 | 0.15 | 0.15 | 0.5 | 0.5 |
| | | (μm/cycle) | | | | | | |
| | | Element | 1.26 | 1.26 | 1.26 | 1.26 | 1.26 | 1.26 |
| | | ratio | | | | | | |
| | | [O]/[Ga] | | | | | | |
| | | Volume | 2.6 × 10⁹ | 2.6 × 10⁹ | 2.6 × 10⁹ | 2.6 × 10⁹ | 2.6 × 10⁹ | 2.6 × 10⁹ |
| | | resistivity | | | | | | |
| | | (Ω cm) | | | | | | |
| | The | Film | Condition 1 | Condition 1 | Condition 2 | Condition 3 | Condition 1 | Condition 1 |
| | first | forming | | | | | | |
| | region | condition | | | | | | |
| | | Film | 5.4 | 81 | 5.4 | 81 | 54 | 135 |
| | | forming | | | | | | |
| | | time | | | | | | |
| | | (minute/cycle) | | | | | | |
| | | Thickness | 0.1 | 1.5 | 0.1 | 1.5 | 1.0 | 2.5 |
| | | (μm/cycle) | | | | | | |
| | | Element | 1.48 | 1.48 | 1.40 | 1.43 | 1.48 | 1.48 |
| | | ratio | | | | | | |
| | | [O]/[Ga] | | | | | | |
| | | Volume | 4.0 × 10¹⁰ | 4.0 × 10¹⁰ | 5.3 × 10¹⁰ | 6.7 × 10¹⁰ | 4.0 × 10¹⁰ | 4.0 × 10¹⁰ |
| | | resistivity | | | | | | |
| | | (Ω cm) | | | | | | |
| | The number of | | 30 | 3 | 18 | 6 | 1 | 1 |
| | repetitions (times) | | | | | | | |
| | Overall film forming | | 173 | 244 | 294 | 552 | 91 | 172 |
| | time (minute) | | | | | | | |
| | [O] + [Ga] | | 0.81 | 0.81 | 0.76 | 0.78 | 0.79 | 0.80 |
| | Overall thickness | | 3.2 | 4.5 | 4.5 | 9.9 | 1.5 | 3 |
| | (mm) | | | | | | | |
| Charge | The content of silica | | 65 | 65 | 65 | 65 | 65 | 65 |
| transport | particle (mass %) | | | | | | | |
| layer | | | | | | | | |
| Counductive | Thickness (mm) | | 1.0 | 1.0 | 1.0 | 1.0 | 1.0 | 1.0 |
| substrate | | | | | | | | |
| Evaluation | Sensitivity (mJ/m²) | | 4.3 | 3.8 | 7.5 | 9.2 | 4.0 | 4.2 |
| | Residual potential (V) | | +97 | +119 | +48 | +108 | +84 | +182 |
| | Recess | | C | A | A | A | C | C |
| | Scratch | | C | B | B | A | D | C |
| | | | | | Comparative | Comparative | Comparative | Comparative |
| | | | Comparative | Comparative | Example | Example | Example | Example |
| | | | Example 8 | Example 9 | 10 | 11 | 12 | 13 |
| Inorganig | The | Film forming | Condition 4 | None | None | Condition 6 | Condition 1 | Condition 1 |
| protective | second | condition | | | | | | |
| layer | region | Film forming | 37 | 0 | 0 | 4 | 189 | 243 |
| | | time | | | | | | |
| | | (minute/cycle) | | | | | | |
| | | Thickness | 0.5 | 0 | 0 | 0.1 | 3.5 | 4.5 |
| | | (μm/cycle) | | | | | | |
| | | Element | 1.26 | — | — | 1.14 | 1.48 | 1.48 |
| | | ratio | | | | | | |
| | | [O]/[Ga] | | | | | | |
| | | Volume | 2.6 × 10⁹ | — | — | 1.2 × 10⁸ | 4.0 × 10¹⁰ | 4.0 × 10¹⁰ |
| | | resistivity (Ω | | | | | | |
| | | cm) | | | | | | |
| | The | Film forming | Condition 1 | Condition 4 | Condition 4 | Condition 3 | None | None |
| | first | condition | | | | | | |
| | region | Film forming | 216 | 110 | 219 | 54 | 0 | 0 |
| | | time | | | | | | |
| | | (minute/cycle) | | | | | | |
| | | Thickness | 4.0 | 1.5 | 3.0 | 1.0 | 0 | 0 |
| | | (μm/cycle) | | | | | | |
| | | Element | 1.48 | 1.26 | 1.26 | 1.43 | — | — |
| | | ratio | | | | | | |
| | | [O]/[Ga] | | | | | | |
| | | Volume | 4.0 × 10¹⁰ | 2.6 × 10⁹ | 2.6 × 10⁹ | 6.7 × 10¹⁰ | — | — |
| | | resistivity | | | | | | |
| | | (Ω cm) | | | | | | |

| | | | | | | | |
|---|---|---|---|---|---|---|---|
| | The number of | 1 | 1 | 1 | 5 | 1 | 1 |
| | repetitions (times) | | | | | | |
| | Overall film | 253 | 110 | 219 | 292 | 189 | 243 |
| | forming time | | | | | | |
| | (minute) | | | | | | |
| | [O] + [Ga] | 0.81 | 0.76 | 0.76 | 0.81 | 0.81 | 0.81 |
| | Overall thickness | 4.5 | 1.5 | 3.0 | 5.3 | 3.5 | 4.5 |
| | (mm) | | | | | | |
| Charge | The content of | 65 | 65 | 65 | 0 | 65 | 4.5 |
| transport | silica particle | | | | | | |
| layer | (mass %) | | | | | | |
| Counductive | Thickness (mm) | 1.0 | 1.0 | 1.0 | 1.0 | 1.0 | 1.0 |
| substrate | | | | | | | |
| Evaluation | Sensitivity (mJ/m²) | 4.5 | 6.1 | 12.5 | 2.8 | 3.9 | 5.0 |
| | Residual potential | +203 | +91 | +109 | +93 | +131 | +170 |
| | (V) | | | | | | |
| | Recess | A | C | C | C | B | A |
| | Scratch | B | D | C | C | B | A |

The conditions shown in the film formation condition columns in Table 3 and Table 4 are the same as those shown in Table 2. Further. [O]+[Ga] in Table 3 and Table 4 represents a sum of the element composition ratios of gallium and oxygen with respect to all elements configuring the inorganic protective layer.

From the above results, it can be seen that in this embodiment, the sensitivity is ensured and the increase of the residual potential is suppressed as compared with the comparative example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
a single-layer type photosensitive layer that is provided on the conductive substrate;
an inorganic protective layer that is provided on the single-layer type photosensitive layer; wherein
layers that are interposed between the conductive substrate and the inorganic protective layer have a total thickness of 10 μm to 25 μm.

2. The electrophotographic photoreceptor according to claim 1, wherein
the single-layer type photosensitive layer includes a binder resin, a charge generation material, a hole transport material, an electron transport material, and silica particles.

3. The electrophotographic photoreceptor according to claim 2, wherein a content of the silica particles in the single-layer type photosensitive layer is 40% by mass to 70% by mass.

4. The electrophotographic photoreceptor according to claim 1, wherein a ratio (A/B) of a thickness A of the inorganic protective layer to the total thickness B of the layers that are interposed between the conductive substrate and the inorganic protective layer is 0.12 or more.

5. The electrophotographic photoreceptor according to claim 1, wherein the inorganic protective layer is composed of a metal oxide layer including a Group 13 element and oxygen.

6. The electrophotographic photoreceptor according to claim 5, wherein the metal oxide layer comprises gallium oxide.

7. A process cartridge that is detachable from an image forming apparatus and that comprises:
the electrophotographic photoreceptor according to claim 1.

8. An image forming apparatus comprising:
the electrophotographic photoreceptor according to claim 1;
a charging unit that charges a surface of the electrophotographic photoreceptor,
an electrostatic latent image forming unit that forms an electrostatic latent image on the surface of the electrophotographic photoreceptor;
a developing unit that develops the electrostatic latent image formed on the surface of the electrophotographic photoreceptor with a developer including toner to form a toner image; and
a transferring unit that transfers the toner image onto a surface of a recording medium.

9. An electrophotographic photoreceptor for positive charging, comprising:
a conductive substrate;
an organic photosensitive layer that is provided on the conductive substrate; and
an inorganic protective layer that is provided on the organic photosensitive layer, the inorganic protective layer including a Group 13 element and oxygen, wherein
a sum of element composition ratios of the Group 13 element and the oxygen with respect to all elements constituting the inorganic protective layer is 0.70 or more, and
the inorganic protective layer includes at least one combination of:
a first region in which an element ratio (oxygen/Group 13 element) of the oxygen to the Group 13 element is 1.10 to 1.30; and
a second region in which an element ratio (oxygen/Group 13 element) of the oxygen to the Group 13 element is 1.40 to 1.50 in this order on the organic photosensitive layer,
wherein the second region is the upmost layer of the inorganic protective layer.

10. An electrophotographic photoreceptor for positive charging, comprising:
a conductive substrate;
an organic photosensitive layer that is provided on the conductive substrate; and
an inorganic protective layer that is provided on the organic photosensitive layer, the inorganic protective layer including a Group 13 element and oxygen, wherein
a sum of element composition ratios of the Group 13 element and the oxygen with respect to all elements constituting the inorganic protective layer is 0.70 or more, and
the inorganic protective layer includes at least one combination of:
a first region having a volume resistivity of 2.0×10⁷ Ωcm to 1.0×10¹⁰ Ωcm; and
a second region having a volume resistivity of 2.0×10¹⁰ Ωcm or more in this order on the organic photosensitive layer,
wherein the second region is the upmost layer of the inorganic protective layer.

11. The electrophotographic photoreceptor for positive charging according to claim 9, wherein the Group 13 element is gallium.

12. The electrophotographic photoreceptor for positive charging according to claim 9, wherein a thickness of the first region is smaller than a thickness of the second region.

13. The electrophotographic photoreceptor for positive charging according to claim 12, wherein a ratio of the thickness of the second region to the thickness of the first region (thickness of the second region/thickness of the first region) is 3 to 100.

14. The electrophotographic photoreceptor for positive charging according to claim 12, wherein the thickness of the first region is 0.01 μm to 0.5 μm, and the thickness of the second region is 0.3 μm to 3.5 μm.

15. The electrophotographic photoreceptor for positive charging according to claim 9, wherein an entire thickness of the inorganic protective layer is 3 μm to 10 μm.

16. The electrophotographic photoreceptor for positive charging according to claim 15, wherein an entire thickness of the inorganic protective layer is 3 μm to 6 μm.

17. The electrophotographic photoreceptor for positive charging according to claim 9, wherein combinations of the first region and the second region formed in this order are repeatedly stacked.

18. The electrophotographic photoreceptor for positive charging according to claim 17, wherein a number of the combinations of the first region and the second region is one to ten.

19. The electrophotographic photoreceptor for positive charging according to claim 9, wherein the organic photosensitive layer includes a layer containing a charge transport material, a binder resin, and silica particles.

20. The electrophotographic photoreceptor for positive charging according to claim 19, wherein a content of the silica particles is 40% by mass to 80% by mass with respect to an entire layer containing the charge transport material, the binder resin, and the silica particles.

21. The electrophotographic photoreceptor for positive charging according to claim 9, wherein a thickness of the conductive substrate is 1.5 μm or more.

22. A process cartridge that is detachable from an image forming apparatus, the process cartridge comprising:
the electrophotographic photoreceptor according to claim 9.

23. An image forming apparatus including:
the electrophotographic photoreceptor according to claim 9;
a charging unit that charges a surface of the electrophotographic photoreceptor for positive charging:
an electrostatic latent image forming unit that forms an electrostatic latent image on the surface of the electrophotographic photoreceptor for positive charging;
a developing unit that develops the electrostatic latent image formed on the surface of the electrophotographic photoreceptor for positive charging with a developer including toner to form a toner image; and
a transferring unit that transfers the toner image onto a surface of a recording medium.
